(19) United States
(12) Patent Application Publication
(10) Pub. No.: US 2025/0325928 A1
(43) Pub. Date: Oct. 23, 2025

(54) FILTER MEDIA FOR WATER FILTRATION

(71) Applicant: Hollingsworth & Vose Company, East Walpole, MA (US)

(72) Inventors: Farzad Rezaei, Floyd, VA (US); Fred Ewing Lybrand, IV, Meredith, NH (US)

(73) Assignee: Hollingsworth & Vose Company, East Walpole, MA (US)

(21) Appl. No.: 18/820,174

(22) Filed: Aug. 29, 2024

Related U.S. Application Data
(63) Continuation-in-part of application No. 18/639,868, filed on Apr. 18, 2024.

(51) Int. Cl. B01D 39/08; B01D 29/00; B01D 39/16

(52) U.S. Cl. CPC B01D 39/083; B01D 29/0093; B01D 39/1623

(57) ABSTRACT

Filter media may be bonded to a filter housing during filtration processes. However, bonding between the filter media and filter housing sufficient to prevent delamination during filtration processes may be challenging as some filter media may be challenging to adhere sufficiently well to the filter housing. Furthermore, for use in consumer water applications, it may be desirable for filter media may undergo sterilization processes (e.g., using an autoclave) that expose the filter media to relatively high temperatures and pressures, which may decrease the adhesion strength between the filter media and the filter housing. Accordingly, there is a need for strategies for bonding filter media to filter housings that do not compromise the performance of the filter media and/or that can undergo sterilization processes without unacceptably compromising the structural integrity of the bond between the filter media and the filter housing.

### RELATED APPLICATIONS

This application is a continuation-in-part of U.S. patent application Ser. No. 18/639,868, filed Apr. 18, 2024, and entitled “Filter Media for Water Filtration,” which is incorporated herein by reference in its entirety for all purposes.

### TECHNICAL FIELD

The present disclosure relates generally to filter media, and, more particularly, to filter media that may bond to filter housings.

### BACKGROUND

Filter media may be used in a variety of applications. In some instances, filter media may be used to remove particulates and/or contaminants from liquids, especially when employed in a filter housing. However, it may be challenging to bond filter media to filter housings. Accordingly, improved filter media designs are needed.

### SUMMARY

Filter media and related components, systems, and methods are generally described. The subject matter of the present disclosure involves, in some cases, interrelated products, alternative solutions to a particular problem, and/or a plurality of different uses of one or more systems and/or articles.

In some embodiments, a filter media is provided. The filter media comprises a first fiber web comprising first fibers. The first fibers have an average diameter of less than or equal to 0.5 micrometers. The first fiber web has a thickness of less than or equal to 200 micrometers. The filter media comprises a second, hydrophilic fiber web directly adjacent to the first fiber web. The filter media comprises a third fiber web bonded to the first fiber web. The filter media comprises a fourth fiber web bonded to the second fiber web or the third fiber web. The fourth fiber web and the second or third fiber web are bonded mechanically and/or by an adhesive layer positioned therebetween. The fourth fiber web has a basis weight greater than or equal to 30 gsm.

In some embodiments, a filter element is provided. The filter element comprises a gravity filter housing. The filter element comprises a filter media bonded to the filter housing. The filter media comprises a first fiber web comprising first fibers. The first fibers have an average diameter of less than or equal to 0.5 micrometers. The first fiber web has a thickness of less than or equal to 200 micrometers. The filter media comprises a second, hydrophilic fiber web directly adjacent to the first fiber web. The filter media comprises a third fiber web directly adjacent to the first fiber web. The filter media comprises a fourth fiber web bonded to the second fiber web or the third fiber web.

In some embodiments, a method for fabricating a filter media is provided. The method for fabricating a filter media comprises bonding a fourth fiber web to a second, hydrophilic fiber web or a third fiber web mechanically and/or by an adhesive layer positioned therebetween. The second fiber web is directly adjacent to a first fiber web having a thickness of less than or equal to 200 micrometers. The third fiber web is bonded to the first fiber web. The first fiber web comprises first fibers having an average diameter of less than or equal to 0.5 micrometers. The fourth fiber web has a basis weight greater than or equal to 30 gsm.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1A is a schematic depicting a filter media comprising a first layer and a fourth fiber web, according to some embodiments.

FIG. 1B is a schematic depicting a filter media bonded to a filter housing, according to some embodiments.

FIG. 1C is a schematic depicting a filter media comprising a fourth fiber web, a first fiber web, and a second fiber web, according to some embodiments.

FIG. 1D is a schematic depicting a filter media comprising a fourth fiber web, a first fiber web, a second fiber web, and a third fiber web, according to some embodiments.

FIG. 1E is a schematic depicting a filter media comprising a fourth fiber web, an adhesive layer, a first fiber web, a second fiber web, and a third fiber web, according to some embodiments.

FIG. 2 is a plot depicting the air permeability of “AW” samples, according to some embodiments.

FIG. 3A is a diagram depicting the structure of the filter media with an adhesive layer, according to some embodiments.

FIG. 3B is a diagram depicting the structure of the filter media without an adhesive layer, according to some embodiments.

FIG. 4 is a plot depicting the change in air permeability for filter media with and without an adhesive layer, according to some embodiments.

FIG. 5 is a diagram showing the surface of a plastic article after peeling off filter media having various qualitative bonding strengths to the plastic article, according to some embodiments.

### DETAILED DESCRIPTION

Filter media and related components, systems, and methods associated therewith are provided.

Filter media may be bonded to a filter housing for any of a variety of filtration processes. However, bonding between the filter media and filter housing sufficient to prevent delamination during filtration processes may be challenging as some filter media may be challenging to adhere sufficiently well to the filter housing. Furthermore, for use in consumer water applications, it may be desirable for filter media to undergo sterilization processes (e.g., using an autoclave) that expose the filter media to relatively high temperatures and pressures, which may decrease the adhesion strength between the filter media and the filter housing. Accordingly, there is a need for strategies for bonding filter media to filter housings that do not compromise the performance of the filter media and/or that can undergo sterilization processes without unacceptably compromising the structural integrity of the bond between the filter media and the filter housing.

Some filter media, described herein, include a layer that advantageously promotes the adhesion of the filter media to a filter housing. This layer may be referred to herein as a “fourth fiber web,” as it may be employed in designs that comprise three other fiber webs. However, this should not be understood to be limiting and it should be understood that a filter media may comprise a “fourth fiber web” and comprise two or fewer further fiber webs and/or that a filter media may comprise a “fourth fiber web” and comprise four or more fiber webs. A fourth fiber web itself may be bonded to one or more other layers of the filter media, such as by ultrasonic bonding and/or by an adhesive layer between it and a layer to which it is bonded. The fourth fiber web, in certain embodiments, comprises properties that promote adhesion with a filter housing without compromising the structural integrity of the filter media. For instance, the melting temperature of the fourth fiber web may be less than that of some or all of the other layers present in the filter media, which may allow for the fourth fiber web to be ultrasonically bonded to the filter housing without melting or otherwise disturbing these other layers. The structural integrity of the fourth fiber web, in some embodiments, can withstand the temperatures and pressures of sterilization procedures (e.g., using an autoclave). In some embodiments, this may occur without crumpling and/or wrinkling of the fourth fiber web.

In some embodiments, a fourth fiber web is provided together with another layer and/or a combination of other layers that it would be desirable to bond to a filter element. For instance, a fourth fiber web may be provided in combination with a low basis weight and/or thin efficiency layer with a relatively small and homogeneous pore structure. The efficiency layer may have pore characteristics that efficiently capture small particles (e.g., colloidal aggregates, suspended organic and inorganic matter) while allowing fluid to pass through with relative ease. The low thickness and/or basis weight of the efficiency layer may reduce the impact of the tight pore structure on pressure drop, allowing, at least in part, the filter media to have a relatively low pressure drop. The low pressure drop may result in improved energy efficiency, relatively long lifetime, and/or reduced likelihood of damage to the filter media during operation. In addition, the relatively low thickness of the filter media may allow more filter media to fit into filter elements resulting in an increased effective filter area compared to thicker filter media. In some instances, the relatively small and homogeneous pore structure of an efficiency layer described herein may be formed using fibers having relatively small diameters (e.g., less than or equal to about 0.5 micrometers). The relatively small diameter fibers and uniformity of fiber diameter (e.g. coefficient of variation around 30%) may impart a relatively higher surface area to the efficiency layer, which may result in a greater particulate capturing efficiency for a given basis weight. Without being bound by theory, it is believed that fine fibers facilitate a smaller pore size in layers that are desirable to be bonded to a filter element, and uniformity in fiber size facilitates a narrow pore size distribution. Further, without being bound by theory, the absence or minimization of fiber merging and bundling is conducive to the formation of smaller pores.

However, filter media with low basis weight and/or thin efficiency layers may be mechanically fragile. In some cases, the smaller the basis weight, thickness, and/or fiber diameter of the efficiency layer, the lower the strength of the efficiency layer. The fragile nature of some filter media layers tend to result in defects that adversely affect the homogeneity of the pore structure. These defects can occur, e.g., during formation of the efficiency layer or in a later manufacturing process such as during bonding of the filter media to the filter housing. As a result, low basis weight and/or thin efficiency layers in conventional filter media may display significant variation in the pore sizes across the area of the filter media that may significantly reduce the filtration efficiency of the filter media. Accordingly, some conventional filter media utilize thicker efficiency layers, which produce thicker filter media. The thicker efficiency layers may suffer from a relatively high pressure drop, short lifetime, reduced energy efficiency, and/or reduced effective filter area. There is a need to bond filter media comprising low basis weight and/or thin efficiency layers with a relatively stable, small, and homogeneous pore structures to filter housings.

In addition to the fourth fiber web, the filter media, described herein, may further include a low basis weight and/or thin efficiency layer that does not suffer from one or more of the above-described limitations.

In some embodiments, as described in more detail below, the fourth fiber web may be bonded to a fibrous support layer having one or more properties that serve to promote the formation of and/or protect the integrity of one or more fiber webs having relatively small pore sizes and/or homogeneous pore structures. For instance, the fibrous support layer may have surface properties (e.g., pore size, solidity, smoothness, fiber intersection density, surface mean pore area) that facilitate efficiency layer (e.g., fiber web having an average fiber diameter of less than or equal to about 0.5 micrometers) formation without significant deformation of the deposited efficiency layer within the pore area of the fibrous support layer. In some embodiments, the fibrous support layer may have mechanical properties (e.g., tensile strength, tensile elongation) that sharply reduce the amount of stress imparted to the efficiency layer, e.g., during manufacture, handling, and/or application. For example, without being bound by theory, it is believed that a support layer having a small surface pore area and/or a relatively smooth surface can minimize the average bridge length (e.g., length of fiber between two solid portions of the support layer that is not in direct contact with a solid portion of the support layer) of the fibers in the efficiency layer. In certain embodiments, the support layer may prevent defects during the filter media and/or filter element manufacturing process. For example, the support layer may prevent defect formation during manufacturing steps, such as during bonding (e.g., adhesively, via lamination) of the efficiency layer to layers that are desirable to be bonded to a filter element. Without being bound by theory, it is believed that dimensional stability of the support layer reduces the amount of strain of the nanofiber web during processing and handling steps. Calendering may increase the solidity and/or the dimensional stability (e.g. increased strength, increased toughness, increased compressive modulus) of a fiber web (e.g., polymer fiber web) to be used for, e.g., a support layer. Without being bound by theory, it is believed that calendering can increase the amount of bonding between individual fibers in the fiber web (e.g., polymer web) and also increase the amount of crystallinity of the polymer in embodiments where the fiber web comprises polymer fibers, both of which may result in higher strength and toughness.

Regardless of whether defect formation is prevented or otherwise minimized during the web formation and/or subsequent manufacturing steps, a low basis weight and/or thin efficiency layer adjacent to (e.g., directly adjacent to) a support layer described herein may have a relatively small and homogeneous pore structure when incorporated into a filter media and/or bonded to the filter housing. For instance, a support layer, described herein, directly adjacent to a low basis weight and/or thin efficiency layer comprising relatively small fibers (e.g., average diameter of less than or equal to about 0.5 micrometers) may allow the efficiency layer or a plurality of such efficiency layers to withstand processing conditions that would otherwise typically result in increased pore size and/or defects (e.g., fiber web formation, bonding with other layers, tension from rollers). As an example, a fibrous efficiency layer directly adjacent to a support layer may substantially retain the pore structure when bonded to other layers of the filter media (e.g., a protective layer) using lamination (e.g., heat lamination) or an adhesive (e.g., an acrylic adhesive, an acrylic copolymer adhesive) whereas a similar process using a conventional support layer may result in a significant change in pore structure.

Filter media described herein may be used in a variety of applications (e.g., gravity filter elements and/or pour-through filter elements; e.g., removal of fine small particulates and dust when filtering consumer and/or potable water).

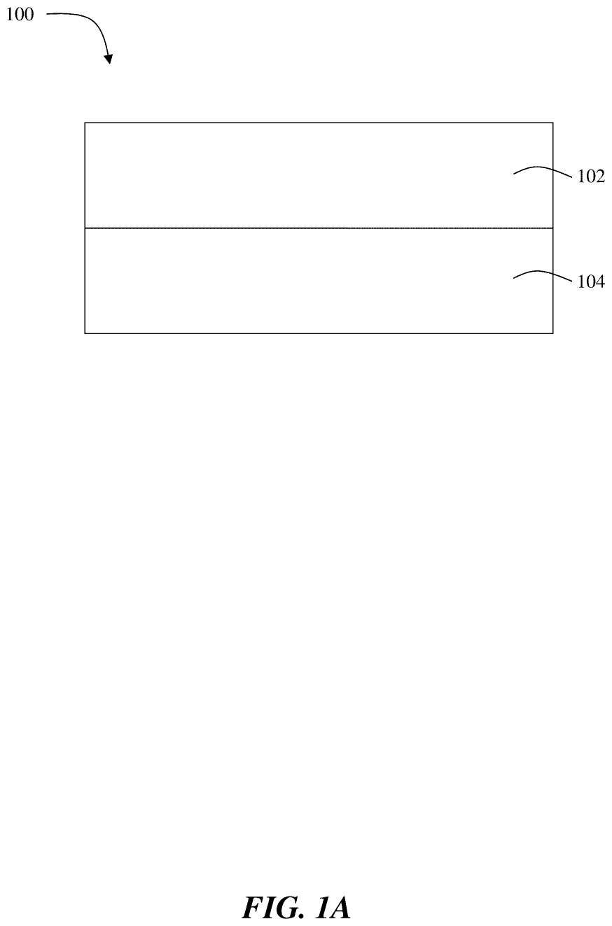

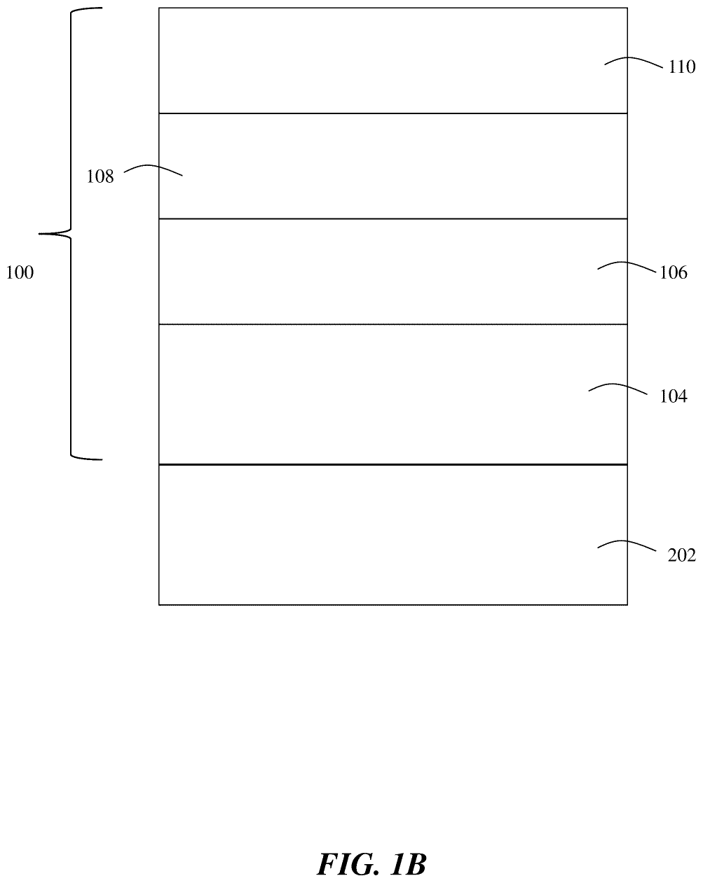

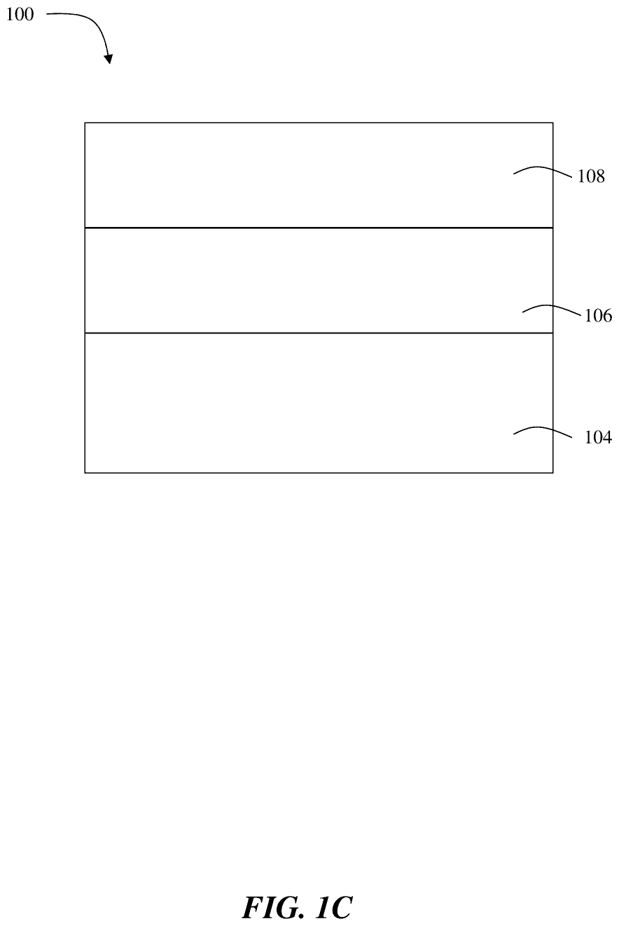

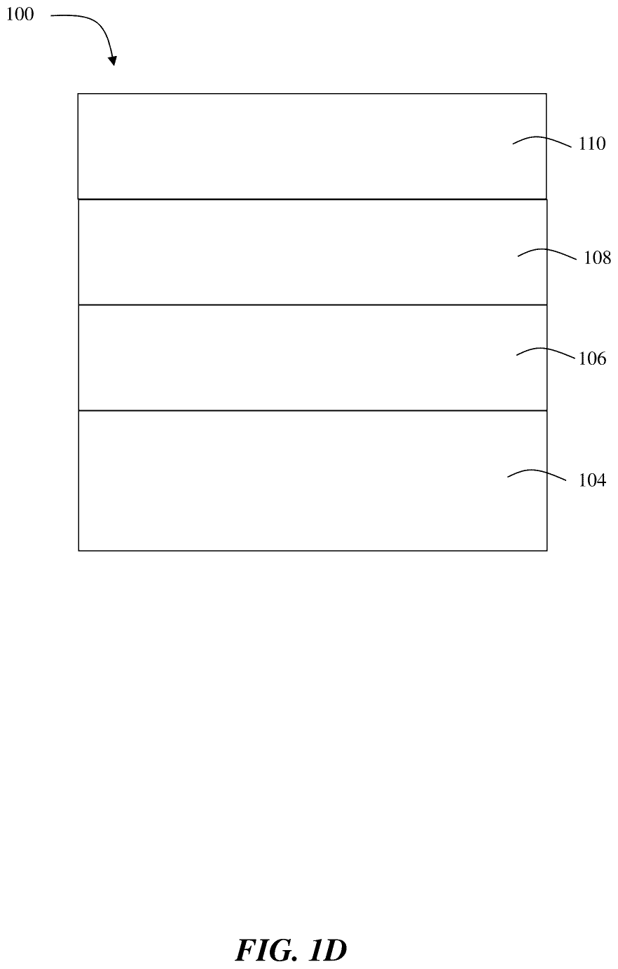

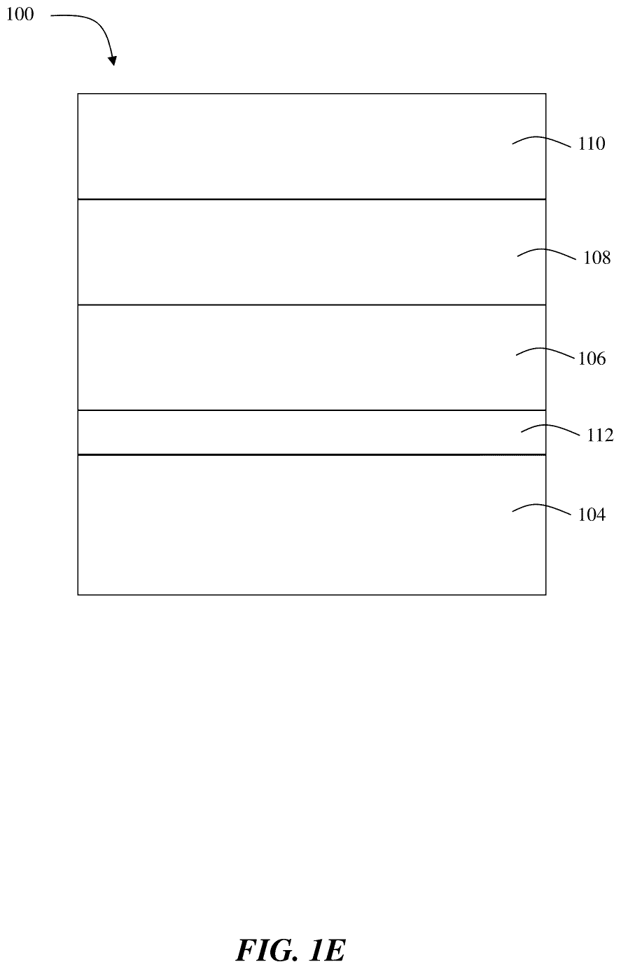

Non-limiting examples of filter media described herein are shown in FIGS. 1A-1C. In some embodiments, as illustrated in FIG. 1A, filter media 100 comprises layer 102 bonded to fourth fiber web 104. In some embodiments, the fourth fiber web 104 serves to facilitate bonding of filter media 100 to a filter housing (and/or is capable of doing so and/or is configured to do so). In some embodiments, layer 102 is disposed on fourth fiber web 104.

Fourth fiber web 104 may facilitate bonding between filter media 100 and filter housing 202, as shown in FIG. 1B. Fourth fiber web 104 may be mechanically (e.g., thermomechanically and/or ultrasonically) bonded to filter housing 202. In such instances, it may adhere other layers, such as second fiber web 106, first fiber web 108, and/or third fiber web 110 to filter housing 202. Filter housing 202 may be a component of a pour-through filter element and/or a gravity filter element. In some embodiments, filter housing 202 may be a pour-through filter housing and/or a gravity filter housing. In some embodiments, fourth fiber web 104 and filter media 100 may be disposed on the filter housing.

In some embodiments, a filter media comprises a fourth fiber web bonded to a layer that is adjacent to another layer (e.g., on an opposite side thereof from the fourth fiber web). In other words, layer 102 in FIG. 1A may also be adjacent to a layer other than the fourth fiber web. As shown in FIG. 1C, filter media 100 may comprise fourth fiber web 104 bonded to a second fiber web 106 (e.g., a support layer), and the second fiber web 106 may be directly adjacent to a first fiber web 108 (e.g., an efficiency layer)). Additionally, the layers of filter media 100 may adopt any one of a myriad of arrangements. In some embodiments, second fiber web 106, first fiber web 108, and/or one or more other layers may be disposed on fourth fiber web 104 (in this order or in a different order). As a further example, layer 102, as shown in FIG. 1A, may be the second fiber web or the third fiber web. In some embodiments, second fiber web 106 may be disposed on fourth fiber web 104. In some embodiments, first fiber web 108 may be disposed on second fiber web 106.

In some instances, when both a first and second fiber web are present, second fiber web 106 serves to promote and/or otherwise maintain the homogeneity of first fiber web 108 by decreasing the stress on the first fiber web 108 during fabrication and/or use of the filter media 100. In some embodiments, second fiber web 106 is hydrophilic. In some instances, second fiber web 106 serves to promote and/or otherwise maintain the homogeneity of first fiber web 108 by decreasing the stress on the first fiber web 108 during fabrication and/or use of the filter media 100. First fiber web 108 may be a fibrous efficiency layer having a relatively small and homogeneous pore structure. In some embodiments, the second fiber web is a meltblown layer.

As shown in FIG. 1D, a filter media may comprise three fiber webs in addition to a fourth fiber web. In such instances, and as shown in FIG. 1D, fourth fiber web 104 may be adjacent to second fiber web 106. Second fiber web 106, in this example, is directly adjacent to first fiber web 108 (e.g., an efficiency layer), which is adjacent (e.g., directly) and/or bonded to a third fiber web 110. It is also possible for a fourth fiber web to be adjacent and/or bonded to a third layer, such as on an opposing side of the third fiber web from the first fiber web (not shown). Such embodiments may further comprise a second fiber web on the opposing side of the first fiber web from the third fiber web. In some embodiments, third fiber web 110 is a meltblown layer.

As demonstrated in FIGS. 1A-1E, fourth fiber web 104 may be bonded to various combinations and/or arrangements of other layers.

In some embodiments, fourth fiber web is mechanically (e.g., thermomechanically and/or ultrasonically) bonded to other layer. For example, fourth fiber web 104 may be mechanically (e.g., thermomechanically and/or ultrasonically) bonded to second fiber web 106 or to third fiber web 110.

When present, fourth fiber web 104, in some embodiments, may be bonded to second fiber web 106 using adhesive layer 112, as shown in FIG. 1E. It is also possible for fourth fiber web 104 to be bonded to and/or disposed on third fiber web 110 using an adhesive layer (not shown). Adhesive layer 112 may be positioned between fourth fiber web 104 and a layer to which fourth fiber web 104 is bonded, such as second fiber web 106. In some embodiments, adhesive layer 112 may comprise an adhesive web and/or a hot melt glue.

The arrangement of layers depicted in FIG. 1B can be fabricated using a number of various strategies. In some embodiments, to fabricate filter media 100, fourth fiber web 104 may be bonded to another fiber web (e.g., second fiber web 106 or third fiber web 110). The bonding between fourth fiber web 104 and another fiber web present in filter media 100, in some embodiments, comprises ultrasonic bonding and/or an adhesion layer, such as adhesion layer 112 shown in FIG. 1E. As also shown in FIG. 1E, an adhesion layer may be positioned between fourth fiber web 104 and another layer of filter media 100.

It should be understood that the configurations of the fiber webs shown in the figures are by way of example only, and that in other embodiments, filter media including other configurations of fiber webs may be possible. While the various fiber webs are shown in specific orders in FIGS. 1A-1E, other configurations are also possible. For example, an optional fiber web may be positioned between the first and second fiber webs. It should be appreciated that the terms “first”, and “second” fiber webs, as used herein, refer to different fiber webs within the media, and are not meant to be limiting with respect to the location of that fiber web. Furthermore, in some embodiments, additional fiber webs (e.g., “third”, “fourth”, “fifth”, “sixth”, or “seventh” fiber webs) may be present in addition to the ones shown in the figures. It should also be appreciated that not all fiber webs shown in the figures need be present in some embodiments.

As used herein, when a fiber web is referred to as being “disposed on” another fiber web, it can be directly disposed on the fiber web, or an intervening fiber web also may be present. A fiber web that is “directly disposed on” another fiber web means that no intervening fiber web is present. When a fiber web is positioned between other fiber webs, those fiber webs can be considered to be disposed on the fiber web.

As noted above, the filter media, as described herein, may comprise a fourth fiber web. In some embodiments, the fourth fiber web is bonded to another layer in the filter media (e.g., another fiber web) using mechanical bonding. The mechanical bonding may comprise thermomechanical bonding, such as ultrasonic bonding. Ultrasonic bonding generally uses relatively high-frequency vibrations to generate sufficient heat between two materials to form a bond between the two materials. Advantageously, by using ultrasonic bonding to bond the fourth fiber web to another layer, the bond may be formed relatively quickly and/or the bond may be formed in the absence of solvents and/or other adhesives to cure. Accordingly, the fourth fiber web may advantageously allow for the adhesion of filter media to filter housing in a scalable and secure manner.

In some embodiments, a fourth fiber web may be bonded to another layer of the filter media via an adhesive layer. The adhesive layer may be positioned between the fourth fiber web and another layer of the filter media (e.g., a second fiber web or a third fiber web). In some embodiments, the adhesive layer comprises an adhesive web. In some embodiments, the adhesive web is a meltblown adhesive web. In some embodiments, the adhesive web does not limit or substantially impede flow (e.g. water flow) through the filter media. In some embodiments, the adhesive layer comprises a hot melt glue and/or epoxy. The adhesive layer, in some instances, can withstand temperatures and pressures needed for sterilization processes (e.g., those used in an autoclave).

In some embodiments, a fourth fiber web can be bonded to the second fiber web or the third fiber web. According to certain embodiments, the fourth fiber web can be bonded directly to the second or third fiber web using bonding strategies presented in the totality of this disclosure. In some embodiments, the fourth fiber web is bonded to the second or third web such that at least a portion of the third fiber web is in physical contact with at least a portion of the fourth fiber web. For example, fourth fiber web may be mechanically bonded to the third fiber web and therefore, a portion of the fourth fiber web may be in direct contact with a portion of the third fiber web. Bonding the fourth fiber web to the second or third fiber web, in some embodiments, can be carried out in a manner that does not influence or substantially change the structural integrity of other layers associated with the filter media. In some embodiments, the bonding of the fourth fiber web to the second or third fiber web can be carried out using mechanical bonding such as jet-lace techniques and/or thermomechanical bonding. In some embodiments, thermomechanical bonding includes but is not limited to heat lamination, thermo-dot bonding, calendering, ultrasonic bonding, bonding achieved by jet-lace techniques, and/or bonding achieved by an embossing technique. In some embodiments, the bonding of the fourth fiber web to the second or third fiber web can be carried out using an adhesive layer such as an adhesive layer comprising a low melting point glue (e.g., applied via spray deposition or as an adhesive webs) and/or an adhesive layer comprising a reactive and/or pressure sensitive adhesive. The aforementioned bonding strategies may be used in place of mechanical bonding and/or the adhesive layer, or in combination with mechanical bonding and/or the adhesive layer.

In some embodiments, the fourth fiber web is a scrim. A number of different types of scrims may be employed. In some embodiments, the scrim is spunbond, wetlaid, carded, flashspun, and/or meltblown. The scrim, in certain embodiments, can undergo various manufacturing processes that alter the properties of the scrim. In some embodiments, the scrim is subjected to thermo-dot bonding, calendering, through-gas bonding, embossing, hydroentangle bonding (e.g., jet lacing), and/or spunlace bonding. In some embodiments, the scrim is calendered. In some embodiments, the scrim is non-calendered.

As noted previously, a fourth fiber web may serve to facilitate bonding of filter media to the filter housing, and accordingly, the fourth fiber web may have properties that allow it to bond sufficiently to the filter housing. In some embodiments, the fourth fiber web is a scrim. In some embodiments, the scrim is embossed (e.g., as part of a mechanical bonding process and/or separately from a bonding process). In some embodiments, features that are generally indicative of embossing, such as surface depressions, may be present on the fourth fiber web. In some embodiments, embossing may comprise performing point-bonding, wave-bonding, thermal dot-bonding, and/or bonding according to other types of bonding patterns. In some embodiments, embossing may involve indenting portion of the fourth fiber web (e.g., greater than or equal to 10% of the geometric surface area of the fourth fiber web). In some embodiments, the scrim is area-bonded (e.g., bonded through a smooth surface). The scrim may be area-bonded as part of a mechanical bonding process and/or separately from a bonding process. Area-bonding, in some embodiments, may involve bonding across a relatively large portion of the fourth fiber web (e.g., greater than or equal to 60%). Accordingly, without wishing to be bound by any particular theory, an embossed scrim may have a comparatively higher void volume and thickness compared to an otherwise identical scrim that is area-bonded. In some embodiments, embossing may allow for the fourth fiber web to have advantageous melt-flow properties such that the bonding strength between an embossed fourth fiber web has a relatively higher bond strength to the filter housing compared to an area-bonded fourth fiber web bonded to the filter housing. In some embodiments, embossing may allow for a relatively large portion of fibers in the fourth fiber web to remain amorphous, while an otherwise identical fourth fiber web that has undergone an area-bonding process may comprise a greater portion of crystalline fibers adversely affecting its melt-flow properties. According to certain embodiments, the fourth fiber web comprises polyester, polyamide (e.g., nylon), polycarbonate, polysulfide, polyphenylene sulfide (PPS), polypropylene, and/or polyethylene. In some embodiments, the fourth fiber web is a polyester scrim. In some embodiments, the scrim comprises fibers. In some embodiments, the fibers comprise polyester, polyamide, polycarbonate, polyphenylene sulfide (PPS), polypropylene, and/or polyethylene. Without wishing to be bound by any particular theory, a polyester scrim may allow for the filter media to sufficiently adhere to the filter housing using any one of a myriad bonding strategies (e.g., ultrasonic bonding) without substantially limiting flow (e.g. water flow) and/or the structural integrity of the filter media.

A fourth fiber web as described herein may have a variety of different additives. In some embodiments, the fourth fiber web comprises anti-microbial additives and/or anti-fungal additives including but not limited silver-based additives and quaternary ammonium salts.

A fourth fiber web as described herein may have a variety of suitable basis weights. In some embodiments, the fourth fiber web has a basis weight of greater than or equal 20 gsm, greater than or equal 30 gsm, greater than or equal 50 gsm, greater than or equal 80 gsm, greater than or equal 100 gsm, greater than or equal 120 gsm, greater than or equal 140 gsm, greater than or equal 160 gsm, greater than or equal 180 gsm, or greater than or equal 200 gsm. In some embodiments, the fourth fiber web has a basis weight of less than or equal 200 gsm, less than or equal 180 gsm, less than or equal 160 gsm, less than or equal 140 gsm, less than or equal 120 gsm, less than or equal 100 gsm, less than or equal 80 gsm, less than or equal 50 gsm, less than or equal 30 gsm, or less than or equal 20 gsm. Combinations of these ranges are possible (e.g., greater than or equal 20 gsm and less than or equal 200 gsm, greater than or equal 30 gsm and less than or equal 100 gsm, and/or greater than or equal 50 gsm and less than or equal to 80 gsm). Other ranges are also possible.

The basis weight of the fourth fiber web may be measured in accordance with ASTM D3776-20 (2020).

A fourth fiber web as described herein may have a variety of suitable machine direction bending resistances. In some embodiments, the fourth fiber web has a machine direction bending resistance greater than or equal to 100 mgf, greater than or equal to 150 mgf, greater than or equal to 200 mgf, greater than or equal to 250 mgf, greater than or equal to 300 mgf, greater than or equal to 350 mgf, greater than or equal to 400 mgf, greater than or equal to 450 mgf, greater than or equal to 500 mgf, greater than or equal to 550 mgf, or greater than or equal to 600 mgf. In some embodiments, the fourth fiber web has a machine direction bending resistance less than or equal to 600 mgf, less than or equal to 550 mgf, less than or equal to 500 mgf, less than or equal to 450 mgf, less than or equal to 400 mgf, less than or equal to 350 mgf, less than or equal to 300 mgf, less than or equal to 250 mgf, less than or equal to 200 mgf, less than or equal to 150 mgf, or less than or equal to 100 mgf. Combinations of these ranges are possible (e.g., greater than or equal to 100 mgf and less than or equal to 600 mgf, greater than or equal to 150 mgf and less than or equal to 550 mgf, and/or greater than or equal to 200 mgf and less than or equal to 500 mgf). Other ranges are also possible.

The machine direction bending resistance of the fourth fiber web may be measured in accordance with ASTM D6125-97 (1997).

A fourth fiber web as described herein may have a variety of suitable thicknesses. In some embodiments, the fourth fiber web has a thickness greater than or equal to 0.1 mm, greater than or equal to 0.2 mm, greater than or equal to 0.3 mm, greater than or equal to 0.4 mm, greater than or equal to 0.5 mm, greater than or equal to 0.7 mm, greater than or equal to 1 mm, greater than or equal to 1.2 mm, greater than or equal to 1.4 mm, greater than or equal to 1.6 mm, greater than or equal to 1.8 mm, or greater than or equal to 2 mm. In some embodiments, the fourth fiber web has a thickness less than or equal to 2 mm, less than or equal to 1.8 mm, less than or equal to 1.6 mm, less than or equal to 1.4 mm, less than or equal to 1.2 mm, less than or equal to 1 mm, less than or equal to 0.7 mm, less than or equal to 0.5 mm, less than or equal to 0.4 mm, less than or equal to 0.3 mm, less than or equal to 0.2 mm, or less than or equal to 0.1 mm. Combinations of these ranges are possible (greater than or equal to 0.1 mm and less than or equal to 2 mm, greater than or equal to 0.3 mm and less than or equal to 1 mm, and/or greater than or equal to 0.4 mm and less than or equal to 0.7 mm). Other ranges are also possible.

The thickness of the fourth fiber web disclosed herein may be measured in accordance with ASTM D1777 (2015) under an applied pressure of 0.8 kPa.

In some embodiments, a fourth fiber web comprises a variety of different fibers. In some embodiments, the fourth fiber web comprises synthetic fibers. When present, synthetic fibers may comprise continuous fibers and/or non-continuous fibers. Continuous fibers may be made by a “continuous” fiber-forming process, such as a meltblown or a spunbond process, and typically have longer lengths than non-continuous fibers. Non-continuous fibers may be staple fibers that may be cut (e.g., from a filament) or formed as non-continuous discrete fibers to have a particular length or a range of lengths as described in more detail herein. In certain embodiments, a non-woven fiber web comprises continuous fibers that have an average length of greater than 5 inches. The synthetic fibers may comprise continuous fibers, monocomponent staple (e.g., non-continuous) fibers, multicomponent staple fibers (e.g., bicomponent staple fibers, tricomponent staple fibers, staple fibers comprising four or more components), and/or binder fibers. In some embodiments, the fourth fiber web comprises low melting point binder fibers. In some such embodiments, the binder fibers may serve as a binder for the fourth fiber web that binds fibers within the web together.

Binder fibers described herein may have any of a variety of suitable melting temperatures. In some embodiments, the melting temperature of the binding fiber (and/or a component thereof) is greater than or equal to 80 degrees Celsius, 100 degrees Celsius, 120 degrees Celsius, 140 degrees Celsius, 160 degrees Celsius, 180 degrees Celsius, 200 degrees Celsius, 220 degrees Celsius, or 240 degrees Celsius. In some embodiments, the melting temperature of the binding fiber (and/or a component thereof) is less than or equal to 240 degrees Celsius, less than or equal to 220 degrees Celsius, less than or equal to 200 degrees Celsius, less than or equal to 180 degrees Celsius, less than or equal to 160 degrees Celsius, less than or equal to 140 degrees Celsius, less than or equal to 120 degrees Celsius, less than or equal to 100 degrees Celsius, or less than or equal to 80 degrees Celsius. Combinations of these ranges are possible (e.g., greater than or equal to 80 degrees Celsius and less than or equal to 240 degrees Celsius). Other ranges are possible.

A variety of suitable types of binder fibers may be employed in the fourth fiber web described herein. In some embodiments, the binder fibers comprise multicomponent fibers and/or monocomponent fibers. The multicomponent fibers may comprise bicomponent fibers (i.e., fibers including two components), and/or may comprise fibers comprising three or more components. Multicomponent fibers may have a variety of suitable structures. For instance, a fourth fiber web may comprise one or more of the following types of multicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the fourth fiber web together while the core remains solid.

A fourth fiber web as described herein may comprise fibers having a variety of diameters. In some embodiments, the fibers have an average fiber diameter greater than or equal to 1 micrometer, greater than or equal to 5 micrometers, greater than or equal to 10 micrometers, greater than or equal to 15 micrometers, greater than or equal to 20 micrometers, greater than or equal to 25 micrometers, greater than or equal to 30 micrometers, greater than or equal to 35 micrometers, or greater than or equal to 40 micrometers. In some embodiments, the fibers have an average fiber diameter less than or equal to 40 micrometers, less than or equal to 35 micrometers, less than or equal to 30 micrometers, less than or equal to 25 micrometers, less than or equal to 20 micrometers, less than or equal to 15 micrometers, less than or equal to 10 micrometers, less than or equal to 5 micrometers, or less than or equal to 1 micrometer. Combinations of these ranges are possible (e.g., greater than or equal to 1 micrometer and less than or equal to 40 micrometers, greater than or equal to 10 micrometers and less than or equal to 30 micrometers, and/or greater than or equal to 15 micrometers and less than or equal to 25 micrometers). Other ranges are also possible.

A fourth fiber web as described herein may have a variety of suitable melting temperatures. The melting temperature of the fourth fiber web may be less than that of some or all of the other layers present in the filter media, which may allow for the fourth fiber web to be ultrasonically bonded to the filter housing without melting or otherwise disturbing these other layers. In some embodiments, the melting temperature of the fourth fiber web may be higher than temperatures typically used in sterilization processes. In some embodiments, the fourth fiber web has a melting temperature greater than or equal to 180 degrees Celsius, greater than or equal to 200 degrees Celsius, greater than or equal to 220 degrees Celsius, greater than or equal to 240 degrees Celsius, greater than or equal to 260 degrees Celsius, greater than or equal to 280 degrees Celsius, or greater than or equal to 300 degrees Celsius. In some embodiments, the fourth fiber web has a melting temperature less than or equal to 300 degrees Celsius, less than or equal to 280 degrees Celsius, less than or equal to 260 degrees Celsius, less than or equal to 240 degrees Celsius, less than or equal to 220 degrees Celsius, less than or equal to 200 degrees Celsius, or less than or equal to 180 degrees Celsius. Combinations of these ranges are possible (e.g., greater than or equal to 180 degrees Celsius and less than or equal to 300 degrees Celsius, greater than or equal to 200 degrees Celsius and less than or equal to 280 degrees Celsius, and/or greater than or equal to 220 degrees Celsius and less than or equal to 260 degrees Celsius). Other ranges are also possible.

The melting temperature of the fourth fiber web may be measured using differential scanning calorimetry in accordance with ASTM D7138-16 (2016).

A fourth fiber web as described herein may have a suitable intrinsic viscosity. In some embodiments, the intrinsic viscosity of the fourth fiber web (and/or one or more polymers positioned therein) is greater than or equal to 0.1 dL/g, greater than or equal to 0.2 dL/g, greater than or equal to 0.3 dL/g, greater than or equal to 0.4 dL/g, greater than or equal to 0.5 dL/g, greater than or equal to 0.6 dL/g, greater than or equal to 0.7 dL/g, greater than or equal to 0.8 dL/g, greater than or equal to 0.9 dL/g, greater than or equal to 1 dL/g, greater than or equal to 1.25 dL/g, greater than or equal to 1.5 dL/g, greater than or equal to 1.75 dL/g, or greater than or equal to 2 dL/g. In some embodiments, the intrinsic viscosity of the fourth fiber web (and/or one or more polymers positioned therein) is less than or equal to 2 dL/g, less than or equal to 1.75 dL/g, less than or equal to 1.5 dL/g, less than or equal to 1.25 dL/g, less than or equal to 1 dL/g, less than or equal to 0.9 dL/g, less than or equal to 0.8 dL/g, less than or equal to 0.7 dL/g, less than or equal to 0.6 dL/g, less than or equal to 0.5 dL/g, less than or equal to 0.4 dL/g, less than or equal to 0.3 dL/g, less than or equal to 0.2 dL/g, less than or equal to 0.1 dL/g. Combinations of these ranges are possible (e.g., greater than or equal to 0.1 dL/g and less than or equal to 2 dL/g, greater than or equal to 0.3 dL/g and less than or equal to 1.5 dL/g, and/or greater than or equal to 0.4 dL/g and less than or equal to 0.9 dL/g. Other ranges are also possible.

A fourth fiber web as described herein may have a suitable melting temperature that is less than that of other layers in the filter media. In some embodiments, the difference between the melting temperature of the second fiber web and/or third fiber web in the filter media and the melting temperature of the fourth fiber web is greater than or equal to 0 degrees Celsius, greater than or equal to 10 degrees Celsius, greater than or equal to 20 degrees Celsius, greater than or equal to 30 degrees Celsius, greater than or equal to 40 degrees Celsius, greater than or equal to 45 degrees Celsius, greater than or equal to 50 degrees Celsius, or greater than or equal to 60 degrees Celsius. In some embodiments, the difference between the melting temperature of the second fiber web and/or third fiber web and the melting temperature of the fourth fiber web is less than or equal to 60 degrees Celsius, less than or equal to 50 degrees Celsius, less than or equal to 45 degrees Celsius, less than or equal to 40 degrees Celsius, less than or equal to 30 degrees Celsius, less than or equal to 20 degrees Celsius, less than or equal to 10 degrees Celsius, or less than or equal to 0.1 degrees Celsius. Combinations of these ranges are possible (e.g., greater than or equal to 0 degrees Celsius and less than or equal to 60 degrees Celsius, greater than or equal to 10 degrees Celsius and less than or equal to 50 degrees Celsius, and/or greater than or equal to 20 degrees Celsius and less than or equal to 40 degrees Celsius). In some embodiments, the difference between the melting temperature of the second fiber web and/or third fiber web and the melting temperature of the fourth fiber web is identically 0 degrees Celsius. Other ranges are also possible.

A fourth fiber web as described herein may have a variety of suitable air permeabilities. In some embodiments, the fourth fiber web advantageously has an air permeability that does not substantially compromise the air permeability and/or water flow of the filter media as a whole. In some embodiments, the air permeability of the fourth fiber web is greater than or equal to 150 L/(m²·s), greater than or equal to 300 L/(m²·s), greater than or equal to 500 L/(m²·s), greater than or equal to 800 L/(m²·s), greater than or equal to 1000 L/(m²·s), greater than or equal to 1200 L/(m²·s), greater than or equal to 1500 L/(m²·s), greater than or equal to 2000 L/(m²·s), greater than or equal to 3000 L/(m²·s), greater than or equal to 5000 L/(m²·s), greater than or equal to 7000 L/(m²·s), or greater than or equal to 9000 L/(m²·s). In some embodiments, the air permeability of the fourth fiber web is less than or equal to 9000 L/(m²·s), less than or equal to 7000 L/(m²·s), less than or equal to 5000 L/(m²·s), less than or equal to 3000 L/(m²·s), less than or equal to 2000 L/(m²·s), less than or equal to 1500 L/(m²·s), less than or equal to 1200 L/(m²·s), less than or equal to 1000 L/(m²·s), less than or equal to 800 L/(m²·s), less than or equal to 500 L/(m²·s), less than or equal to 300 L/(m²·s), or less than or equal to 150 L/(m²·s). Combinations of these ranges are possible (e.g., greater than or equal to 150 L/(m²·s) and less than or equal to 9000 L/(m²·s). greater than or equal to 500 L/(m²·s) and less than or equal to 2000 L/(m²·s), and/or greater than or equal to 800 L/(m²·s) and less than or equal to 1200 L/(m²·s)). Other ranges are also possible.

The air permeability of the fourth fiber web may be measured in accordance with ASTM D737-04 (2016) at a pressure of 125 Pa.

A fourth fiber web as described herein may have a variety of suitable mean flow pore sizes. In some embodiments, the fourth fiber web has a mean flow pore size greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, or greater than or equal to 70 micrometers. In some embodiments, the fourth fiber web has a mean flow pore size less than or equal to 70 micrometers, less than or equal to 60 micrometers, less than or equal to 50 micrometers, less than or equal to 40 micrometers, less than or equal to 30 micrometers, less than or equal to 20 micrometers, or less than or equal to 10 micrometers. Combinations of these ranges are possible (e.g., greater than or equal to 10 micrometers and less than or equal to 70 micrometers, greater than or equal to 20 micrometers and less than or equal to 60 micrometers, and/or greater than or equal to 30 micrometers and less than or equal to 50 micrometers). Other ranges are also possible.

The mean flow pore size of the fourth fiber web may be measured in accordance with ASTM F316-03 (2019) Method B using a commercially-available wetting liquid Galwick having a surface tension of 15.9 dynes/cm and a tortuosity factor of 0.715.

A fourth fiber web as described herein may have a variety of suitable solidities. In some embodiments, the solidity of the fourth fiber web is greater than or equal to 1%, greater than or equal to 2%, greater than or equal to 5%, greater than or equal to 10%, greater than or equal to 15%, greater than or equal to 20%, greater than or equal to 25%, greater than or equal to 30%, greater than or equal to 35%, or greater than or equal to 40%. In some embodiments, the solidity of the fourth fiber web is less than or equal to 40%, less than or equal to 35%, less than or equal to 30%, less than or equal to 25%, less than or equal to 20%, less than or equal to 15%, less than or equal to 10%, less than or equal to 5%, less than or equal to 2%, or less than or equal to 1%. Combinations of these ranges are possible (e.g., greater than or equal to 1% and less than or equal to 40%, greater than or equal to 2% and less than or equal to 30%, and/or greater than or equal to 5% and less than or equal to 15%). Other ranges are also possible.

The solidity of the fourth fiber web is equivalent to the percentage of the interior of the fiber web occupied by solid material. One non-limiting way of determining solidity of a fiber web is described in this paragraph, but other methods are also possible. The method described in this paragraph includes determining the basis weight and thickness of the fourth fiber web and then applying the following formula: solidity=[basis weight of the fiber web/(density of the components forming the fourth fiber web·thickness of the fiber web)]·100%. The density of the components forming the fourth fiber web is equivalent to the average density of the material or material(s) forming the components of the fourth fiber web (e.g., the fibers therein, any other components therein), which is typically specified by the manufacturer of each material. The average density of the materials forming the components of the fourth fiber web may be determined by: (1) determining the total volume of all of the components in the fourth fiber web; and (2) dividing the total mass of all of the components in the fourth fiber web by the total volume of all of the components in the fourth fiber web. If the mass and density of each component of the fourth fiber web are known, the volume of all the components in the fourth fiber web may be determined by: (1) for each type of component, dividing the total mass of the component in the fourth fiber web by the density of the component; and (2) summing the volumes of each component. If the mass and density of each component of the fourth fiber web are not known, the volume of all the components in the fourth fiber web may be determined in accordance with Archimedes' principle.

A fourth fiber web as described herein may be bonded to another layer (e.g., a second fiber web or a third fiber web) and accordingly, may have a variety of peak peel strengths. In some embodiments, the peak peel strength between the fourth fiber web and a layer to which it is bonded (e.g., a second fiber web or a third fiber web) is greater than or equal to 0.1 g/mm, greater than or equal to 0.15 g/mm, greater than or equal to 0.2 g/mm, greater than or equal to 0.3 g/mm, greater than or equal to 0.4 g/mm, greater than or equal to 0.5 g/mm, greater than or equal to 0.75 g/mm, greater than or equal to 1 g/mm, greater than or equal to 1.5 g/mm, greater than or equal to 2 g/mm, greater than or equal to 2.5 g/mm, greater than or equal to 3 g/mm, greater than or equal to 4 g/mm, greater than or equal to 5 g/mm, greater than or equal to 6 g/mm, greater than or equal to 7 g/mm, greater than or equal to 8 g/mm, greater than or equal to 9 g/mm, greater than or equal to 10 g/mm, greater than or equal to 12.5 g/mm, greater than or equal to 15 g/mm, greater than or equal to 20 g/mm, greater than or equal to 30 g/mm, greater than or equal to 40 g/mm, greater than or equal to 80 g/mm, greater than or equal to 120 g/mm, greater than or equal to 150 g/mm, greater than or equal to 200 g/mm, greater than or equal to 250 g/mm, or greater than or equal to 300 g/mm. In some embodiments, the peak peel strength between the fourth fiber web and a layer to which it is bonded is less than or equal to 300 g/mm, less than or equal to 250 g/mm, less than or equal to 200 g/mm, less than or equal to 150 g/mm, less than or equal to 120 g/mm, less than or equal to 80 g/mm, less than or equal to 40 g/mm, less than or equal to 30 g/mm, less than or equal to 20 g/mm, less than or equal to 15 g/mm, less than or equal to 12.5 g/mm, less than or equal to 10 g/mm, less than or equal to 9 g/mm, less than or equal to 8 g/mm, less than or equal to 7 g/mm, less than or equal to 6 g/mm, less than or equal to 5 g/mm, less than or equal to 4 g/mm, less than or equal to 3 g/mm, less than or equal to 2.5 g/mm, less than or equal to 2 g/mm, less than or equal to 1.5 g/mm, less than or equal to 1 g/mm, less than or equal to 0.75 g/mm, less than or equal to 0.5 g/mm, less than or equal to 0.4 g/mm, less than or equal to 0.3 g/mm, less than or equal to 0.2 g/mm, or less than or equal to 0.15 g/mm. Combinations of these ranges are also possible (e.g., greater than or equal to 0.1 g/mm and less than or equal to 300 g/mm, greater than or equal to 0.1 g/mm and less than or equal to 10 g/mm, greater than or equal to 0.15 g/mm and less than or equal to 7 g/mm, greater than or equal to 0.2 g/mm and less than or equal to 3 g/mm, greater than or equal to 15 g/mm and less than or equal to 300 g/mm, greater than or equal to 30 g/mm and less than or equal to 200 g/mm, and/or greater than or equal to 40 g/mm and less than or equal to 150 g/mm). Other ranges are also possible.

The peak peel strength between the fourth fiber web and another layer may be measured in accordance with ASTM D1876-08 (2001) at 12 in/min (305 mm/min) separation speed.

A fourth fiber web may facilitate the bonding of a filter media to a filter housing. The filter housing may be a housing for a filter element. The filter housing, in some instances, is a housing for a gravity filter element. In some embodiments, the filter housing is a housing for a pour-through filter element. In some embodiments, the filter housing is a gravity filter housing. In some embodiments, the filter housing is a pour-through filter housing.

In some embodiments, a filter housing is a housing for a filter media. As noted below, a filter housing and a filter media may together be provided as a filter element. Filter housings, and filter elements in which they are positioned, may have a variety of suitable geometries. In some embodiments, the geometry of the filter element is a plate-and-frame filter element, a filter element including a pleated filter media (e.g., pleated composite with or without additional scrim layers), a panel filter element, a disk filter element (e.g., including a flat disk filter media), a filter element in which a filter media is wrapped (e.g., a wrap-around filter element), and/or a spiral-wound filter element. Further non-limiting examples of suitable geometries for filter elements include cylindrical filter elements (e.g., having a base that is oval, round, triangular, square, polygonal, or star-shaped), straight filter elements, tapered filter elements, sectional filter elements, single-bodied filter elements, single-stage filter elements, and multi-stage filter elements.

In some embodiments, additional filter components may be included in a filter housing including but not limited to membrane-based filter media, meltblown, carded, wetlaid, spunbond, flashspun, and/or other layers. In some embodiments, the additional filter components may be positioned to form a gradient density structure. That is, a gradient density structure, in one example, may comprise a pore size, air permeability, solidity, and/or a fiber diameter that gradually increases and/or decreases from an upstream portion of the filter element to a downstream portion of the filter element.

A filter housing as described herein may comprise a variety of suitable materials capable of bonding to a fourth fiber web. In some embodiments, the filter housing comprises a thermoplastic material. In some embodiments, the filter housing comprises polypropylene (PP), polystyrene (PS), acrylonitrile butadiene styrene (ABS), Delrin acetal, low-density polyethylene (LDPE), high-density polyethylene (HDPE), extruded nylon, cast nylon, polyester, crosslinked polystyrene (Rexolite), ultra-high-molecular-weight polyethylene (UHMWPE), polyphenylene sulfide (PPS), fluorinated ethylene propylene (FEP), polyvinyl chloride (PVC), and/or polyvinylidene fluoride or polyvinylidene difluoride (PVDF). Without wishing to be bound by any particular theory, the bond strength between the fourth fiber web and the filter housing may be related to the difference in melting temperatures between the filter housing and the fourth fiber web. That is, a relatively small difference between the melting temperatures of the fourth fiber web and the filter housing may result in relatively high bonding strengths, while a relatively large difference between the melting temperatures of the fourth fiber web and the filter housing may result in relatively low bonding strengths. Similarly, the intrinsic viscosity of the fourth fiber web (and/or one or more polymers therein) may also influence the bonding strength between the filter media and the filter housing. A fourth fiber web having a relatively low intrinsic viscosity may have a relatively higher bonding strength to the filter housing than an otherwise identical fourth fiber web having a relatively high intrinsic viscosity.

In some embodiments, a fourth fiber web may be capable of bonding to a filter housing using any of a myriad of bonding techniques. In some embodiments, the bonding of the fourth fiber web to the filter housing can be carried out using mechanical bonding as described elsewhere herein (e.g., thermomechanical bonding) and/or via an adhesive layer as described elsewhere herein (e.g., comprising a low melting point glue, such as a low melting point glue applied via spray deposition and/or as an adhesive web, and/or comprising a reactive and/or pressure sensitive adhesive). In some embodiments, the filter media may be attached to the filter housing via a reversible clamp (e.g., in a plate-and-frame geometry) that allows for the attachment and detachment of the filter media from the filter housing. Accordingly, the filter media may be removed and/or replaced when reversibly attached to the filter housing.

A filter housing as described herein may comprise a variety of properties that may be desirable for the commercialization of filtration applications. In some embodiments, the filter housing may be formed via scalable manufacturing processes such as injection molding and/or extrusion molding.

In some embodiments, the filter housing is translucent. In some embodiments, the filter housing is opaque.

A fourth fiber web as described herein may be bonded to a second or third fiber web using an adhesive layer. The adhesive layer, as previously described, may be positioned between the fourth fiber web and the second or third fiber web. In some embodiments, the adhesive layer facilitates the adhesion between the fourth fiber web and other layers of the filter media, such that the filter media can be bonded thereto. In some embodiments, the adhesive layer is an adhesive web (e.g., a fiber web, such as a meltblown fiber web). In some embodiments, the adhesive layer comprises a hot melt glue (e.g., fibers present in an adhesive web may comprise a hot melt glue). In some embodiments, the adhesive layer comprises a reactive adhesive and/or a pressure sensitive adhesive (e.g., fibers present in an adhesive web may comprise a reactive adhesive and/or a pressure sensitive adhesive). In some embodiments, the adhesive layer is thermally activated, such that when the adhesive layer is exposed to a temperature greater than its melting temperature, the adhesive layer facilitates bonding between the fourth fiber web and the second and/or third fiber web.

An adhesive layer as described herein may have a variety of suitable chemistries. In some embodiments, the adhesive layer comprises an acrylic copolymer, a copolyester, a polyolefin, a polyamide, a polyurethane, a styrene block copolymer, a thermoplastic elastomer, a polycarbonate, and/or a silicone. In some embodiments, the adhesive layer comprises polypropylene. In some embodiments, the adhesive layer comprises a copolyester. In some embodiments, the adhesive layer comprises fibers (e.g., it may be a fiber web). In some embodiments, the fibers comprise an acrylic copolymer, a copolyester, a polyolefin, a polyamide, a polyurethane, a styrene block copolymer, a thermoplastic elastomer, a polycarbonate, and/or a silicone. In some embodiments, the fibers comprise polypropylene.

An adhesive layer as described herein may comprise the adhesive web having any of a variety of suitable basis weights. In some embodiments, the basis weight of the adhesive web is greater than or equal to 0.1 gsm, greater than or equal to 1 gsm, greater than or equal to 2 gsm, greater than or equal to 3 gsm, greater than or equal to 4 gsm, greater than or equal to 5 gsm, greater than or equal to 6 gsm, greater than or equal to 8 gsm, greater than or equal to 10 gsm, or greater than or equal to 12 gsm. In some embodiments, the basis weight of the adhesive web is less than or equal to 12 gsm, less than or equal to 10 gsm, less than or equal to 8 gsm, less than or equal to 6 gsm, less than or equal to 5 gsm, less than or equal to 4 gsm, less than or equal to 3 gsm, less than or equal to 2 gsm, less than or equal to 1 gsm, or less than or equal to 0.1 gsm. Combinations of these ranges are possible (e.g., greater than or equal to 0.1 gsm and less than or equal to 12 gsm, greater than or equal to 2 gsm and less than or equal to 10 gsm, and/or greater than or equal to 3 gsm and less than or equal to 6 gsm). Other ranges are also possible.

The basis weight of the adhesive layer can be measured in accordance with ASTM D3776-20 (2020).

An adhesive layer as described herein may have a variety of suitable melting temperatures. In some embodiments, the melting temperature of the adhesive layer is greater than or equal to the melting temperature of the fourth fiber web. In some embodiments, the melting temperature of the adhesive layer is greater than the temperature of sterilization processes (e.g., autoclaving). In some embodiments, the melting temperature of the adhesive layer is greater than or equal to 110 degrees Celsius, greater than or equal to 120 degrees Celsius, greater than or equal to 130 degrees Celsius, greater than or equal to 140 degrees Celsius, greater than or equal to 150 degrees Celsius, greater than or equal to 160 degrees Celsius, greater than or equal to 170 degrees Celsius, greater than or equal to 180 degrees Celsius, greater than or equal to 190 degrees Celsius, or greater than or equal to 200 degrees Celsius. In some embodiments, the melting temperature of the adhesive layer is less than or equal to 200 degrees Celsius, less than or equal to 190 degrees Celsius, less than or equal to 180 degrees Celsius, less than or equal to 170 degrees Celsius, less than or equal to 160 degrees Celsius, less than or equal to 150 degrees Celsius, less than or equal to 140 degrees Celsius, less than or equal to 130 degrees Celsius, less than or equal to 120 degrees Celsius, or less than or equal to 110 degrees Celsius. Combinations of these ranges are possible (e.g., greater than or equal to 110 degrees Celsius and less than or equal to 200 degrees Celsius, greater than or equal to 130 degrees Celsius and less than or equal to 180 degrees Celsius, and/or greater than or equal to 140 degrees Celsius and less than or equal to 170 degrees Celsius). Other ranges are also possible.

The melting temperature of the adhesive layer may be measured using differential scanning calorimetry in accordance with ASTM D7138-16 (2016).

An adhesive layer as described herein may have a variety of suitable decomposition temperatures. In some embodiments, the adhesive layer has a decomposition temperature greater than or equal to 170 degrees Celsius, greater than or equal to 200 degrees Celsius, greater than or equal to 300 degrees Celsius, greater than or equal to 400 degrees Celsius, greater than or equal to 500 degrees Celsius, greater than or equal to 600 degrees Celsius, greater than or equal to 700 degrees Celsius, or greater than or equal to 800 degrees Celsius. In some embodiments, the adhesive layer has a decomposition temperature less than or equal to 800 degrees Celsius, less than or equal to 700 degrees Celsius, less than or equal to 600 degrees Celsius, less than or equal to 500 degrees Celsius, less than or equal to 400 degrees Celsius, less than or equal to 300 degrees Celsius, less than or equal to 200 degrees Celsius, or less than or equal to 170 degrees Celsius. Combinations of these ranges are also possible (e.g., greater than or equal to 170 degrees Celsius and less than or equal to 800 degrees Celsius, greater than or equal to 200 degrees Celsius and less than or equal to 700 degrees Celsius, or greater than or equal to 500 degrees Celsius and less than or equal to 300 degrees Celsius). Other ranges are also possible.

The decomposition temperature of the adhesive layer can be measured using thermal gravitational analysis in accordance with ASTM E2550-21 (2021).

An adhesive layer as described herein may have any of a variety of suitable air permeabilities. In some embodiments, the adhesive layer does not substantially change and/or alter the air permeability of the filter media and/or the fourth fiber web. In some embodiments, a filter media comprising the adhesive layer has an air permeability greater than or equal to 40%, greater than or equal to 50%, greater than or equal to 60%, greater than or equal to 70%, greater than or equal to 80%, greater than or equal to 90%, or greater than or equal to 95% the air permeability of an otherwise-equivalent filter media lacking the adhesive layer. In some embodiments, a filter media comprising the adhesive layer has an air permeability less than or equal to 100%, less than or equal to 95%, less than or equal to 90%, less than or equal to 80%, less than or equal to 70%, less than or equal to 60%, less than or equal to 50%, or less than or equal to 40% the air permeability of an otherwise-equivalent filter media lacking the adhesive layer. Combinations of these ranges are possible (e.g., greater than or equal to 40% and less than or equal to 100%, or greater than or equal to 80% and less than or equal to 100%). Other ranges are possible. In some embodiments, the filter media comprising the adhesive layer has an air permeability equal to 100% the air permeability of an otherwise-equivalent filter media lacking the adhesive layer.

An adhesive layer as described herein may have any of a variety of suitable properties. In some embodiments, the adhesive layer comprises, consists of, and/or consists essentially of a food-grade material. In some embodiments, the food-grade material may meet some or all of the requirements for food contact applications in accordance with US 21 CFR and EU 10/2011, and/or be substantially free of PFAS, lead, and/or bis-phenol A. In some embodiments, the adhesive layer is hydrophobic. In some embodiments, the adhesive layer provides sufficient adhesion between the fourth fiber web and other layers of the filter media such they do not delaminate after exposure to a sterilization process (e.g., an autoclave, such as an autoclave operated at a temperature present during a sterilization process as described elsewhere herein).

An adhesive layer as described herein may have any of a variety of suitable hydrostatic pressures. In some embodiments, the adhesive layer does not substantially change and/or alter the hydrostatic pressure of the filter media and/or the fourth fiber web. In some embodiments, a filter media comprising the adhesive layer has a hydrostatic pressure of greater than or equal to 80%, greater than or equal to 82.5%, greater than or equal to 85%, greater than or equal to 87.5%, greater than or equal to 90%, or greater than or equal to 95% of the hydrostatic pressure of an otherwise-equivalent filter media lacking the adhesive layer. In some embodiments, a filter media comprising the adhesive layer has a hydrostatic pressure of less than or equal to 95%, less than or equal to 90%, less than or equal to 87.5%, less than or equal to 85%, less than or equal to 82.5%, or less than or equal to 80% of the hydrostatic pressure of an otherwise-equivalent filter media lacking the adhesive layer. Combinations of these ranges are possible (e.g., greater than or equal to 80% and less than or equal to less than or equal to 95%). Other ranges are also possible. In some embodiments, the filter media comprising the adhesive layer has a hydrostatic pressure equal to 100% the hydrostatic pressure of an otherwise-equivalent filter media lacking the adhesive layer.

The hydrostatic pressure of an adhesive layer may be determined according to the standard AATCC 127-2008 (2008).

In some embodiments, one or more additional fiber webs or components are included with the filter media. In certain embodiments, the filter media may include one or more additional fiber webs. For instance, the filter media may include five or more (e.g., six or more, seven or more) fiber webs. In some embodiments, the additional fiber web(s) may comprise a protective layer. For instance, the filter media may comprise a first fiber web (e.g., efficiency layer) adjacent to (e.g., directly adjacent to) a second fiber web (e.g., calendered fiber web) and a third fiber web (e.g., efficiency layer) and a fifth fiber web (e.g., protective fiber web) adjacent to (e.g., directly adjacent to) to the third fiber web. In such cases, the filter media may also comprise a fifth fiber web (e.g., support layer) adjacent to (e.g., directly adjacent to) the second fiber web. In some embodiments, the additional fiber web may be a support layer. In some such cases, the support layer (e.g., spunbond fiber web) may be adjacent to the second fiber web. As another example, the filter media may comprise a first fiber web (e.g., efficiency layer) adjacent to (e.g., directly adjacent to) a second fiber web (e.g., calendered fiber web) and a third fiber web (e.g., protective layer) and a fifth fiber web (e.g., support layer) adjacent to (e.g., directly adjacent to) to the second fiber web. In some embodiments, the one or more additional fiber webs can be directly adjacent to the fourth fiber webs. In some instances, the fourth fiber web may be bonded to the one or more additional fiber webs.

Non-limiting examples of additional fiber webs (e.g., a fifth fiber web) include a meltblown fiber web, a wet laid fiber web, a spunbond fiber web, a carded fiber web, an air-laid fiber web, a spunlace fiber web, a forcespun fiber web or an electrospun fiber web.

In some embodiments, a non-wet laid process, such as an air laid or carding process, may be used to form one or more fiber webs. For example, in an air laid process, synthetic fibers may be mixed, while air is blown onto a conveyor. In a carding process, in some embodiments, the fibers are manipulated by rollers and extensions (e.g., hooks, needles) associated with the rollers. In some cases, forming the fiber webs through a non-wet laid process may be more suitable for the production of a highly porous media. In some embodiments, a non-wet laid process (e.g., electrospun, meltblown) may be used to form the first fiber web and a wet laid process may be used to form the second fiber web. The first fiber web and the second fiber web may be combined using any suitable process (e.g., lamination, calendering, smooth roll calendering).

As noted above, filter media, described herein, may comprise a first fiber web (e.g., efficiency layer) having a relatively small and homogeneous pore structure. In some embodiments, the maximum pore size of the first fiber web may be relatively small. For instance, in some embodiments, the first fiber web may have a maximum pore size of less than or equal to 10 micrometers, less than or equal to 9 micrometers, less than or equal to 8 micrometers, less than or equal to 7 micrometers, less than or equal to 6 micrometers, less than or equal to 5 micrometers, less than or equal to 2.5 micrometers, less than or equal to 2.3 micrometers, less than or equal to 2 micrometers, less than or equal to 1.8 micrometers, less than or equal to 1.5 micrometers, less than or equal to 1.4 micrometers, less than or equal to 1.3 micrometers, less than or equal to 1.2 micrometers, less than or equal to 1.1 micrometers, less than or equal to 1 micrometer, less than or equal to 0.9 micrometers, less than or equal to 0.8 micrometers, less than or equal to 0.7 micrometers, less than or equal to 0.6 micrometers, less than or equal to 0.5 micrometers, less than or equal to 0.4 micrometers, less than or equal to 0.3 micrometers, or less than or equal to 0.2 micrometers. In some instances, the first fiber web may have a maximum pore size of greater than or equal to 0.1 micrometers, greater than or equal to 0.2 micrometers, greater than or equal to 0.3 micrometers, greater than or equal to 0.4 micrometers, greater than or equal to 0.5 micrometers, greater than or equal to 0.6 micrometers, greater than or equal to 0.7 micrometers, greater than or equal to 0.8 micrometers, greater than or equal to 0.9 micrometers, greater than or equal to 1 micrometer, greater than or equal to 1.1 micrometers, greater than or equal to 1.2 micrometers, greater than or equal to 1.4 micrometers, greater than or equal to 1.6 micrometers, greater than or equal to 1.8 micrometers, greater than or equal to 2 micrometers, greater than or equal to 2.2 micrometers, greater than or equal to 2.5 micrometers, greater than or equal to 5 micrometers, greater than or equal to 6 micrometers, greater than or equal to 7 micrometers, greater than or equal to 8 micrometers, greater than or equal to 9 micrometers, or greater than or equal to 10 micrometers. Combinations of the above-referenced ranges are also possible (e.g., greater than or equal to 0.1 micrometers and less than or equal to 10 micrometers, greater than or equal to 0.5 micrometers and less than or equal to 8 micrometers, and/or greater than or equal to 1 micrometers and less than or equal to 5 micrometers). Other values of maximum pore size are also possible.

The maximum pore size of the first fiber web may be determined via bubble point measurement according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm.

In some embodiments, the mean flow pore size of the first fiber web may be less than or equal to 1 micrometer, less than or equal to 0.9 micrometers, less than or equal to 0.8 micrometers, less than or equal to 0.7 micrometers, less than or equal to 0.6 micrometers, less than or equal to 0.5 micrometers, less than or equal to 0.4 micrometers, less than or equal to 0.3 micrometers, less than or equal to 0.2 micrometers, less than or equal to 0.1 micrometers, or less than or equal to 0.08 micrometers. In some instances, the mean flow pore size may be greater than or equal to 0.05 micrometers, greater than or equal to 0.06 micrometers, greater than or equal to 0.07 micrometers, greater than or equal to 0.08 micrometers, greater than or equal to 0.1 micrometers, greater than or equal to 0.2 micrometers, greater than or equal to 0.3 micrometers, greater than or equal to 0.4 micrometers, greater than or equal to 0.5 micrometers, greater than or equal to 0.6 micrometers, greater than or equal to 0.7 micrometers, greater than or equal to 0.8 micrometers, or greater than or equal to 0.9 micrometers. Combinations of the above-referenced ranges are also possible (e.g., greater than or equal to 0.05 micrometers and less than or equal to 1 micrometer, greater than or equal to 0.1 micrometers and less than or equal to 0.4 micrometers).

The mean flow pore size of the first fiber web may be determined according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm and a tortuosity factor of 0.715.

In some embodiments, the pore characteristics of the first fiber web may be relatively homogenous. For instance, in some embodiments, the ratio of maximum pore size to mean flow pore size of the first fiber web may be less than or equal to 25, less than or equal to 20, less than or equal to 15, less than or equal to 10, less than or equal to 8, less than or equal to 5, less than or equal to 4.8, less than or equal to 4.5, less than or equal to 4.2, less than or equal to 4, less than or equal to 3.8, less than or equal to 3.5, less than or equal to 3.2, less than or equal to 3, less than or equal to 2.7, less than or equal to 2.5, less than or equal to 2.2, less than or equal to 2, less than or equal to 1.8, less than or equal to 1.5, or less than or equal to 1.2. In some instances, the ratio of maximum pore size to mean flow pore size may be greater than or equal to 1, greater than or equal to 1.2, greater than or equal to 1.5, greater than or equal to 1.8, greater than or equal to 2, greater than or equal to 2.3, greater than or equal to 2.5, greater than or equal to 2.8, greater than or equal to 3, greater than or equal to 3.2, greater than or equal to 3.5, greater than or equal to 3.8, greater than or equal to 4, greater than or equal to 4.2, greater than or equal to 4.5, greater than or equal to 4.8, greater than or equal to 5, greater than or equal to 8, greater than or equal to 10, greater than or equal to 15, greater than or equal to 20, greater than or equal to 25. Combinations of the above-referenced ranges are also possible (e.g., greater than or equal to 1 and less than or equal to 25, greater than or equal to 1.5 and less than or equal to 15, and/or greater than or equal to 2 and less than or equal to 8). The ratio may be determined according to the standard ASTM F316-03 (2019) Method B, BS6410 (2011) as described above. As described in more detail below, the first fiber web may comprise synthetic fibers (e.g., nylon fibers), amongst other fiber types. In some instances, the first fiber web may comprise a relatively high weight percentage of synthetic fibers (e.g., greater than or equal to about 95 wt. %, 100 wt. %). In some instances, the synthetic fibers may be continuous as described further below. For example, the fiber web may comprise a relatively high percentage (e.g., greater than or equal to about 95 wt. %, 100 wt. %) of synthetic fibers formed via an electrospinning process. In general, the first fiber web may comprise synthetic fibers formed by any suitable process including an electrospinning process, meltblown process, melt spinning process, or centrifugal spinning process. In certain embodiments, the first fiber web may comprise nylon and/or poly(ether sulfone) (PES) fibers. In some embodiments, an electrospinning process facilitates the formation of an efficiency layer with a small mean pore size and a narrow pore size distribution.

In some embodiments, the first fiber web may have an average fiber diameter of less than or equal to 0.5 micrometers, less than or equal to 0.45 micrometers, less than or equal to 0.4 micrometers, less than or equal to 0.35 micrometers, less than or equal to 0.3 micrometers, less than or equal to 0.25 micrometers, less than or equal to 0.2 micrometers, less than or equal to 0.15 micrometers, less than or equal to 0.1 micrometers, less than or equal to 0.09 micrometers, less than or equal to 0.08 micrometers, less than or equal to 0.07 micrometers, or less than or equal to 0.06 micrometers. In some instances, the average fiber diameter of the first fiber web may be greater than or equal to 0.05 micrometers, greater than or equal to 0.06 micrometers, greater than or equal to 0.07 micrometers, greater than or equal to 0.08 micrometers, greater than or equal to 0.09 micrometers, greater than or equal to 0.1 micrometers, greater than or equal to 0.15 micrometers, greater than or equal to 0.2 micrometers, greater than or equal to 0.25 micrometers, greater than or equal to 0.3 micrometers, greater than or equal to 0.35 micrometers, greater than or equal to 0.4 micrometers, or greater than or equal to 0.45 micrometers. Combinations of the above-referenced ranges are also possible (e.g., greater than or equal to 0.05 micrometers and less than or equal to 0.5 micrometers, greater than or equal to 0.07 micrometers and less than or equal to 0.2 micrometers). Other values of average fiber diameter are also possible. In some embodiments, the first fiber web comprises a nanofiber web. That is, the first fiber web comprises fibers having a diameter less than or equal to 1 micrometer.

In some embodiments, the first fiber web may be relatively thin. For instance, in some embodiments, the first fiber web may have a thickness of less than or equal to 200 micrometers, less than or equal to 175 micrometers, less than or equal to 150 micrometers, less than or equal to 125 micrometers, less than or equal to 100 micrometers, less than or equal to 75 micrometers, less than or equal to 50 micrometers, less than or equal to 40 micrometers, less than or equal to 30 micrometers, less than or equal to 20 micrometers, less than or equal to 18 micrometers, less than or equal to 15 micrometers, less than or equal to 12 micrometers, less than or equal to 10 micrometers, or less than or equal to 8 micrometers. In some instances, the first fiber web may have a thickness of greater than or equal to 5 micrometers, greater than or equal to 6 micrometers, greater than or equal to 8 micrometers, greater than or equal to 10 micrometers, greater than or equal to 12 micrometers, greater than or equal to 15 micrometers, greater than or equal to 18 micrometers, greater than or equal to 20 micrometers, greater than or equal to 25 micrometers, greater than or equal to 30 micrometers, greater than or equal to 40 micrometers, greater than or equal to 50 micrometers, greater than or equal to 75 micrometers, greater than or equal to 100 micrometers, greater than or equal to 125 micrometers, greater than or equal to 150 micrometers, or greater than or equal to 175 micrometers. Combinations of the above-referenced ranges are also possible (e.g., greater than or equal to 5 micrometers and less than or equal to 200 micrometers, greater than or equal to 5 micrometers and less than or equal to 20 micrometers). Other values of average thickness are also possible. In some embodiments, the thickness is determined using scanning electron microscopy (SEM).

Thicknesses of the first fiber web of 5 micrometers or greater may be determined according to the standard ASTM D1777-96 (2015) using a pressure of 2.65 psi. Thicknesses of the first fiber web less than 5 micrometers may be determined using scanning electron microscopy.

In some embodiments, the first fiber web may have a relatively low basis weight. For instance, in some embodiments, the first fiber web may have a basis weight of less than or equal to 10 gsm, less than or equal to 9 gsm, less than or equal to 8 gsm, less than or equal to 7 gsm, less than or equal to 6 gsm, less than or equal to 5 gsm, less than or equal to 4.5 gsm, less than or equal to 4 gsm, less than or equal to 3.5 gsm, less than or equal to 3 gsm, less than or equal to 2.5 gsm, less than or equal to 2 gsm, less than or equal to 1.5 gsm, less than or equal to 1 gsm, or less than or equal to 0.8 gsm. In some instances, the first fiber web may have a basis weight of greater than or equal to 0.5 gsm, greater than or equal to 1 gsm, greater than or equal to 1.5 gsm, greater than or equal to 2 gsm, greater than or equal to 2.5 gsm, greater than or equal to 3 gsm, greater than or equal to 3.5 gsm, greater than or equal to 4 gsm, greater than or equal to 5 gsm, greater than or equal to 6 gsm, greater than or equal to 7 gsm, or greater than or equal to 8 gsm. Combinations of the above-referenced ranges are possible (e.g., greater than or equal to 0.5 gsm and less than or equal to 10 gsm, greater than or equal to 0.5 gsm and less than or equal to 5 gsm, greater than or equal to 1 gsm and less than or equal to 2 gsm). Other values of basis weight are possible.

The basis weight of the first fiber web may be determined according to the standard ASTM D3776-09 (2009).

In certain embodiments, the first fiber web, described herein, may have a relatively low solidity. For instance, in some embodiments, the first fiber web may have a solidity of less than or equal to 30%, less than or equal to 28%, less than or equal to 25%, less than or equal to 22%, less than or equal to 20%, less than or equal to 18%, less than or equal to 15%, less than or equal to 12%, less than or equal to 10%, less than or equal to 8%, or less than or equal to 5%. In some instances, the first fiber web may have a solidity of greater than or equal to 2%, greater than or equal to 5%, greater than or equal to 8%, greater than or equal to 10%, greater than or equal to 12%, greater than or equal to 15%, greater than or equal to 20%, greater than or equal to 22%, greater than or equal to 25%, or greater than or equal to 28%. It should be understood that combinations of the above-reference ranges are possible (e.g., greater than or equal to 2% and less than or equal to 30%, greater than or equal to 5% and less than or equal to 12%). The solidity of a first fiber web may determined as previously described in this disclosure with respect to the determinations of the solidity of fourth fiber webs.

In certain embodiments, the first fiber web, described herein, may have a relatively high surface area. For instance, in some embodiments, the first fiber web may have a surface area of greater than or equal to 5 m²/g, greater than or equal to 10 m²/g, greater than or equal to 25 m²/g, greater than or equal to 50 m²/g, greater than or equal to 75 m²/g, greater than or equal to 100 m²/g, greater than or equal to 125 m²/g, greater than or equal to 150 m²/g, greater than or equal to 175 m²/g, greater than or equal to 200 m²/g, greater than or equal to 225 m²/g, greater than or equal to 250 m²/g, greater than or equal to 275 m²/g, or greater than or equal to 300 m²/g. In some instances, the first fiber web may have a surface area of less than or equal to 350 m²/g, less than or equal to 325 m²/g, less than or equal to 300 m²/g, less than or equal to 275 m²/g, less than or equal to 250 m²/g, less than or equal to 225 m²/g, less than or equal to 200 m²/g, less than or equal to 175 m²/g, less than or equal to 150 m²/g, less than or equal to 125 m²/g, less than or equal to 100 m²/g, less than or equal to 70 m²/g, less than or equal to 40 m²/g, or less than or equal to 10 m²/g. It should be understood that combinations of the above-referenced ranges are possible (e.g., greater than or equal to 5 m²/g and less than or equal to 350 m²/g, greater than or equal to 5 m²/g and less than or equal to 70 m²/g, and/or greater than or equal to 5 m²/g and less than or equal to 75 m²/g).

As determined herein, the surface area of the first fiber web is measured through use of a standard BET surface area measurement technique. The BET surface area is measured according to section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the BET surface area is measured via adsorption analysis using a BET surface analyzer (e.g., Micromeritics Gemini III 2375 Surface Area Analyzer) with nitrogen gas; the sample amount is between 0.5 and 0.6 grams in, e.g., a ¾″ tube; and, the sample is allowed to degas at 75 degrees C. for a minimum of 3 hours.

In some embodiments, a first fiber web is non-calendered. In some embodiments, the non-calendered first fiber web comprises a spunbond layer.

As described herein, the filter media may comprise a second fiber web (e.g., calendered fiber web). In some embodiments, one or more properties of the second fiber web may impart beneficial properties to the filter media, such as relatively homogeneous pore characteristics and mechanical stability. For instance, certain pore characteristics (e.g., solidity, surface mean pore area, intersection density (number of intersections per unit area), pore size), certain mechanical properties (e.g., tensile strength, tensile elongation), and/or the smoothness of the second fiber web may serve to promote relative pore homogeneity and/or provide mechanical stability for one or more fiber webs (e.g., first fiber web). In some embodiments, a second fiber web with the above-mentioned beneficial properties may be formed using a calendering process. In some such cases, the second fiber web may be calendered prior to combination with another fiber web (e.g., first fiber web) in the filter media and/or inclusion into the filter media. In other embodiments, a second fiber web with the above-mentioned beneficial properties may be formed by casting a cross-linkable monomer solution (e.g., acrylate, acrylamide or cellulose monomers) on to a non-compressed fiber web (e.g., meltblown fiber web), such that the cross-linkable monomer solution fully wets the pores of the non-compressed fiber web (e.g., meltblown fiber web). In some such embodiments, crosslinking and polymerization of the monomer leads to pore filling and strengthening of the fiber web. In some such embodiments, crosslinking can be initiated via irradiation, or a chemical process or a thermal treatment. The crosslinked or polymerized monomer may be a sacrificial layer that is removed after deposition of the first fiber web (e.g., efficiency layer).

In some embodiments, the distance between fibers in the second layer may be relatively small. Without being bound by theory, it is believed that fibers of the first fiber web are more likely to uniformly cover porous areas of the second fiber web (e.g., without defect and crack formation) when the distance between fibers in the second layer is small.

In some embodiments, the porosity of the second fiber web may be greater than or equal to 35%, greater than or equal to 40%, greater than or equal to 45%, greater than or equal to 50%, greater than or equal to 55%, greater than or equal to 60%, greater than or equal to 65%, greater than or equal to 70%, or greater than or equal to 75%. In some instances, the porosity of the second fiber web may less than or equal to 80%, less than or equal to 75%, less than or equal to 70%, less than or equal to 65%, less than or equal to 60%, or less than or equal to 55%. It should be understood that combinations of the above-referenced ranges are possible (e.g., greater than or equal to 50% and less than or equal to 90%, greater than or equal to 70% and less than or equal to 90%). In some embodiments, the porosity of the second fiber web is greater than or equal to 35% and less than or equal to 80%. The porosity of a fiber web, porosity (%)=100-solidity (%).

In certain embodiments, the second fiber web, described herein, may have a relatively small surface mean pore area. For instance, in some embodiments, the second fiber web may have a surface mean pore area of less than or equal to 50 square micrometers, less than or equal to 45 square micrometers, less than or equal to 40 square micrometers, less than or equal to 35 square micrometers, less than or equal to 30 square micrometers, less than or equal to 25 square micrometers, less than or equal to 20 square micrometers, less than or equal to 15 square micrometers, less than or equal to 10 square micrometers, or less than or equal to 5 square micrometers. In some instances, the second fiber web may have a surface mean pore area of greater than or equal to 2 square micrometers, greater than or equal to 5 square micrometers, greater than or equal to 8 square micrometers, greater than or equal to 10 square micrometers, greater than or equal to 15 square micrometers, greater than or equal to 20 square micrometers, greater than or equal to 25 square micrometers, greater than or equal to 30 square micrometers, greater than or equal to 35 square micrometers, greater than or equal to 40 square micrometers, greater than or equal to 45 square micrometers, or greater than or equal to 50 square micrometers. It should be understood that combinations of the above-reference ranges are possible (e.g., greater than or equal to 2 square micrometers and less than or equal to 50 square micrometers, and/or greater than or equal to 5 square micrometers and less than or equal to 25 square micrometers). Other values of surface mean pore area of the second fiber web are also possible.

As determined herein, the surface mean pore area is measured through scanning electron microscopy analysis using DiameterJ, a plug-in for the ImageJ image analysis software. A Phenom desktop scanning electron microscope can be used to generate the micrographs. The microscope may be focused on a surface of a layer (e.g., a fiber web; e.g., a second fiber web), e.g., at a zero degrees tilt. The micrographs can be taken at a magnification of 1200×. The electron acceleration voltage can be 10 kV and backscattered electrons can be used to create the micrographs. The SEM micrographs (images) can be in gray scale. To measure geometrical characteristics of an SEM image (e.g., average fiber diameter, surface mean pore area, average fiber intersection density), ImageJ software can transform the SEM image from gray scale to black-and-white image. In a black-and-white image, a black pixel can represent at least a portion of a pore (e.g., hole) and a white pixel can represent at least a portion of a solid material (e.g., fiber). In a continuous web such as a meltblown fiber web, collections of one or more black pixels, also referred to as black “islands,” may be surrounded by white pixels. A software algorithm in ImageJ can detect these black “islands”, count the number of black islands (the number of pores) and measure the area of each of them (the surface cross-sectional area of each pore, or pore area). The surface mean pore area can be calculated by dividing the cumulative pore area of all pores in an SEM image by the number of pores in the image. Similarly, the software can count the number of white pixels and calculate fiber diameter, intersection density, and/or other information.

In certain embodiments, the second fiber web, described herein, may have a relatively high number of fiber intersections per unit area. For instance, in some embodiments, the second fiber web may have greater than or equal to 0.005 intersections per square micrometers, greater than or equal to 0.006 intersections per square micrometers, greater than or equal to 0.007 intersections per square micrometers, greater than or equal to 0.008 intersections per square micrometers, greater than or equal to 0.009 intersections per square micrometers, greater than or equal to 0.01 intersections per square micrometers, greater than or equal to 0.012 intersections per square micrometers, greater than or equal to 0.015 intersections per square micrometers, greater than or equal to 0.018 intersections per square micrometers, or greater than or equal to 0.02 intersections per square micrometers. In some instances, the second fiber web may have less than or equal to 0.025 intersections per square micrometers, less than or equal to 0.022 intersections per square micrometers, less than or equal to 0.2 intersections per square micrometers, less than or equal to 0.018 intersections per square micrometers, less than or equal to 0.015 intersections per square micrometers, less than or equal to 0.012 intersections per square micrometers, less than or equal to 0.01 intersections per square micrometers, less than or equal to 0.009 intersections per square micrometers, less than or equal to 0.008 intersections per square micrometers, less than or equal to 0.007 intersections per square micrometers, or less than or equal to 0.006 intersections per square micrometers. It should be understood that combinations of the above-reference ranges are possible (e.g., greater than or equal to 0.005 intersections per square micrometers and less than or equal to 0.025 intersections per square micrometers, and/or greater than or equal to 0.008 intersections per square micrometers and less than or equal to 0.02 intersections per square micrometers).

As determined herein, the number of fiber intersections per micron squared of the second fiber web may be measured through scanning electron microscopy analysis using ImageJ image analysis software. A Phenom desktop scanning electron microscope can be used to generate the micrographs. The microscope may be focused on a surface of a layer (e.g., a fiber web; e.g., a second fiber web), e.g., at a zero degrees tilt. The micrographs can be taken at a magnification of 1200×. The electron acceleration voltage can be 10 kV and backscattered electrons can be used to create the micrographs. The total number of intersections between fibers at the surface of the layer can be determined by counting the intersections in a micrograph and dividing the number of intersections by the area covered by the micrograph.

In some embodiments, the second fiber web may have a maximum pore size of less than or equal to 80 micrometers, less than or equal to 70 micrometers, less than or equal to 60 micrometers, less than or equal to 50 micrometers, less than or equal to 40 micrometers, less than or equal to 30 micrometers, less than or equal to 20 micrometers, or less than or equal to 15 micrometers. In some instances, the second fiber web may have a maximum pore size of greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, or greater than or equal to 70 micrometers. Combinations of the above-referenced ranges are also possible (e.g., greater than or equal to 10 micrometers and less than or equal to 80 micrometers, greater than or equal to 30 micrometers and less than or equal to 80 micrometers, greater than or equal to 70 micrometers and less than or equal to 80 micrometers). Other values of maximum pore size are also possible.

The maximum pore size of the second fiber web may be determined via bubble point measurement according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm.

In some embodiments, the mean flow pore size of the second fiber web (e.g., calendered fiber web) may be less than or equal to 30 micrometers, less than or equal to 28 micrometers, less than or equal to 25 micrometers, less than or equal to 22 micrometers, less than or equal to 20 micrometers, less than or equal to 18 micrometers, less than or equal to 15 micrometers, less than or equal to 12 micrometers, less than or equal to 10 micrometers, less than or equal to 8 micrometers, less than or equal to 5 micrometers, less than or equal to 4 micrometers, or less than or equal to 2 micrometers. In some instances, the mean flow pore size may be greater than or equal to 1 micrometer, greater than or equal to 2 micrometers, greater than or equal to 5 micrometers, greater than or equal to 8 micrometers, greater than or equal to 10 micrometers, greater than or equal to 12 micrometers, greater than or equal to 15 micrometers, greater than or equal to 20 micrometers, greater than or equal to 22 micrometers, greater than or equal to 25 micrometers, or greater than or equal to 28 micrometers. Combinations of the above-referenced ranges are also possible (e.g., greater than or equal to 1 micrometer and less than or equal to 30 micrometers, greater than or equal to 10 micrometers and less than or equal to 20 micrometers).

The mean flow pore size of the second fiber web may be determined according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm and a tortuosity factor of 0.715.

As noted above, in some embodiments, the second fiber web may be relatively resistant to deformation without being brittle. For instance, the second fiber web may have a relatively high tensile strength and/or a tensile elongation. Without being bound by theory, it is believed that the resistance to deformation may significantly reduce the likelihood of damage to the first fiber web that could be induced by some physical stress. This type of stress may originate, e.g., from web handling (e.g. unwinding/rewinding, laminating, collating and slitting steps), pleating, and the cartridge assembly phase. If the second fiber web undergoes significant deformation when the product is fabricated, the stability and properties of the first fiber web may be affected.

In some embodiments, the second fiber web (e.g., calendered fiber web) may have a dry tensile strength in the machine direction of greater than or equal to 1 lb/in, greater than or equal to 2 lb/in, greater than or equal to 5 lb/in, greater than or equal to 8 lb/in, greater than or equal to 10 lb/in, greater than or equal to 12 lb/in, greater than or equal to 15 lb/in, greater than or equal to 18 lb/in, greater than or equal to 20 lb/in, greater than or equal to 22 lb/in, greater than or equal to 25 lb/in, or greater than or equal to 30 lb/in. In some instances, the dry tensile strength in the machine direction may be less than or equal to 35 lb/in, less than or equal to 32 lb/in, less than or equal to 30 lb/in, less than or equal to 28 lb/in, less than or equal to 25 lb/in, less than or equal to 20 lb/in, less than or equal to 15 lb/in, less than or equal to 10 lb/in, or less than or equal to 5 lb/in. Combinations of the above-referenced ranges are also possible (e.g., greater than or equal to 1 lb/in and less than or equal to 35 lb/in, greater than or equal to 2 lb/in and less than or equal to 30 lb/in). Other values of dry tensile strength in the machine direction are also possible. The dry tensile strength of the second fiber web in the machine direction may be determined according to the standard ASTM D5035-11 (2015).

In some embodiments, the second fiber web (e.g., calendered fiber web) may have a dry tensile strength in the cross direction of greater than or equal to 1 lb/in, greater than or equal to 2 lb/in, greater than or equal to 5 lb/in, greater than or equal to 8 lb/in, greater than or equal to 10 lb/in, greater than or equal to 12 lb/in, greater than or equal to 15 lb/in, greater than or equal to 18 lb/in, greater than or equal to 20 lb/in, greater than or equal to 22 lb/in, greater than or equal to 25 lb/in, or greater than or equal to 30 lb/in. In some instances, the dry tensile strength in the cross direction may be less than or equal to 35 lb/in, less than or equal to 32 lb/in, less than or equal to 30 lb/in, less than or equal to 28 lb/in, less than or equal to 25 lb/in, less than or equal to 20 lb/in, less than or equal to 15 lb/in, less than or equal to 10 lb/in, or less than or equal to 5 lb/in. Combinations of the above-referenced ranges are also possible (e.g., greater than or equal to 1 lb/in and less than or equal to 35 lb/in, greater than or equal to 2 lb/in and less than or equal to 30 lb/in). Other values of dry tensile strength of the second fiber web in the cross direction are also possible. The dry tensile strength in the cross direction of the second fiber web may be determined according to the standard ASTM D5035-11 (2015).

In some embodiments, the second fiber web (e.g., calendered fiber web) may have a dry tensile elongation in the machine direction of greater than or equal to 10%, greater than or equal to 13%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, or greater than or equal to 55%. In some instances, the dry tensile elongation in the machine direction may be less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, or less than or equal to 15%. Combinations of the above-referenced ranges are also possible (e.g., greater than or equal to 10% and less than or equal to 60%, greater than or equal to 13% and less than or equal to 50%). Other values of dry tensile elongation in the machine direction are also possible. The dry tensile elongation of the second fiber web in the machine direction may be determined according to the standard ASTM D5035-11 (2015).

In some embodiments, the second fiber web (e.g., calendered fiber web) may have a dry tensile elongation in the cross direction of greater than or equal to 5%, greater than or equal to 10%, greater than or equal to 13%, greater than or equal to 15%, greater than or equal to 20%, greater than or equal to 25%, greater than or equal to 30%, greater than or equal to 35%, greater than or equal to 40%, greater than or equal to 45%, greater than or equal to 50%, or greater than or equal to 55%. In some instances, the dry tensile elongation in the cross direction may be less than or equal to 70%, less than or equal to 65%, less than or equal to 60%, less than or equal to 55%, less than or equal to 50%, less than or equal to 45%, less than or equal to 40%, less than or equal to 35%, less than or equal to 30%, less than or equal to 25%, less than or equal to 20%, or less than or equal to 15%. Combinations of the above-referenced ranges are also possible (e.g., greater than or equal to 5% and less than or equal to 70%, greater than or equal to 10% and less than or equal to 60%, greater than or equal to 13% and less than or equal to 50%). Other values of dry tensile elongation in the cross direction are also possible. The dry tensile elongation of the second fiber web in the cross direction may be determined according to the standard ASTM D5035-11 (2015).

In some embodiments, at least a portion of a surface of the second fiber web is relatively smooth. Without being bound by theory, it is believed that: (i) smooth surfaces can provide a high degree (e.g., areal density) of contact points between the efficiency layer (e.g., fiber web having an average fiber diameter of less than or equal to about 0.5 micrometers) and the surface of the support layer, which may reduce the amount of localized stress on the efficiency layer under an external source of pressure; and (ii) smooth surfaces have a relatively small surface roughness, which may reduce the amount of curvature of the nanofiber layer when conforming to the smooth surface, which may reduce the amount of internal stresses in the nanofiber layer. In some instances, smoothness may be imparted to a surface of the second fiber web by one or more manufacturing and/or processing steps. For instance, in some embodiments, the second fiber web (e.g., support layer) is a calendered fiber web. Without being bound by theory, it is believed that the calendering process may decrease or eliminate the amount of loose fiber ends on the surface of the second fiber web, which might protrude into or through the efficiency layer and cause defects in the efficiency layer. In certain embodiments, fibers with different diameters (e.g., staple fibers, continuous fibers) may be mixed or used to enhance or decrease surface roughness. Non-limiting examples of methods for imparting smoothness to a surface of the second fiber web include calendering, chemical and/or bio-polishing, flame singeing, and surface coating.

In some embodiments, the root mean square of surface roughness of the second fiber web may be less than or equal to 50 micrometers, less than or equal to 40 micrometers, less than or equal to 30 micrometers, less than or equal to 20 micrometers, less than or equal to 15 micrometers, less than or equal to 12 micrometers, less than or equal to 10 micrometers, less than or equal to 8 micrometers, less than or equal to 5 micrometers, or less than or equal to 2 micrometers. In some instances, the root mean square of surface roughness of the second fiber web may be greater than or equal to 1 micrometer, greater than or equal to 2 micrometers, greater than or equal to 3 micrometers, greater than or equal to 4 micrometers, greater than or equal to 5 micrometers, greater than or equal to 6 micrometers, greater than or equal to 8 micrometers, greater than or equal to 10 micrometers, greater than or equal to 15 micrometers, greater than or equal to 20 micrometers, greater than or equal to 30 micrometers, or greater than or equal to 40 micrometers. Combinations of the above referenced ranges are also possible (e.g., greater than or equal to 1 micrometer and less than or equal to 50 micrometers, greater than or equal to 3 micrometers and less than or equal to 10 micrometers).

The root mean square roughness of surface roughness of the second fiber web may be determined using confocal laser microscopy. This test was performed following ISO 25178-1 (2016) standard.

In some embodiments, the second fiber web may be relatively lightweight. For instance, in some embodiments, the second fiber web may have a basis weight of less than or equal to about 50 gsm, less than or equal to about 45 gsm, less than or equal to about 40 gsm, less than or equal to about 35 gsm, less than or equal to about 30 gsm, less than or equal to about 25 gsm, less than or equal to about 20 gsm, or less than or equal to about 15 gsm. In some instances, the second fiber web may have a basis weight of greater than or equal to about 10 gsm, greater than or equal to about 15 gsm, greater than or equal to about 20 gsm, greater than or equal to about 25 gsm, greater than or equal to about 30 gsm, greater than or equal to about 35 gsm, greater than or equal to about 40 gsm, or greater than or equal to about 45 gsm. Combinations of the above-referenced ranges are also possible (e.g., greater than or equal to about 10 gsm and less than or equal to about 50 gsm, greater than or equal to about 20 gsm and less than or equal to about 35 gsm). Other values of basis weight are also possible.

In some embodiments, the second fiber web may be relatively thin. For instance, in some embodiments, the second fiber web may have a thickness of less than or equal to about 400 micrometers, less than or equal to about 350 micrometers, less than or equal to about 300 micrometers, less than or equal to about 250 micrometers, less than or equal to about 200 micrometers, less than or equal to about 180 micrometers, less than or equal to about 150 micrometers, less than or equal to about 120 micrometers, less than or equal to about 100 micrometers, less than or equal to about 80 micrometers, or less than or equal to about 50 micrometers. In some instances, the second fiber web may have a thickness of greater than or equal to about 25 micrometers, greater than or equal to about 30 micrometers, greater than or equal to about 50 micrometers, greater than or equal to about 80 micrometers, greater than or equal to about 100 micrometers, greater than or equal to about 120 micrometers, greater than or equal to about 150 micrometers, greater than or equal to about 180 micrometers, greater than or equal to about 200 micrometers, greater than or equal to about 220 micrometers, greater than or equal to about 250 micrometers, greater than or equal to about 280 micrometers, greater than or equal to about 300 micrometers, greater than or equal to about 320 micrometers, or greater than or equal to about 350 micrometers. Combinations of the above-referenced ranges are also possible (e.g., greater than or equal to about 25 micrometers and less than or equal to about 400 micrometers, greater than or equal to about 50 micrometers and less than or equal to about 180 micrometers). Other values of average thickness are also possible. In some embodiments, the thickness of the second fiber web may be determined according to ASTM D1777-96 (2015) using a pressure of 2.65 psi.

As described in more detail below, the second fiber web may comprise synthetic fibers, amongst other fiber types. In some instances, the second fiber web may comprise a relatively high weight percentage of synthetic fibers (e.g., greater than or equal to about 95 wt. %, 100 wt. %). In some instances, the synthetic fibers (e.g., nylon fibers, propylene fibers) may be continuous as described further below. For example, the second fiber web may comprise a relatively high percentage (e.g., greater than or equal to about 95 wt. %, 100 wt. %) of synthetic fibers formed via a meltblowing process. In general, the second fiber web may comprise synthetic fibers formed by any suitable process including a meltblown process, melt spinning process, centrifugal spinning process, non-wet laid process, and/or wetlaid process.

In some embodiments, the second fiber web may have an average fiber diameter of less than or equal to about 50 micrometers, less than or equal to about 45 micrometers, less than or equal to about 40 micrometers, less than or equal to about 35 micrometers, less than or equal to about 30 micrometers, less than or equal to about 25 micrometers, less than or equal to about 20 micrometers, less than or equal to about 15 micrometers, less than or equal to about 10 micrometer, or less than or equal to about 5 micrometers. In some instances, the average fiber diameter may be greater than or equal to about 2 micrometers, greater than or equal to about 5 micrometers, greater than or equal to about 10 micrometers, greater than or equal to about 15 micrometers, greater than or equal to about 20 micrometer, greater than or equal to about 25 micrometers, greater than or equal to about 30 micrometers, greater than or equal to about 35 micrometers, greater than or equal to about 40 micrometers, or greater than or equal to about 45 micrometers. Combinations of the above-referenced ranges are also possible (e.g., greater than or equal to about 2 micrometers and less than or equal to about 50 micrometers, greater than or equal to about 2 micrometers and less than or equal to about 30 micrometers). Other values of average fiber diameter are also possible.

A second fiber web as described herein may be hydrophilic. In some embodiments, the second fiber web has a hydrostatic pressure of greater than or equal to 0 millibar, greater than or equal to 1 millibar, greater than or equal to 2 millibar, greater than or equal to 3 millibar, greater than or equal to 4 millibar, greater than or equal to 5 millibar, greater than or equal to 6 millibar, greater than or equal to 7 millibar, greater than or equal to 8 millibar, greater than or equal to 9 millibar, greater than or equal to 10 millibar, greater than or equal to 20 millibar, or greater than or equal to 30 millibar. In some embodiments, the second fiber web has a hydrostatic pressure of less than or equal to 30 millibar, less than or equal to 20 millibar, less than or equal to 10 millibar, less than or equal to 9 millibar, less than or equal to 8 millibar, less than or equal to 7 millibar, less than or equal to 6 millibar, less than or equal to 5 millibar, less than or equal to 4 millibar, less than or equal to 3 millibar, less than or equal to 2 millibar, or less than or equal to 1 millibar. Combinations of the above-referenced ranges are also possible (e.g., greater than or equal to 0 millibar and less than or equal to 30 millibar, greater than or equal to 0 millibar and less than or equal to 20 millibar, and/or greater than or equal to 0 millibar and less than or equal to 10). In some embodiments, the second fiber web has a hydrostatic pressure of identically 0 millibar. Other ranges are also possible.

The hydrostatic pressure of the second fiber web may be determined according to the standard AATCC 127-2008 (2008).

As noted above, the filter media may include a third fiber web bonded (e.g., adhesively bonded, via lamination) to the first fiber web. The third fiber web may impart beneficial properties to the filter media. For instance, the third fiber web may be a non-filtration layer that serves to protect the first fiber web from potential mechanical damages during processing and handling. In some embodiments, the third fiber web is configured to act as a pre-filtration layer that increases the dirt holding capacity of the filter media. In certain embodiments, the third fiber web is configured to act as both a pre-filtration layer and a protective layer. In certain embodiments, the third fiber web may impart beneficial particulate capture properties to the filter media. For example, the third fiber web may be an efficiency layer. In some such cases, the third fiber web may have one or more properties substantially similar to and/or the same as the first fiber web. Regardless of the function of the third fiber web, the third fiber web may be bonded (e.g., via lamination, adhesively) to the first fiber web.

In some embodiments (e.g., in which the third fiber web is a non-filtration layer), the third layer may have relatively large pores. For instance, in some embodiments, the third fiber web may have a maximum pore size of greater than or equal to 20 micrometers, greater than or equal to 25 micrometers, greater than or equal to 30 micrometers, greater than or equal to 35 micrometers, greater than or equal to 40 micrometers, greater than or equal to 45 micrometers, greater than or equal to 50 micrometers, or greater than or equal to 55 micrometers. In some instances, the third fiber web may have a maximum pore size of less than or equal to 70 micrometers, less than or equal to 60 micrometers, less than or equal to 56 micrometers, less than or equal to 50 micrometers, less than or equal to 45 micrometers, less than or equal to 40 micrometers, less than or equal to 35 micrometers, less than or equal to 30 micrometers, or less than or equal to 25 micrometers. Combinations of the above-referenced ranges are also possible (e.g., greater than or equal to 20 micrometers and less than or equal to 70 micrometers, greater than or equal to 20 micrometers and less than or equal to 60 micrometers, and/or greater than or equal to 30 micrometers and less than or equal to 56 micrometers). Other values of maximum pore size are also possible.

The maximum pore size of the third fiber web may be determined via bubble point measurement according to the standard ASTM F-316-03 Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm and a tortuosity factor of 0.715.

In some embodiments (e.g., in which the third fiber web is a non-filtration layer), the mean flow pore size of the third fiber web may be greater than or equal to 5 micrometers, greater than or equal to 8 micrometers, greater than or equal to 10 micrometers, greater than or equal to 12 micrometers, greater than or equal to 15 micrometers, greater than or equal to 18 micrometers, greater than or equal to 20 micrometers, greater than or equal to 22 micrometers, greater than or equal to 25 micrometers, or greater than or equal to 28 micrometers. In some instances, the mean flow pore size may be less than or equal to 30 micrometers, less than or equal to 28 micrometers, less than or equal to 25 micrometers, less than or equal to 22 micrometers, less than or equal to 20 micrometers, less than or equal to 18 micrometers, less than or equal to 15 micrometers, less than or equal to 12 micrometers, less than or equal to 10 micrometers, or less than or equal to 8 micrometers. Combinations of the above-referenced ranges are also possible (e.g., greater than or equal to 5 micrometer and less than or equal to 30 micrometers, greater than or equal to 15 micrometers and less than or equal to 25 micrometers). It should be understood that in some embodiments (e.g., in which the third fiber web is a filtration layer), the maximum pore size and/or the mean flow pore size may be substantially similar to and/or the same as one or more fiber webs described herein (e.g., first fiber web, second fiber web, fourth fiber web).

The mean flow pore size of the third fiber web may be determined according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm and a tortuosity factor of 0.715.

In some embodiments, the third fiber web may have a basis weight of less than or equal to 30 gsm, less than or equal to 28 gsm, less than or equal to 25 gsm, less than or equal to 22 gsm, less than or equal to 20 gsm, less than or equal to 18 gsm, less than or equal to 15 gsm, less than or equal to 12 gsm, less than or equal to 10 gsm, or less than or equal to 8 gsm. In some instances, the third fiber web may have a basis weight of greater than or equal to 5 gsm, greater than or equal to 8 gsm, greater than or equal to 10 gsm, greater than or equal to 12 gsm, greater than or equal to 15 gsm, greater than or equal to 18 gsm, greater than or equal to 20 gsm, greater than or equal to 22 gsm, greater than or equal to 25 gsm, or greater than or equal to 28 gsm. Combinations of the above-referenced ranges are possible (e.g., greater than or equal to 5 gsm and less than or equal to 30 gsm, greater than or equal to 10 gsm and less than or equal to 25 gsm). Other values of basis weight are possible. The basis weight may be determined according to the standard ASTM D3776 (2017). It should be understood that in some embodiments (e.g., in which the third fiber web is a filtration layer), the basis weight may be substantially similar to and/or the same as one or more fiber webs described herein (e.g., first fiber web, second fiber web, fourth fiber web).

In some embodiments, the third fiber web may be relatively thin. For instance, in some embodiments, the third fiber web may have a thickness of less than or equal to 250 micrometers, less than or equal to 225 micrometers, less than or equal to 200 micrometers, less than or equal to 175 micrometers, less than or equal to 150 micrometers, less than or equal to 125 micrometers, or less than or equal to 100 micrometers. In some instances, the third fiber web may have a thickness of greater than or equal to 80 micrometers, greater than or equal to 100 micrometers, greater than or equal to 125 micrometers, greater than or equal to 150 micrometers, greater than or equal to 175 micrometers, greater than or equal to 200 micrometers, or greater than or equal to 225 micrometers. Combinations of the above-referenced ranges are also possible (e.g., greater than or equal to 80 micrometers and less than or equal to 250 micrometers, greater than or equal to 100 micrometers and less than or equal to 150 micrometers). Other values of average thickness are also possible. In some embodiments, the thickness may be determined according to the standard ASTM D1777-96 (2015) using a pressure of 2.65 psi. It should be understood that in some embodiments (e.g., in which the third fiber web is a filtration layer), the thickness may be substantially similar to and/or the same as one or more fiber webs described herein (e.g., first fiber web, second fiber web, fourth fiber web).

As described in more detail below, the third fiber web may comprise synthetic fibers, amongst other fiber types. In some instances, the third fiber web may comprise a relatively high weight percentage of synthetic fibers (e.g., greater than or equal to 95 wt %, identically 100 wt %). In some instances, the synthetic fibers may be continuous as described further below. For example, the third fiber web may comprise a relatively high percentage (e.g., greater than or equal to 95 wt %, identically 100 wt %) of synthetic fibers formed via a meltblowing process. In general, the third fiber web may comprise synthetic fibers formed by any suitable process including a meltblown process, melt spinning process, centrifugal spinning process, non-wet laid process, and/or wetlaid process.

In some embodiments, the average fiber diameter of the third fiber web may be greater than or equal to 1 micrometer, greater than or equal to 2 micrometers, greater than or equal to 3 micrometers, greater than or equal to 4 micrometers, greater than or equal to 5 micrometers, greater than or equal to 8 micrometers, greater than or equal to 10 micrometers, greater than or equal to 12 micrometers, greater than or equal to 15 micrometers, or greater than or equal to 18 micrometers. In some instances, the third fiber web may have an average fiber diameter of less than or equal to 20 micrometers, less than or equal to 18 micrometers, less than or equal to 15 micrometers, less than or equal to 12 micrometers, less than or equal to 10 micrometers, less than or equal to 8 micrometers, less than or equal to 6 micrometers, less than or equal to 5 micrometers, less than or equal to 4 micrometers, or less than or equal to 3 micrometers. Combinations of the above-referenced ranges are also possible (e.g., greater than or equal to 1 micrometer and less than or equal to 20 micrometers, greater than or equal to 2 micrometers and less than or equal to 15 micrometers). Other values of average fiber diameter are also possible. It should be understood that in some embodiments (e.g., in which the third fiber web is a filtration layer), the average fiber diameter may be substantially similar to and/or the same as one or more fiber webs described herein (e.g., first fiber web, second fiber web, fourth fiber web). In some embodiments, the average fiber diameter of the third fiber web is greater than that of the first fiber web.

As previously described, a fourth fiber web may be bonded to a filter media comprising any number of layers.

A filter media as described may have a variety of suitable basis weights. In some embodiments, the filter media can have a basis weight of less than or equal to 150 gsm, less than or equal to 130 gsm, less than or equal to 110 gsm, less than or equal to 90 gsm, less than or equal to 70 gsm, less than or equal to 50 gsm, or less than or equal to 40 gsm. In some embodiments, the filter media can have a basis weight of greater than or equal to 40 gsm, greater than or equal to 50 gsm, greater than or equal to 70 gsm, greater than or equal to 90 gsm, greater than or equal to 110 gsm, greater than or equal to 130 gsm, or greater than or equal to 150 gsm. Combinations of these ranges are possible (less than or equal to 150 gsm and greater than or equal to 40 gsm). Other ranges are possible.

Filter media and a fourth fiber web as described herein may have a variety of suitable ratios of the basis of weight. In some embodiments, the ratio of the basis weight of the fourth fiber web to the basis weight of the other layers of the filter media is greater than or equal to 1, greater than or equal to 1.5, greater than or equal to 2, greater than or equal to 2.5, greater than or equal to 3, greater than or equal to 3.5, or greater than or equal to 4. In some embodiments, the ratio of the basis weight of the fourth fiber web to the basis weight of the other layers of the filter media is less than or equal to 4, less than or equal to 3.5, less than or equal to 3, less than or equal to 2.5, less than or equal to 2, less than or equal to 1.5, or less than or equal to 1. Combinations of these ranges are possible (e.g., greater than or equal to 1 and less than or equal to 4, greater than or equal to 1 and less than or equal to 3, and/or greater than or equal to 1.5 and less than or equal to 2.5). Other ranges are possible.

The basis weight of a filter media may be determined according to the standard ASTM D3776 (2013).

Filter media disclosed herein may have a variety of suitable thicknesses. In some embodiments, the thickness of the filter media may be less than or equal to 400 micrometers, less than or equal to 375 micrometers, less than or equal to 350 micrometers, less than or equal to 325 micrometers, less than or equal to 300 micrometers, less than or equal to 275 micrometers, less than or equal to 250 micrometers, less than or equal to 225 micrometers, less than or equal to 200 micrometers, less than or equal to 175 micrometers, less than or equal to 150 micrometers, or less than or equal to 125 micrometers. In some instances, the thickness may be greater than or equal to 100 micrometers, greater than or equal to 130 micrometers, greater than or equal to 150 micrometers, greater than or equal to 175 micrometers, greater than or equal to 200 micrometers, greater than or equal to 225 micrometers, greater than or equal to 250 micrometers, greater than or equal to 275 micrometers, greater than or equal to 300 micrometers, greater than or equal to 325 micrometers, greater than or equal to 350 micrometers, or greater than or equal to 400 micrometers. Combinations of the above referenced ranges are also possible (e.g., greater than or equal to 100 micrometers and less than or equal to 400 micrometers, and/or greater than or equal to 130 micrometers and less than or equal to 300 micrometers). Other ranges are also possible.

The thickness of filter media may be determined according to the standard ASTM D1777-96 (2015) at 2.65 psi.

A filter media as described herein may have a variety of suitable water fluxes at a 20 PSI pressure differential and sample area of 12.5 cm². In some embodiments, the filter media has a water flux greater than or equal to 30 mL/min/cm², greater than or equal to 50 mL/min/cm², greater than or equal to 100 mL/min/cm², greater than or equal to 150 mL/min/cm², greater than or equal to 200 mL/min/cm², greater than or equal to 250 mL/min/cm², or greater than or equal to 300 mL/min/cm² at a 20 PSI pressure differential and sample area of 12.5 cm². In some embodiments, the filter media has a water flux of less than or equal to 300 mL/min/cm², less than or equal to 250 mL/min/cm², less than or equal to 200 mL/min/cm², less than or equal to 150 mL/min/cm², less than or equal to 100 mL/min/cm², less than or equal to 50 mL/min/cm², or less than or equal to 30 mL/min/cm² at a 20 PSI pressure differential and sample area of 12.5 cm². Combinations of these ranges are possible (e.g., greater than or equal to 30 mL/min/cm² and less than or equal to 300 mL/min/cm²). Other ranges are possible. Water flux is calculated by dividing the flow rate (ml/min) by a sample effective area (cm²) of the filter media (i.e., the area exposed to fluid flow) and is expressed in ml/min/cm².

Filter media disclosed herein may have a variety of suitable air permeabilities. In some embodiments, the air permeability of the filter media, measured at 125 Pa pressure drop, is greater than or equal to 2.5 liter per second per square meter (L/(m²·s)) greater than or equal to 5 L/(m²·s), greater than or equal to 10 L/(m²·s), greater than or equal to 15 L/(m²·s), greater than or equal to 20 L/(m²·s), greater than or equal to 25 L/(m²·s), greater than or equal to 30 L/(m²·s), greater than or equal to 35 L/(m²·s), greater than or equal to 40 L/(m²·s), greater than or equal to 45 L/(m²·s), or greater than or equal to 50 L/(m²·s). In some instances, the air permeability of the filter media, measured at 125 Pa pressure drop, may be less than or equal to 50 L/(m²·s), less than or equal to 45 L/(m²·s), less than or equal to 40 L/(m²·s), less than or equal to 35 L/(m²·s), less than or equal to 30 L/(m²·s), less than or equal to 25 L/(m²·s), less than or equal to 20 L/(m²·s), less than or equal to 15 L/(m²·s), less than or equal to 10 L/(m²·s), less than or equal to 5 L/(m²·s), or less than or equal to 2.5 L/(m²·s). All combinations of the above-referenced ranges are possible (e.g., greater than 2.5 L/(m²·s) and less than or equal to 50 L/(m²·s), greater than 5 L/(m²·s) and less than or equal to 30 L/(m²·s)).

Filter media disclosed herein may have a different air permeability when an adhesive layer is included compared to an otherwise identical filter media without an adhesive layer. In some embodiments, the difference in air permeability between the filter media with an adhesive layer and an otherwise identical filter media without an adhesive layer is greater than or equal to 0 L/(m²·s), greater than or equal to 0.5 L/(m²·s), greater than or equal to 1 L/(m²·s), greater than or equal to 1.5 L/(m²·s), greater than or equal to 2 L/(m²·s), greater than or equal to 2.5 L/(m²·s), or greater than or equal to 3 L/(m²·s) at a pressure of 125 Pa. In some embodiments, the difference in air permeability between the filter media with an adhesive layer and an otherwise identical filter media without an adhesive layer is less than or equal to 10 L/(m²·s), less than or equal to 9 L/(m²·s), less than or equal to 8 L/(m²·s), less than or equal to 7 L/(m²·s), less than or equal to 6 L/(m²·s), less than or equal to 5 L/(m²·s), less than or equal to 4 L/(m²·s), less than or equal to 3 L/(m²·s), less than or equal to 2.5 L/(m²·s), less than or equal to 2 L/(m²·s), less than or equal to 1.5 L/(m²·s), less than or equal to 1 L/(m²·s), less than or equal to 0.5 L/(m²·s), or less than or equal to 0.1 L/(m²·s) at a pressure of 125 Pa. Combinations of these ranges are possible (e.g., greater than or equal to 0 L/(m²·s) and less than or equal to 10 L/(m²·s), greater than or equal to 1 L/(m²·s) and less than or equal to 3 L/(m²·s), and/or greater than or equal to 1.5 L/(m²·s) and less than or equal to 2.5 L/(m²·s)). Other ranges are possible. In some embodiments, the difference in air permeability between the filter media with an adhesive layer and an otherwise identical filter media without an adhesive layer is identical to 0 L/(m²·s).

The air permeability of a filter media may be determined according to the standard ASTM D737-04 (2016).

Filter media as described may have a variety of suitable maximum pore sizes. In some embodiments, the filter media has a maximum pore size of less than or equal to 5 micrometers, less than or equal to 4.5 micrometers, less than or equal to 4 micrometers, less than or equal to 3.5 micrometers, less than or equal to 3 micrometers, less than or equal to 2.5 micrometers, less than or equal to 2.3 micrometers, less than or equal to 2 micrometers, less than or equal to 1.8 micrometers, less than or equal to 1.6 micrometers, less than or equal to 1.4 micrometers, less than or equal to 1.3 micrometers, less than or equal to 1.2 micrometers, less than or equal to 1.1 micrometers, less than or equal to 1 micrometer, less than or equal to 0.9 micrometers, less than or equal to 0.8 micrometers, less than or equal to 0.7 micrometers, less than or equal to 0.6 micrometers, less than or equal to 0.5 micrometers, less than or equal to 0.4 micrometers, less than or equal to 0.3 micrometers, or less than or equal to 0.2 micrometers. In some embodiments, the filter media may have a maximum pore size of greater than or equal to 0.1 micrometers, greater than or equal to 0.2 micrometers, greater than or equal to 0.3 micrometers, greater than or equal to 0.4 micrometers, greater than or equal to 0.5 micrometers, greater than or equal to 0.6 micrometers, greater than or equal to 0.7 micrometers, greater than or equal to 0.8 micrometers, greater than or equal to 0.9 micrometers, greater than or equal to 1 micrometer, greater than or equal to 1.1 micrometers, greater than or equal to 1.2 micrometers, greater than or equal to 1.4 micrometers, greater than or equal to 1.6 micrometers, greater than or equal to 1.8 micrometers, greater than or equal to 2 micrometers, greater than or equal to 2.2 micrometers, greater than or equal to 2.5 micrometers, greater than or equal to 3 micrometers, greater than or equal to 3.5 micrometers, greater than or equal to 4 micrometers, greater than or equal to 4.5 micrometers, or greater than or equal to 5 micrometers. Combinations of the above-referenced ranges are also possible (e.g., greater than or equal to 0.1 micrometers and less than or equal to 2.5 micrometers, greater than or equal to 0.5 micrometers and less than or equal to 1.3 micrometers). Other ranges are also possible.

The maximum pore size may be determined via bubble point measurement according to the standard ASTM F316-03 (2019) Method B, BS6410 (2011), e.g., using a Capillary Flow Porometer (e.g., model number CFP-34RTF-8A-X6) made by Porous Materials Inc. and Galwick, which has a fluid surface tension of 15.9 dynes/cm and a tortuosity factor of 0.715.

Filter media as described herein may have a variety of suitable mean flow pore sizes. In some embodiments, the filter media has a mean flow pore size of less than or equal to 1 micrometer, less than or equal to 0.9 micrometers, less than or equal to 0.8 micrometers, less than or equal to 0.7 micrometers, less than or equal to 0.6 micrometers, less than or equal to 0.5 micrometers, less than or equal to 0.4 micrometers, less than or equal to 0.3 micrometers, less than or equal to 0.2 micrometers, less than or equal to 0.1 micrometers, or less than or equal to 0.08 micrometers. In some embodiments, the mean flow pore size may be greater than or equal to 0.05 micrometers, greater than or equal to 0.06 micrometers, greater than or equal to 0.07 micrometers, greater than or equal to 0.08 micrometers, greater than or equal to 0.1 micrometers, greater than or equal to 0.2 micrometers, greater than or equal to 0.3 micrometers, greater than or equal to 0.4 micrometers, greater than or equal to 0.5 micrometers, greater than or equal to 0.6 micrometers, greater than or equal to 0.7 micrometers, greater than or equal to 0.8 micrometers, or greater than or equal to 0.9 micrometers. Combinations of the above-referenced ranges are also possible (e.g., greater than or equal to 0.05 micrometers and less than or equal to 1 micrometer, greater than or equal to 0.1 micrometers and less than or equal to 0.4 micrometers). Other ranges are possible.

Filter media as described herein may be bonded to a filter housing via the fourth fiber web and/or an adhesive and may have a variety of suitable peak peel strengths between the filter media and the filter housing. In some embodiments, the peak peel strength between the filter media and the filter housing is greater than or equal to 1 g/mm, greater than or equal to 2 g/mm, greater than or equal to 5 g/mm, greater than or equal to 7.5 g/mm, greater than or equal to 10 g/mm, greater than or equal to 30 g/mm, greater than or equal to 40 g/mm, greater than or equal to 60 g/mm, greater than or equal to 90 g/mm, greater than or equal to 100 g/mm, greater than or equal to 120 g/mm, greater than or equal to 150 g/mm, greater than or equal to 180 g/mm, greater than or equal to 210 g/mm, greater than or equal to 240 g/mm, greater than or equal to 250 g/mm, greater than or equal to 270 g/mm, greater than or equal to 280 g/mm, or greater than or equal to 300 g/mm. In some embodiments, the peak peel strength between the filter media and the filter housing is less than or equal to 300 g/mm, less than or equal to 280 g/mm, less than or equal to 270 g/mm, less than or equal to 250 g/mm, less than or equal to 240 g/mm, less than or equal to 210 g/mm, less than or equal to 180 g/mm, less than or equal to 150 g/mm, less than or equal to 120 g/mm, less than or equal to 100 g/mm, less than or equal to 90 g/mm, less than or equal to 60 g/mm, less than or equal to 40 g/mm, less than or equal to 30 g/mm, less than or equal to 10 g/mm, less than or equal to 7.5 g/mm, less than or equal to 5 g/mm, or less than or equal to 2 g/mm. Combinations of these ranges are possible (e.g., greater than or equal to 1 g/mm and less than or equal to 300 g/mm, greater than or equal to 10 g/mm and less than or equal to 300 g/mm, greater than or equal to 40 g/mm and less than or equal to 280 g/mm, and/or greater than or equal to 100 g/mm and less than or equal 250 g/mm). Other ranges are possible.

The peak peel strength between filter media and a fourth fiber web may be measured in accordance with ASTM D1876 (2001) at 12 in/min (305 mm/min) separation speed.

Filter media as described herein may have a variety of suitable filtration efficiencies. In some embodiments, the filter media has a filtration efficiency of greater than or equal to 85%, greater than or equal to 90%, greater than or equal to 95%, greater than or equal to 99%, greater than or equal to 99.9%, greater than or equal to 99.99%, greater than or equal to 99.999%, greater than or equal to 99.9999% for particulates with a maximum characteristic dimension greater than or equal to 0.5 micrometer and less than or equal to 1 micrometer. In some embodiments, the filter media has a filtration efficiency of less than or equal to 99.9999%, less than or equal to 99.999%, less than or equal to 99.99%, less than or equal to 99.9%, less than or equal to 99%, less than or equal to 95%, less than or equal to 90%, or less than or equal to 85% for particulates with a maximum characteristic dimension greater than or equal to 0.5 micrometer and less than or equal to 1 micrometer. Combinations of these ranges are possible (e.g., greater than or equal to 85% and less than or equal to 99.9999%, greater than or equal to 90% and less than or equal to 99.999%, and greater than or equal to 95% and less than or equal to 99.99%). Other ranges are also possible.

Filtration efficiency of filter media may be measured in accordance with ASTM F795-88 (1988). The ASTM F795 test may be performed with flow rate of 60 ml/min on 90 mm disk samples and using ISO 12103-1 A2 Fine Test Dust diluted in deionized water to achieve particle counts in the range of 5 E+3-5 E+4 #/ml as challenge particles. The efficiency is measured using counting of particles in the range of 0.5-1.0 μm size range and Eq. 1:

$$Efficiency ( \% ) = \frac{upstream particles ( \# / ml ) - downstream particles ( \# / ml )}{upstream particles ( \# / ml )} \times 100 \% \qquad ( Eq . 1 )$$

The background count may also be subtracted from the downstream counts to account for cleanliness of the system. The modified formula is as follows in Eq. 2:

$$Efficiency ( \% ) = \frac{\begin{matrix}upstream particles ( \# / ml ) - \\ ( downstream particles ( \# / ml ) - background particles ( \# / ml ) )\end{matrix}}{upstream particles ( \# / ml )} \times 100 \% \qquad ( Eq . 2 )$$

Filter media described herein may have a variety of suitable filtration efficiencies against particles having a maximum characteristic dimension of 3 micrometers. In some embodiments, the filter media has a filtration efficiency of greater than or equal to 80%, greater than or equal to 85%, greater than or equal to 90%, greater than or equal to 95%, greater than or equal to 99%, greater than or equal to 99.9%, greater than or equal to 99.95%, greater than or equal to 99.999%, greater than or equal to 99.9999% for particulates with a maximum characteristic dimension greater than or equal to 3 micrometers. In some embodiments, the filter media has a filtration efficiency of less than or equal to 99.9999%, less than or equal to 99.999%, less than or equal to 99.95%, less than or equal to 99.9%, less than or equal to 99%, less than or equal to 95%, less than or equal to 90%, less than or equal to 85%, or less than or equal to 80% for particulates with a maximum characteristic dimension greater than or equal to 3 micrometers. Combinations of these ranges are possible (e.g., greater than or equal to 80% and less than or equal to 99.9999%, greater than or equal to 90% and less than or equal to 99.999%, and greater than or equal to 99.95% and less than or equal to 99.999%). Other ranges are also possible. In some embodiments, the particulates with a maximum characteristic dimension greater than or equal to 3 micrometers comprise polystyrene.

The filtration efficiency of the filter media against particulates with a maximum characteristic dimension greater than or equal to 3 micrometers may be measured in accordance with NSF 53 (2021) § 7.3.2.2.1.

In some embodiments, the filter media has a filtration efficiency as listed in any one of the ranges listed above, measured in accordance with NSF 53 (2021) § 7.3.2.2.1, for monodispersed particulates comprising polystyrene having a maximum characteristic dimension greater than or equal to 3 micrometers.

In some embodiments, the filter media has a filtration efficiency as listed in any one of the ranges listed above, measured in accordance with NSF 53 (2021) § 7.3.2.2.1, for monodispersed particulates comprising polyvinyl chloride (PVC) having a maximum characteristic dimension greater than or equal to 3 micrometers.

As noted above, a fourth fiber web may facilitate the bonding of other layers of the filter media to a filter housing to form a filter element. That is, the filter element, in some embodiments, comprises the filter media and the filter housing. In some embodiments, the filter element is for gravity filtration applications and/or pour-through filtration applications. A variety of suitable filter element designs may be employed as described elsewhere herein. In some embodiments, a filter element that takes the form of a filter cartridge is provided.

In some embodiments, a filter element as one or more beneficial optical features. For instance, a filter element may be visually attractive and/or pleasing to consumers. Filter elements may be clear or opaque, and may be provided in a variety of colors. In some embodiments, a filter element has sufficient transparency such that one or more components in the interior of the filter element may be viewed through the filter element. As one example, a filter element may comprise a stimulus-responsive additive that is indicative of the life, usage history, and/or end-of-life of the filter element and this stimulus-responsive additive may be capable of being viewed through the filter element. Non-limiting examples of such stimulus-responsive additives include those sensitive to pH, hardness, total dissolved solids content, conductivity, and/or the presence of one or more contaminants filtered from water positioned in and/or passed through the filter element.

A filter element as described herein may have a variety of filtration efficiencies against microorganisms such as Serratia Marcescens. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against Serratia Marcescens. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against Serratia Marcescens. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of Serratia Marcescens.

Filtration efficiency of a filter element against microorganisms such as Serratia Marcescens may be measured in accordance with ASTM F838 (2005).

A filter element as described herein may have a variety of filtration efficiencies against microorganisms such as Cryptosporidium parvum oocysts. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against Cryptosporidium parvum oocysts. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against Cryptosporidium parvum oocysts. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of Cryptosporidium parvum oocysts.

Filtration efficiency of a filter element against microorganisms such as Cryptosporidium parvum oocysts may be measured in accordance with NSF 53 (2021) § 7.3.2.

A filter element as described herein may have a variety of filtration efficiencies against microorganisms such as Cryptosporidium. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against Cryptosporidium. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against Cryptosporidium. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of Cryptosporidium.

Filtration efficiency of a filter element against microorganisms such as Cryptosporidium may be measured in accordance with EPA 1623.1 (2012).

A filter element as described herein may have a variety of filtration efficiencies against microorganisms such as Giardia. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against Giardia. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against Giardia. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of Giardia.

Filtration efficiency of a filter element against microorganisms such as Giardia may be measured in accordance with EPA 1623.1 (2012).

A filter element as described herein may have a variety of filtration efficiencies against microorganisms such as coliform bacteria. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against coliform bacteria. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against coliform bacteria. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of coliform bacteria.

Filtration efficiency of a filter element against microorganisms such as coliform bacteria may be measured in accordance with EPA 9223 B Collilert-18® (2017).

A filter element as described herein may have a variety of filtration efficiencies against microorganisms such as Escherichia coli. In some embodiments, the filter element has a filtration efficiency greater than or equal to 1 LRV, greater than or equal to 2 LRV, greater than or equal to 3 LRV, greater than or equal to 4 LRV, greater than or equal to 5 LRV, greater than or equal to 6 LRV, greater than or equal to 7 LRV, greater than or equal to 8 LRV, or greater than or equal to 9 LRV against Escherichia coli. In some embodiments, the filter element has a filtration efficiency less than or equal to 9 LRV, less than or equal to 8 LRV, less than or equal to 7 LRV, less than or equal to 6 LRV, less than or equal to 5 LRV, less than or equal to 4 LRV, less than or equal to 3 LRV, less than or equal to 2 LRV, or less than or equal to 1 LRV against Escherichia coli. Combinations of these ranges are possible (e.g., greater than or equal to 1 LRV and less than or equal to 9 LRV, greater than or equal to 3 LRV and less than or equal to 9 LRV, and/or greater than or equal to 6 LRV and less than or equal to 9 LRV). Other ranges are also possible. In some embodiments, a filter element has a filtration efficiency such that it results in total removal of Escherichia coli.

Filtration efficiency of a filter element against microorganisms such as Escherichia coli may be measured in accordance with EPA 9223 B Collilert-18® (2017).

In some embodiments, a filter element comprises absorptive or adsorptive molecular filter media such as granular activated carbon, carbon blocks, ion exchange resins, metal-organic frameworks, softeners, and/or other organic or inorganic media. Such absorptive or adsorptive molecular filter media may be present in a composite layer and/or a gradient layer.

In some embodiments, a filter element comprises anti-microbial and/or anti-fungal additives such as silver ions. Such anti-microbial and/or antifungal additives may be present in a composite layer and/or a gradient layer.

In some embodiments, a filter element comprises components that can detect, signal, or otherwise indicate the presence of certain conditions such as relatively high or relatively low pH or relatively high or relatively low total organic carbon (TOC). Such components may be present in a composite layer and/or a gradient layer.

In some embodiments, a filter element comprises, consists of, and/or consists essentially of a food-grade material. In some embodiments, the food-grade material may meet some or all of the requirements for food contact applications in accordance with US 21 CFR (as in force in April 2024) and EU 10/2011 (2011), and/or be substantially free of PFAS, lead, and/or bis-phenol A.

In some embodiments, a filter element comprises, consist of, and/or consists essentially of a recyclable material. For instance, a filter element may comprise, consist of, and/or consist essentially of one or more recyclable plastics, non-limiting examples of which include polyester, polypropylene, high-density polyethylene, low-density polyethylene, and polyvinyl chloride.

Filter elements described herein may have a variety of suitable initial water flow rates. In some embodiments, the initial water flow rate of the filter element is greater than or equal to 0.1 L/min, greater than or equal to 0.5 L/min, greater than or equal to 1 L/min, greater than or equal to 10 L/min, greater than or equal to 50 L/min, greater than or equal to 75 L/min, greater than or equal to 100 L/min, greater than or equal to 125 L/min, greater than or equal to 150 L/min, greater than or equal to 175 L/min, or greater than or equal to 200 L/min. In some embodiments, the initial water flow rate of the filter element is less than or equal to 200 L/min, less than or equal to 175 L/min, less than or equal to 150 L/min, less than or equal to 125 L/min, less than or equal to 100 L/min, less than or equal to 75 L/min, less than or equal to 50 L/min, less than or equal to 10 L/min, less than or equal to 1 L/min, less than or equal to 0.5 L/min, or less than or equal to 0.1 L/min. Combinations of these ranges are possible (e.g., greater than or equal to 0.1 L/min and less than or equal to 200 L/min, greater than or equal to 0.5 L/min and less than or equal to 150 L/min, and/or greater than or equal to 1 L/min and less than or equal to 100 L/min). Other ranges are also possible.

The initial water flow rate of filter media may be measured at ambient pressure, with a water height (or device height) of 60 mm to 250 mm, and filter area of 10 cm² to 500 cm². A filter holder that can accommodate a 43 mm (11.5 cm² filter area) membrane disk, 70 ml water capacity and 6.08 cm of the depth of the water reservoir above the membrane may be used to measure water flow rate. The water flow rate may be measured by filling the water reservoir to a certain volume (e.g., 70 mL) above the membrane to obtain constant hydrostatic pressure of 596.5 Pa. To maintain a constant hydrostatic pressure, the volume of the water in the reservoir can be kept constant throughout the experiment. This may involve continuously adding water to the reservoir as water permeates through the filter. The water flow rate is measured by determining the duration of time needed for 500 ml of water to permeate through the membrane under the aforementioned conditions.

Some filter elements described herein are capable of being filled with 0.6 gallons of water over relatively short periods of time. In some embodiments, a filter element is capable of being filled with 0.6 gallons of water over a period of time of (i.e., it may have an “initial water fill time” of) less than or equal to 30 minutes, less than or equal to 25 minutes, less than or equal to 20 minutes, less than or equal to 15 minutes, less than or equal to 10 minutes, less than or equal to 7.5 minutes, less than or equal to 5 minutes, or less than or equal to 2 minutes. In some embodiments, a filter element is capable of being filled with 0.6 gallons of water over a period of time of greater than or equal to 1 minute, greater than or equal to 2 minutes, greater than or equal to 5 minutes, greater than or equal to 7.5 minutes, greater than or equal to 10 minutes, greater than or equal to 15 minutes, greater than or equal to 20 minutes, or greater than or equal to 25 minutes. Combinations of the above-referenced ranges are also possible (e.g., less than or equal to 30 minutes and greater than or equal to 1 minute). Other ranges are also possible.

In some embodiments, a filter element is re-fillable and/or non-permanent. For instance, a filter element may be capable of being filled with water, partially or fully emptied of water, and then re-filled with water one or more times. In some embodiments, the water flow rate and/or water fill time of a filter element may undergo relatively little change even though an appreciable amount of water has flowed through the filter element. In some embodiments, the water flow rate and/or water fill time of a filter element after a particular amount of water has flowed therethrough may remain within 0%, within 1%, within 2%, within 5%, within 7.5%, within 10%, within 20%, within 50%, within 75%, within 100%, within 200%, or within 300% of the initial water flow rate and/or water fill time.

In some embodiments, a filter element has a water flow rate and/or water fill time in one or more of the above-referenced ranges after greater than or equal to 1 L of water, greater than or equal to 2 L of water, greater than or equal to 5 L of water, greater than or equal to 7.5 L of water, greater than or equal to 10 L of water, greater than or equal to 20 L of water, greater than or equal to 50 L of water, greater than or equal to 75 L of water, greater than or equal to 100 L of water, greater than or equal to 200 L of water, greater than or equal to 500 L of water, greater than or equal to 750 L of water, or greater than or equal to 1000 L of water has flowed therethrough. In some embodiments, a filter element has a water flow rate and/or water fill time in one or more of the above-referenced ranges after less than or equal to 2000 L of water, less than or equal to 1000 L of water, less than or equal to 750 L of water, less than or equal to 500 L of water, less than or equal to 200 L of water, less than or equal to 100 L of water, less than or equal to 75 L of water, less than or equal to 50 L of water, less than or equal to 20 L of water, less than or equal to 10 L of water, less than or equal to 7.5 L of water, less than or equal to 5 L of water, or less than or equal to 2 L of water has flowed therethrough. Combinations of the above-referenced ranges are also possible (e.g., a filter element may have a water flow rate and/or a water fill time in one or more of the ranges in the preceding paragraph after greater than or equal to 1 L of water and less than or equal to 2000 L of water has flowed therethrough). Other ranges are also possible.

The water flow rate and water fill time after a particular amount of water has flowed through a filter element may be determined by flowing that amount of water through the filter element in the manner described above with respect to the measurement of the initial water flow rate and then determining the water flow rate and water fill time in the manner above with respect to the determination of the initial water flow rate and the initial water fill time. Some filter elements described herein may have relatively high lifetimes. In some embodiments, a filter element has a lifetime of greater than or equal to 5 gallons, greater than or equal to 7.5 gallons, greater than or equal to 10 gallons, greater than or equal to 20 gallons, greater than or equal to 50 gallons, greater than or equal to 75 gallons, greater than or equal to 100 gallons, greater than or equal to 125 gallons, greater than or equal to 150 gallons, greater than or equal to 175 gallons, greater than or equal to 200 gallons, greater than or equal to 225 gallons, greater than or equal to 250 gallons, or greater than or equal to 275 gallons. In some embodiments, a filter element has a lifetime of less than or equal to 300 gallons, less than or equal to 275 gallons, less than or equal to 250 gallons, less than or equal to 225 gallons, less than or equal to 200 gallons, less than or equal to 175 gallons, less than or equal to 150 gallons, less than or equal to 125 gallons, less than or equal to 100 gallons, less than or equal to 75 gallons, less than or equal to 50 gallons, less than or equal to 20 gallons, less than or equal to 10 gallons, or less than or equal to 7.5 gallons. Combinations of the above-referenced ranges are also possible (e.g., greater than or equal to 5 gallons and less than or equal to 300 gallons). Other ranges are also possible.

In some embodiments, a filter element comprises one or more materials (e.g., an absorptive and/or adsorptive molecular filter media) having a lifetime in one or more of the above-referenced ranges. In some embodiments, a filter element exhibits a water flow rate and/or a water fill time that is within a certain amount of its initial water flow rate and/or water fill time (e.g., within 100%, within 500%) after an amount of water in one or more of the above-referenced ranges has flowed therethrough.

Filter elements described herein may have a variety of suitable heights. In some embodiments, a filter element has a height of greater than or equal to 60 mm, greater than or equal to 75 mm, greater than or equal to 100 mm, greater than or equal to 150 mm, greater than or equal to 200 mm, greater than or equal to 250 mm, greater than or equal to 300 mm, greater than or equal to 400 mm, greater than or equal to 500 mm, or greater than or equal to 750 mm. In some embodiments, a filter element has a height of less than or equal to 1000 mm, less than or equal to 750 mm, less than or equal to 500 mm, less than or equal to 400 mm, less than or equal to 300 mm, less than or equal to 250 mm, less than or equal to 200 mm, less than or equal to 150 mm, less than or equal to 100 mm, or less than or equal to 75 mm. Combinations of the above-referenced ranges are also possible (e.g., greater than or equal to 60 mm and less than or equal to 1000 mm, or greater than or equal to 60 mm and less than or equal to 250 mm). Other ranges are also possible.

Filter elements described herein may have a variety of suitable diameters. In some embodiments, a filter element has a diameter of greater than or equal to 30 mm, greater than or equal to 50 mm, greater than or equal to 75 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, or greater than or equal to 275 mm. In some embodiments, a filter element has a diameter of less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 75 mm, or less than or equal to 50 mm. Combinations of the above-referenced ranges are also possible (e.g., greater than or equal to 30 mm and less than or equal to 300 mm). Other ranges are also possible.

Filter elements described herein may have a variety of suitable aspect ratios (i.e., ratios of height to diameter). In some embodiments, a filter element has an aspect ratio of greater than or equal to 1, greater than or equal to 2, greater than or equal to 5, greater than or equal to 7.5, greater than or equal to 10, greater than or equal to 12.5, greater than or equal to 15, greater than or equal to 17.5, greater than or equal to 20, greater than or equal to 22.5, greater than or equal to 25, or greater than or equal to 27.5. In some embodiments, a filter element has an aspect ratio of less than or equal to 30, less than or equal to 27.5, less than or equal to 25, less than or equal to 22.5, less than or equal to 20, less than or equal to 17.5, less than or equal to 15, less than or equal to 12.5, less than or equal to 10, less than or equal to 7.5, less than or equal to 5, or less than or equal to 2. Combinations of the above-referenced ranges are also possible (e.g., greater than or equal to 1 and less than or equal to 30). Other ranges are also possible.

Filter elements described herein may have a variety of suitable volumes. In some embodiments, the volume of the filter element is greater than or equal to 1 cm³, greater than or equal to 10 cm³, greater than or equal to 50 cm³, greater than or equal to 100 cm³, greater than or equal to 250 cm³, greater than or equal to 500 cm³, greater than or equal to 750 cm³, or greater than or equal to 1000 cm³. In some embodiments, the volume of the filter element is less than or equal to 1000 cm³, less than or equal to 750 cm³, less than or equal to 500 cm³, less than or equal to 250 cm³, less than or equal to 100 cm³, less than or equal to 50 cm³, less than or equal to 10 cm³, less than or equal to 1 cm³. Combinations of these ranges are possible (e.g., greater than or equal to 1 cm³ and less than or equal to 1000 cm³). Other ranges are also possible.

Filter elements described herein may have a variety of suitable dry weights. In some embodiments, the dry weight of the filter element is greater than or equal to 1 gram, greater than or equal to 10 grams, greater than or equal to 50 grams, greater than or equal to 100 grams, greater than or equal to 250 grams, greater than or equal to 500 grams, greater than or equal to 1000 grams, greater than or equal to 1500 grams, or greater than or equal to 2000 grams. In some embodiments, the dry weight of the filter element is less than or equal to 2000 grams, less than or equal to 1500 grams, less than or equal to 1000 grams, less than or equal to 500 grams, less than or equal to 250 grams, less than or equal to 100 grams, less than or equal to 50 grams, less than or equal to 10 grams, or less than or equal to 1 gram. Combinations of these ranges are possible (e.g., greater than or equal to 1 gram and less than or equal to 2000 grams). Other ranges are possible.

Filter elements described herein may have a variety of suitable areas of filter media. In some embodiments, the area of the filter media in the filter element is greater than or equal to 10 cm², greater than or equal to 50 cm², greater than or equal to 100 cm², greater than or equal to 300 cm², greater than or equal to 500 cm², greater than or equal to 800 cm², or greater than or equal to 1000 cm². In some embodiments, the area of the filter media in the filter element is less than or equal to 1000 cm², less than or equal to 800 cm², less than or equal to 500 cm², less than or equal to 300 cm², less than or equal to 100 cm², less than or equal to 50 cm², or less than or equal to 10 cm². Combinations of these ranges are possible (e.g., greater than or equal to 10 cm² and is less than or equal to 1000 cm², greater than or equal to 50 cm² and is less than or equal to 800 cm², and/or greater than or equal to 100 cm² and is less than or equal to 500 cm²). Other ranges are possible.

In some embodiments, the pressure drop across a filter element having a height of 10 inches at a flow rate of 15 liters per minute may be relatively low. For instance, in some embodiments, the pressure drop across a filter element having a height of 10 inches may less than or equal to 5 kPa, less than or equal to 4.8 kPa, less than or equal to 4.5 kPa, less than or equal to 4.2 kPa, less than or equal to 4 kPa, less than or equal to 3.8 kPa, less than or equal to 3.5 kPa, less than or equal to 3.2 kPa, less than or equal to 3 kPa, less than or equal to 2.8 kPa, less than or equal to 2.5 kPa, less than or equal to 2 kPa, less than or equal to 1.5 kPa, or less than or equal to 1 kPa. In some instances, a filter element having a height of 10 inches may have a pressure drop of greater than or equal to 1 kPa, greater than or equal to 1.2 kPa, greater than or equal to 1.5 kPa, greater than or equal to 1.8 kPa, greater than or equal to 2 kPa, greater than or equal to 2.2 kPa, greater than or equal to 2.5 kPa, greater than or equal to 2.8 kPa, greater than or equal to 3 kPa, greater than or equal to 3.2 kPa, greater than or equal to 3.5 kPa, greater than or equal to 3.8 kPa, or greater than or equal to 4 kPa. Combinations of the above-referenced ranges are also possible (e.g., greater than or equal to 1 kPa and less than or equal to 5 kPa, greater than or equal to 1.5 kPa and less than or equal to 4.5 kPa). Other values of pressure drop are also possible. The filter element pressure drop can be measured using the standard NF X 45-302:2000. The pressure drop was measured using 18 MegaOhm-cm deionized water with a flow rate of 15 liters per minute through the filter element having a height of 10 inches.

In some embodiments, the pressure drop across a filter element having a height of 10 inches at a flow rate of 20 liters per minute may be relatively low. For instance, in some embodiments, the filter element having a height of 10 inches may have a pressure drop less than or equal to 7 kPa, less than or equal to 6.8 kPa, less than or equal to 6.5 kPa, less than or equal to 6.2 kPa, less than or equal to 6 kPa, less than or equal to 5.8 kPa, less than or equal to 5.5 kPa, less than or equal to 5.2 kPa, less than or equal to 5 kPa, less than or equal to 4.8 kPa, less than or equal to 4.5 kPa, less than or equal to 4.2 kPa, less than or equal to 4 kPa, less than or equal to 3.8 kPa, less than or equal to 3.5 kPa, less than or equal to 3.2 kPa, less than or equal to 3 kPa, or less than or equal to 2.8 kPa. In some instances, a filter element having a height of 10 inches may have a pressure drop of greater than or equal to 2.5 kPa, greater than or equal to 2.8 kPa, greater than or equal to 3 kPa, greater than or equal to 3.2 kPa, greater than or equal to 3.5 kPa, greater than or equal to 3.8 kPa, greater than or equal to 4 kPa, greater than or equal to 4.2 kPa, greater than or equal to 4.5 kPa, greater than or equal to 4.8 kPa, greater than or equal to 5 kPa, greater than or equal to 5.2 kPa, greater than or equal to 5.5 kPa, greater than or equal to 5.8 kPa, or greater than or equal to 6 kPa. Combinations of the above-referenced ranges are also possible (e.g., greater than or equal to 2.5 kPa and less than or equal to 7 kPa, greater than or equal to 3 kPa and less than or equal to 6.5 kPa). Other values of pressure drop are also possible. The filter element pressure drop can be measured using the NF X 45-302:2000. The pressure drop was measured using 18 MegaOhm-cm deionized water with a flow rate of 20 liters per minute through the filter element having a height of 10 inches.

In some embodiments, the filter element may meet the mechanical filtration requirements of NSF 42 (2019) § 7.4 and or NSF 53 (2021) § 7.3. In some embodiments, the filter element, with the filter media described throughout totality of this disclosure, may be capable of at least partially filtering out and/or removing Cryptosporidium parvum oocysts.

Filter elements as described herein may have a variety of suitable filtration efficiencies. In some embodiments, the filter element has a filtration efficiency of greater than or equal to 85%, greater than or equal to 90%, greater than or equal to 95%, greater than or equal to 99%, greater than or equal to 99.9%, greater than or equal to 99.99%, greater than or equal to 99.999%, or greater than or equal to 99.9999% for particulates with a maximum characteristic dimension greater than or equal to 0.5 micrometer and less than or equal to 1 micrometer. In some embodiments, the filter element has a filtration efficiency of less than or equal to 99.9999%, less than or equal to 99.999%, less than or equal to 99.99%, less than or equal to 99.9%, less than or equal to 99%, less than or equal to 95%, less than or equal to 90%, or less than or equal to 85% for particulates with a maximum characteristic dimension greater than or equal to 0.5 micrometer and less than or equal to 1 micrometer. Combinations of these ranges are possible (e.g., greater than or equal to 85% and less than or equal to 99.9999%, greater than or equal to 90% and less than or equal to 99.999%, and greater than or equal to 95% and less than or equal to 99.99%). Other ranges are also possible.

The filtration efficiency of the filter element against particulates with a maximum characteristic dimension greater than or equal to 0.5 micrometers and less than or equal to 1 micrometer may be measured in accordance with NSF 42 (2019) § 7.4.

Filter elements described herein may have a variety of suitable filtration efficiencies against particles having a maximum characteristic dimension of 3 micrometers. In some embodiments, the filter element has a filtration efficiency of greater than or equal to 80%, greater than or equal to 85%, greater than or equal to 90%, greater than or equal to 95%, greater than or equal to 99%, greater than or equal to 99.9%, greater than or equal to 99.95%, greater than or equal to 99.999%, greater than or equal to 99.9999% for particulates with a maximum characteristic dimension greater than or equal to 3 micrometers. In some embodiments, the filter element has a filtration efficiency of less than or equal to 99.9999%, less than or equal to 99.999%, less than or equal to 99.95%, less than or equal to 99.9%, less than or equal to 99%, less than or equal to 95%, less than or equal to 90%, less than or equal to 85%, or less than or equal to 80% for particulates with a maximum characteristic dimension greater than or equal to 3 micrometers. Combinations of these ranges are possible (e.g., greater than or equal to 80% and less than or equal to 99.9999%, greater than or equal to 90% and less than or equal to 99.999%, and greater than or equal to 99.95% and less than or equal to 99.999%). Other ranges are also possible.

The filtration efficiency of the filter element against particulates with a maximum characteristic dimension greater than or equal to 3 micrometers may be measured in accordance with NSF 53 (2021) § 7.3.2.2.1.

In some embodiments, the filter element has a filtration efficiency as listed in any one of the ranges listed above, measured in accordance with NSF 53 (2021) § 7.3.2.2.1, for monodispersed particulates comprising polystyrene having a maximum characteristic dimension greater than or equal to 3 micrometers.

In some embodiments, the filter element has a filtration efficiency as listed in any one of the ranges listed above, measured in accordance with NSF 53 (2021) § 7.3.2.2.1, for monodispersed particulates comprising polyvinyl chloride (PVC) having a maximum characteristic dimension greater than or equal to 3 micrometers.

In some embodiments, filter media may comprise synthetic fibers. For instance, in some embodiments, the first fiber web and/or the second fiber web may comprise synthetic fibers. The synthetic fibers may have a relatively small average fiber diameter (e.g., less than or equal to about 2 micrometers). For instance, the synthetic fibers in the first fiber web may have an average diameter of less than or equal to 0.5 micrometers (e.g., between 0.05 micrometers and 0.5 micrometers). In some embodiments, the synthetic fibers in the first fiber web, the second fiber web, and/or the filter media may be continuous fibers formed by any suitable process (e.g., a melt-blown, a meltspun, an electrospinning, a spunbond, a centrifugal spinning process). In certain embodiments, the synthetic fibers may be formed by an electrospinning process (e.g., melt electrospinning, solvent electrospinning). In other embodiments, the synthetic fibers may be non-continuous. In some embodiments, all of the fibers in the filter media are synthetic fibers. In certain embodiments, all of the fibers in first fiber web 108 and/or second fiber web 106 are synthetic fibers. In some such cases, all of the fibers in first fiber web 108 and/or second fiber web 106 are continuous fibers.

Synthetic fibers may include any suitable type of synthetic polymer or other material. Examples of suitable synthetic fibers include polyimide, aliphatic polyamide (e.g., nylon 6), aromatic polyamide, polysulfone, cellulose acetate, polyether sulfone, polyaryl ether sulfone, modified polysulfone polymers, modified polyethersulfone polymers, polymethyl methacrylate, polyacrylonitrile, polyurethane, poly(urea urethane), polybenzimidazole, polyetherimide, polyacrylonitrile, poly(ethylene terephthalate), polypropylene, silicon dioxide (silica), regenerated cellulose (e.g., Lyocell, rayon), carbon (e.g., derived from the pyrolysis of polyacrilonitrile), polyaniline, poly(ethylene oxide), poly(ethylene naphthalate), poly(butylene terephthalate), styrene butadiene rubber, polystyrene, poly(vinyl chloride), poly(vinyl alcohol), poly(vinylidene fluoride), poly(vinyl butylene) and copolymers or derivative compounds thereof, and combinations thereof. In some embodiments, the synthetic fibers are organic polymer fibers. Synthetic fibers may also include multi-component fibers (i.e., fibers having multiple compositions such as bicomponent fibers). In some cases, synthetic fibers may include electrospun (e.g., melt, solvent), meltblown, meltspun, or centrifugal spun fibers, which may be formed of polymers described herein (e.g., nylon, polyester, polypropylene). In some embodiments, synthetic fibers may be electrospun fibers. The filter media, as well as each of the fiber webs within the filter media, may also include combinations of more than one type of synthetic fiber. It should be understood that other types of synthetic fiber types may also be used.

In some cases, the synthetic fibers (e.g., in the first and/or second fiber webs) may be continuous (e.g., electrospun fibers, meltblown fibers, spunbond fibers, centrifugal spun fibers, etc.). For instance, synthetic fibers may have an average length of at least 5 cm, at least 10 cm, at least 15 cm, at least 20 cm, at least 50 cm, at least 100 cm, at least 200 cm, at least 500 cm, at least 700 cm, at least 1000 cm, at least 1500 cm, at least 2000 cm, at least 2500 cm, at least 5000 cm, at least 10000 cm; and/or less than or equal to 10000 cm, less than or equal to 5000 cm, less than or equal to 2500 cm, less than or equal to 2000 cm, less than or equal to 1000 cm, less than or equal to 500 cm, or less than or equal to 200 cm. Combinations of the above-referenced ranges are also possible (e.g., greater than or equal to 100 cm and less than or equal to 2500 cm). Other values of average fiber length are also possible.

In other embodiments, the synthetic fibers are not continuous (e.g., staple fibers). In general, synthetic non-continuous fibers may be characterized as being shorter than continuous synthetic fibers. For instance, in some embodiments, synthetic fibers in one or more fiber webs (e.g., second fiber web) in the filter media may have an average length of at least 0.1 mm, at least 0.5 mm, at least 1 mm, at least 1.5 mm, at least 2 mm, at least 3 mm, at least 4 mm, at least 5 mm, at least 6 mm, at least 7 mm, at least 8 mm, at least 9 mm, at least 10 mm, at least 12 mm, at least 15 mm; and/or less than or equal to 15 mm, less than or equal to 12 mm, less than or equal to 10 mm, less than or equal to 5 mm, less than or equal to 4 mm, less than or equal to 1 mm, less than or equal to 0.5 mm, or less than or equal to 0.1 mm. Combinations of the above-referenced ranges are also possible (e.g., at least 1 mm and less than or equal to 4 mm). Other values of average fiber length are also possible.

In one set of embodiments, one or more fiber webs (e.g., second fiber web) in the filter media may include bicomponent fibers. The bicomponent fibers may comprise a thermoplastic polymer. Each component of the bicomponent fiber can have a different melting temperature. For example, the fibers can include a core and a sheath where the activation temperature of the sheath is lower than the melting temperature of the core. This allows the sheath to melt prior to the core, such that the sheath binds to other fibers in the fiber web, while the core maintains its structural integrity. The core/sheath binder fibers can be concentric or non-concentric. Other exemplary bicomponent fibers can include split fiber fibers, side-by-side fibers, and/or “island in the sea” fibers.

In some embodiments, bicomponent fibers may have an average length of at least 0.1 mm, at least 0.5 mm, at least 1 mm, at least 1.5 mm, at least 2 mm, at least 3 mm, at least 4 mm, at least 5 mm, at least 6 mm, at least 7 mm, at least 8 mm, at least 9 mm, at least 10 mm, at least 12 mm, at least 15 mm; and/or less than or equal to 15 mm, less than or equal to 12 mm, less than or equal to 10 mm, less than or equal to 5 mm, less than or equal to 4 mm, less than or equal to 1 mm, less than or equal to 0.5 mm, or less than or equal to 0.1 mm. Combinations of the above-referenced ranges are also possible (e.g., at least 1 mm and less than or equal to 4 mm). Other values of average fiber length are also possible.

In some embodiments in which bicomponent fibers are included in one or more fiber webs (e.g., second fiber web) and/or the entire filter media, the weight percentage of bicomponent fibers in one or more fiber webs and/or the entire filter media may be, for example, greater than or equal to 1 wt %, greater than or equal to 5 wt %, greater than or equal to 10 wt %, greater than or equal to 15 wt %, greater than or equal to 30 wt %, or greater than or equal to 45 wt %. In some instances, the weight percentage of bicomponent fibers in one or more fiber webs and/or the entire filter media may be less than or equal to 70 wt %, less than or equal to 50 wt %, less than or equal to 25 wt %, less than or equal to 10 wt %, less than or equal to 5 wt %, or less than or equal to 1 wt %. Combinations of the above-referenced ranges are also possible (e.g., greater than or equal to 30 wt % and less than or equal to 70 wt %). Other values of weight percentage of the bicomponent fibers are also possible. In other embodiments, one or more fiber webs (e.g., second fiber web) and/or the entire filter media may include 0 wt % bicomponent fibers.

In some embodiments in which the second fiber web comprises non-continuous fibers, the second fiber web may comprise glass fibers.

In some embodiments, one or more layers (e.g., second fiber web, third fiber web) and/or the entire filter media is substantially free of glass fibers (e.g., less than 1 wt % glass fibers, between 0 wt % and 1 wt % glass fibers). For instance, the first fiber web, second fiber web, third fiber web and/or the entire filter media may include 0 wt % glass fibers. Filter media and arrangements that are substantially free of glass fibers may be advantageous for certain applications (e.g., fuel-water separation, particulate separation in fuel systems), since glass fibers may shed and leach sodium ions (e.g., Na⁺) which can lead to physical abrasion and soap formation. For example, shedding of glass fibers may lead to the blockage of fuel injectors such as in high pressure common rail applications. In other embodiments, the second layer may optionally include glass fibers (e.g., microglass and/or chopped glass fibers).

In other embodiments, however, one or more layers and/or the entire filter media may include glass fibers (e.g., microglass fibers, chopped strand glass fibers, or a combination thereof). The average diameter of glass fibers may be, for example, less than or equal to 30 micrometers, less than or equal to 25 micrometers, less than or equal to 15 micrometers, less than or equal to 12 micrometers, less than or equal to 10 micrometers, less than or equal to 9 micrometers, less than or equal to 7 micrometers, less than or equal to 5 micrometers, less than or equal to 3 micrometers, or less than or equal to 1 micrometer. In some instances, the glass fibers may have an average fiber diameter of greater than or equal to 0.1 micrometers, greater than or equal to 0.3 micrometers, greater than or equal to 1 micrometer, greater than or equal to 3 micrometers, or greater than equal to 7 micrometers greater than or equal to 9 micrometers, greater than or equal to 11 micrometers, or greater than or equal to 20 micrometers. Combinations of the above-referenced ranges are also possible (e.g., greater than or equal to 0.1 micrometers and less than or equal to 9 micrometers). Other values of average fiber diameter are also possible.

In some embodiments, the weight percentage of the glass fibers may be greater than or equal to 0 wt %, greater than or equal to 2 wt %, greater than or equal to 5 wt %, greater than or equal to 10 wt %, greater than or equal to 15 wt %. greater than or equal to 25 wt %, greater than or equal to 35 wt %, greater than or equal to 50 wt %, greater than or equal to 65 wt %, or greater than or equal to 80 wt %. In some instances, the weight percentage of the glass fibers in the layer may be less than or equal to 100 wt %, less than or equal to 98 wt %, less than or equal to 95 wt %, less than or equal to 90 wt %, less than or equal to 80 wt %, less than or equal to 65 wt %, less than or equal to 50 wt %, less than or equal to 35 wt %, less than or equal to 25 wt %, less than or equal to 20 wt %, less than or equal to 15 wt %, less than or equal to 10 wt %, less than or equal to 5 wt %, less than or equal to 2 wt %, or less than or equal to 1 wt %. Combinations of the above-referenced ranges are also possible (e.g., greater than or equal to 0 wt % and less than or equal to 10 wt %, greater than or equal to 2 wt % and less than or equal to 100 wt %). In some embodiments, weight percentage of the glass fibers may be less than or equal to 5 wt. % (e.g., 0 wt. %). In other embodiments, weight percentage of the glass fibers may be greater than or equal to 90 wt. % (e.g., 100 wt. %). Other values of weight percentage of the glass in a layer are also possible. In some embodiments, a layer or the filter media includes the above-noted ranges of glass fibers with respect to the total weight of fibers in the layer or filter media, respectively. In some embodiments, the above weight percentages are based on the weight of the total dry solids of the layer.

In some embodiments in which the second fiber web comprises non-continuous fibers, the second fiber web may comprise fibrillated fibers (e.g., fibrillated lyocell fibers, fibrillated acrylic fibers).

In some embodiments, the fibers in one or more layers (e.g., second fiber web, third fiber web) and/or the filter media may comprise fibrillated fibers. As known to those of ordinary skill in the art, a fibrillated fiber includes a parent fiber that branches into smaller diameter fibrils, which can, in some instances, branch further out into even smaller diameter fibrils with further branching also being possible. The branched nature of the fibrils leads to a high surface area and can increase the number of contact points between the fibrillated fibers and the fibers in the fiber web. Such an increase in points of contact between the fibrillated fibers and other fibers and/or components of the web may contribute to enhancing mechanical properties (e.g., flexibility, strength) and/or filtration performance properties of the fiber web.

Examples of fibrillated fibers, include, but are not limited to, fibrillated regenerated cellulose (e.g., rayon, Lyocell), microfibrillated cellulose, nanofibrillated cellulose, fibrillated synthetic fibers, including nanofibrillated synthetic fibers (e.g., fibrillated fibers formed of synthetic polymers such as polyester, polyamide, polyaramid, para-aramid, meta-aramid, polyimide, polyethylene, polypropylene, polyether ether ketone, polyethylene terephthalate, polyolefin, nylon, and/or acrylics), and fibrillated natural fibers (e.g., hardwood, softwood). Regardless of the type of fibrillated fibers, the weight percentage of fibrillated fibers in one or more layers (e.g., second fiber web, third fiber web) and/or the entire filter media may be greater than or equal to 0 wt %, greater than or equal to 1 wt %, greater than or equal to 5 wt %, greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, or greater than or equal to 80 wt %, e.g., based on the total weight of fibers in the layer or media. In some instances, the weight percentage of the fibrillated fibers in one or more layers and/or the entire filter media may be less than or equal to 100 wt %, less than or equal to 98 wt %, less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, or less than or equal to 10%, e.g., based on the total weight of fibers in the layer or media. Combinations of the above-referenced ranges are also possible (e.g., greater than or equal to 0 wt %, and less than or equal to 100 wt %, greater than or equal to 0 wt %, and less than or equal to 80 wt %). Other values of weight percentage of the fibrillated fibers in one or more layers and/or the entire filter media are also possible. In some embodiments, a layer or the filter media may include 0 wt % fibrillated fibers. In some embodiments, a layer (e.g., second fiber web, third fiber web) of the filter media may include greater than or equal to 90 wt. % (e.g., 100 wt. %) fibrillated fibers. For instance, the second layer may comprise 100 wt. % fibrillated fibers. In some embodiments, a layer or the filter media includes the above-noted ranges of fibrillated fibers with respect to the total weight of fibers in the layer or filter media, respectively. In some embodiments, the above weight percentages are based on the weight of the total dry solids of the layer or filter media (including any resins).

In some embodiments the parent fibers may have an average diameter in the micrometer range. For example, the parent fibers may have an average diameter of greater than or equal to 1 micrometer, greater than or equal to 5 micrometers, greater than or equal to 10 micrometers, greater than or equal to 20 micrometers, greater than or equal to 30 micrometers, greater than or equal to 40 micrometers, greater than or equal to 50 micrometers, greater than or equal to 60 micrometers, or greater than or equal to 70 micrometers. In some embodiments, the parent fibers may have an average diameter of less than or equal to 75 micrometers, less than or equal to 55 micrometers, less than or equal to 35 micrometers, less than or equal to 25 micrometers, less than or equal to 15 micrometers, less than or equal to 10 micrometers, or less than or equal to 5 micrometers. Combinations of the above referenced ranges are also possible (e.g., parent fibers having an average diameter of greater than or equal to 1 micrometer and less than or equal to 25 micrometers). Other ranges are also possible.

In other embodiments, the parent fibers may have an average diameter in the nanometer range. For instance, in some embodiments, the parent fibers may have an average diameter of less than 1 micrometer, less than or equal to 0.8 micrometers, less than or equal to 0.5 micrometers, less than or equal to 0.1 micrometers, less than or equal to 0.05 micrometers, less than or equal to 0.02 micrometers, less than or equal to 0.01 micrometers, or less than or equal to 0.005 micrometers. In some embodiments, the parent fibers may have an average diameter of greater than or equal to 0.003 micrometers, greater than or equal to 0.004 micrometer, greater than or equal to 0.01 micrometers, greater than or equal to 0.05 micrometers, greater than or equal to 0.1 micrometers, or greater than or equal to 0.5 micrometers. Combinations of the above referenced ranges are also possible (e.g., parent fibers having an average diameter of greater than or equal to 0.004 micrometers and less than or equal to 0.02 micrometers). Other ranges are also possible.

The average diameter of the fibrils is generally less than the average diameter of the parent fibers. Depending on the average diameter of the parent fibers, in some embodiments, the fibrils may have an average diameter of less than or equal to 25 micrometers, less than or equal to 20 micrometers, less than or equal to 10 micrometers, less than or equal to 5 micrometers, less than or equal to 1 micrometer, less than or equal to 0.5 micrometers, less than or equal to 0.1 micrometers, less than or equal to 0.05 micrometers, or less than or equal to 0.01 micrometers. In some embodiments the fibrils may have an average diameter of greater than or equal to 0.003 micrometers, greater than or equal to 0.01 micrometer, greater than or equal to 0.05 micrometers, greater than or equal to 0.1 micrometers, greater than or equal to 0.5 micrometers greater than or equal to 1 micrometer, greater than or equal to 5 micrometers, greater than or equal to 10 micrometers, or greater than or equal to 20 micrometers. Combinations of the above referenced ranges are also possible (e.g., fibrils having an average diameter of greater than or equal to 0.01 micrometers and less than or equal to 20 micrometers). Other ranges are also possible.

The level of fibrillation of fibers may be measured according to any number of suitable methods. For example, the level of fibrillation of the fibrillated fibers can be measured according to a Canadian Standard Freeness (CSF) test, specified by TAPPI test method T 227 om 09 (2009) Freeness of pulp. The test can provide an average CSF value.

In some embodiments, the average CSF value of the fibrillated fibers used in one or more layers may vary between 5 mL and 750 mL. In certain embodiments, the average CSF value of the fibrillated fibers used one or more layers may be greater than or equal to 1 mL, greater than or equal to 10 mL, greater than or equal to 20 mL, greater than or equal to 35 mL, greater than or equal to 45 mL, greater than or equal to 50 mL, greater than or equal to 65 mL, greater than or equal to 70 mL, greater than or equal to 75 mL, greater than or equal to 80 mL, greater than or equal to 100 mL, greater than or equal to 150 mL, greater than or equal to 175 mL, greater than or equal to 200 mL, greater than or equal to 250 mL, greater than or equal to 300 mL, greater than or equal to 350 mL, greater than or equal to 500 mL, greater than or equal to 600 mL, greater than or equal to 650 mL, greater than or equal to 700 mL, or greater than or equal to 750 mL.

In some embodiments, the average CSF value of the fibrillated fibers used in one or more layers may be less than or equal to 800 mL, less than or equal to 750 mL, less than or equal to 700 mL, less than or equal to 650 mL, less than or equal to 600 mL, less than or equal to 550 mL, less than or equal to 500 mL, less than or equal to 450 mL, less than or equal to 400 mL, less than or equal to 350 mL, less than or equal to 300 mL, less than or equal to 250 mL, less than or equal to 225 mL, less than or equal to 200 mL, less than or equal to 150 mL, less than or equal to 100 mL, less than or equal to 90 mL, less than or equal to 85 mL, less than or equal to 70 mL, less than or equal to 50 mL, less than or equal to 40 mL, less than or equal to 25 mL, less than or equal to 10 mL, or less than or equal to 5 mL. Combinations of the above-referenced ranges are also possible (e.g., greater than or equal to 10 mL and less than or equal to 300 mL). Other ranges are also possible. The average CSF value of the fibrillated fibers used in one or more layers may be based on one type of fibrillated fiber or more than one type of fibrillated fiber.

In some embodiments, one or more fiber webs and/or the entire filter media, in addition to a plurality of fibers, may also include other components, such as a resin, surface treatments, and/or additives. In general, any suitable resin may be used to achieve the desired properties. For example, the resin may be polymeric, water-based, solvent-based, dry strength, and/or wet strength. Typically, any additional components are present in limited amounts.

In some embodiments, at least a portion of the fibers of one or more fiber web may be coated with a resin without substantially blocking the pores of the fiber web. In some embodiments, one or more fiber webs or the entire filter media described herein include a resin.

In some embodiments, the resin may be a binder resin. The binder resin is not in fiber form and is to be distinguished from binder fiber (e.g., multi-component fiber) described above. In general, the binder resin may have any suitable composition. For example, the binder resin may comprise a thermoplastic (e.g., acrylic, polyvinylacetate, polyester, polyamide), a thermoset (e.g., epoxy, phenolic resin), or a combination thereof. In some cases, a binder resin includes one or more of a vinyl acetate resin, an epoxy resin, a polyester resin, a copolyester resin, a polyvinyl alcohol resin, an acrylic resin such as a styrene acrylic resin, and a phenolic resin. Other resins are also possible.

As described further below, the resin may be added to the fibers in any suitable manner including, for example, in the wet state. In some embodiments, the resin coats the fibers and is used to adhere fibers to each other to facilitate adhesion between the fibers. Any suitable method and equipment may be used to coat the fibers, for example, using curtain coating, gravure coating, melt coating, dip coating, knife roll coating, or spin coating, amongst others. In some embodiments, the binder is precipitated when added to the fiber blend. When appropriate, any suitable precipitating agent (e.g., Epichlorohydrin, fluorocarbon) may be provided to the fibers, for example, by injection into the blend. In some embodiments, upon addition to the fibers, the resin is added in a manner such that one or more fiber web or the entire filter media is impregnated with the resin (e.g., the resin permeates throughout). In a multi-fiber web, a resin may be added to each of the fiber webs separately prior to combining the fiber webs, or the resin may be added to the fiber web after combining the fiber webs. In some embodiments, resin is added to the fibers while in a dry state, for example, by spraying or saturation impregnation, or any of the above methods. In other embodiments, a resin is added to a wet fiber web.

In some embodiments, one or more fiber webs and/or the entire filter media, in addition to a plurality of fibers, may comprise a coating that is suitable for biofiltration applications. In some embodiments, the coated fiber web(s) and/or filter media may be suitable for use as an absorptive membrane filter. The coating may be capable of interacting with one or more proteins or biomolecules and/or of capturing one or more proteins or biomolecules. In some embodiments, the coating may conformally coat at least a portion of the fibers in the web(s) (and/or filter media) and/or may not block a significant portion of the pores in the fiber web(s) (and/or filter media). Non-limiting examples of suitable coatings for biofiltration applications include polymers such as cross-linked poly(ethylene imine), hydrogels, ligands, positively charged molecules such as positively charged polymers (e.g., polymers comprising one or more quaternized groups, such as quaternized dialkylamine groups), and negatively charged molecules such as negatively charged polymers (e.g., polymers comprising one or more sulfonate groups such as acryloamidsulfonic acid groups, polymers comprising one or more acrylate groups such as hydroxyalkyl acrylate groups, polymers comprising one or more carboxylate groups). The coating may be applied using chemical vapor deposition, or by applying a solution comprising the coating to the fiber web(s) and/or filter media. In some embodiments, a monomer may be applied to the fiber web(s) and/or filter media (e.g., by CVD, in a solution) which may polymerize on the surfaces of at least some of the fibers within the fiber web(s) and/or filter media.

Filter media described herein may be produced using suitable processes, such as using a non-wet laid or a wet laid process. In some embodiments, a fiber web and/or the filter media described herein may be produced using a non-wet laid process, such as blowing or spinning process. In some embodiments, a fiber web (e.g., first fiber web, second fiber web) and/or the entire filter media may be formed by an electrospinning process. In some embodiments, electrospinning utilizes a high voltage differential to generate a fine jet of polymer solution from bulk polymer solution. The jet forms as the polymer is charged by the potential and electrostatic repulsion forces overcome the surface tension of the solution. The jet gets drawn into a fine fiber under the effect of repulsive electrical forces applied to the solution. The jet dries in flight and is collected on a grounded collector. The rapid solvent evaporation during this process leads to the formation of polymeric nanofiber which are randomly arranged into a web. In some embodiments, electrospun fibers are made using non-melt fiberization processes. Electrospun fibers can be made with any suitable polymers including but not limiting to, organic polymers, inorganic material (e.g., silica), hybrid polymers, and any combination thereof. In some embodiments, the synthetic fibers, described herein, may be formed from an electrospinning process.

In certain embodiments, a fiber web (e.g., first fiber web, second fiber web) and/or the entire filter media may be formed by a meltblowing system, such as the meltblown system described in U.S. Publication No. 2009/0120048, filed Nov. 7, 2008, and entitled “Meltblown Filter Medium”, and U.S. Publication No. 2012-0152824, filed Dec. 17, 2010, and entitled, “Fine Fiber Filter Media and Processes”, each of which is incorporated herein by reference in its entirety for all purposes. In certain embodiments, a fiber web (e.g., first fiber web, second fiber web) and/or the entire filter media may be formed by a meltspinning or a centrifugal spinning process.

In some embodiments, a fiber web and/or the filter media described herein may be produced using a wet laid process. In general, a wet laid process involves mixing together of fibers of one or more type; for example, polymeric staple fibers of one type may be mixed together with polymeric staple fibers of another type, and/or with fibers of a different type (e.g., synthetic fibers and/or glass fibers), to provide a fiber slurry. The slurry may be, for example, an aqueous-based slurry. In certain embodiments, fibers, are optionally stored separately, or in combination, in various holding tanks prior to being mixed together (e.g., to achieve a greater degree of uniformity in the mixture).

During or after formation of a filter media, the filter media may be further processed according to a variety of known techniques. For instance, a coating method may be used to include a resin in the filter media. Optionally, additional fiber webs can be formed and/or added to a filter media using processes such as lamination, co-pleating, or collation. For example, in some cases, two fiber webs (e.g., first fiber web and the second fiber web) are formed into a composite article by a wet laid process as described above, and the composite article is then combined with a third fiber web by any suitable process (e.g., lamination, co-pleating, or collation). It can be appreciated that a filter media or a composite article formed by the processes described herein may be suitably tailored not only based on the components of each fiber web, but also according to the effect of using multiple fiber webs of varying properties in appropriate combination to form filter media having the characteristics described herein.

As described herein, in some embodiments two or more fiber webs of the filter media (e.g., first fiber web and the third fiber web) may be formed separately and bonded by any suitable method such as lamination, collation, or by use of adhesives. The two or more fiber webs may be formed using different processes, or the same process. For example, each of the fiber webs may be independently formed by a non-wet laid process (e.g., meltblown process, melt spinning process, centrifugal spinning process, electrospinning process, dry laid process, air laid process), a wet laid process, or any other suitable process.

Different fiber webs may be adhered together by any suitable method. For instance, fiber webs may be adhered using compressive techniques (e.g., lamination). Fiber webs may also be adhered by chemical bonding, adhesive and/or melt-bonded to one another on either side.

Lamination may involve, for example, compressing two or more fiber webs (e.g., first and second fiber webs) together using a flatbed laminator or any other suitable device at a particular pressure and temperature for a certain residence time (i.e., the amount of time spent under pressure and heat). For instance, the pressure may be between 40 psi to 60 psi (e.g., between 40 psi to 55 psi, between 40 psi to 50 psi, between 45 psi to 55 psi, between 45 and 60 psi, between 50 psi and 60 psi); the temperature may be between 100 degrees Celsius and 200 degrees Celsius (e.g., between 100 degrees Celsius and 175 degrees Celsius, between 100 degrees Celsius and 150 degrees Celsius, or between 100 degrees Celsius and 125° C., between 125 degrees Celsius and 200 degrees Celsius, between 150 degrees Celsius and 200 degrees Celsius, between 175 degrees Celsius and 200 degrees Celsius); the residence time between 1 second to 60 seconds (e.g., between 1 second to 30 seconds, between 10 second to 25 seconds, or between 20 seconds and 40 seconds). Other ranges for pressure, temperature, and residence time are also possible.

In some embodiments, the filter media may include a first fiber web formed via an electrospinning process adhered (e.g., adhesively) to a second fiber web formed via another process (e.g., meltblowing process). For instance, the first fiber web (e.g., electrospun fiber web) may be adhesively bound to a second fiber web (e.g., meltblown fiber web). Non-limiting example of suitable adhesive include acrylic copolymers, ethyl vinyl acetate (EVA), copolyesters, polyolefins, polyamides, polyurethanes, styrene block copolymers, thermoplastic elastomers, polycarbonates, silicones, and combinations thereof. Adhesives can be applied using different methods, such as spray coating (e.g., solution spraying if solvent or water based adhesives are used or melt spraying if hot melt adhesive is used), dip coating, kiss roll, knife coating, and gravure coating. In some embodiments, a first fiber web (e.g., electrospun fiber web) and a second fiber web (e.g., meltblown fiber web) may be adhesively bound using a polymeric adhesive (e.g., acrylic copolymer) applied via spray coating. For example, an electrospun fiber web (e.g., comprising nylon fibers) and a meltblown fiber web (e.g., comprising polypropylene fibers) may be adhesively bound using a polymeric adhesive (e.g., acrylic copolymer) applied via spray coating.

In some embodiments, at least a portion of a surface of the first fiber web may be bonded (e.g., via lamination, via adhesive) to a third fiber web formed via a meltblowing, wetlaid, air laid, force spinning, electrospinning, or electroblowing process. In some cases, the third fiber web may be bonded to a surface of the first fiber web to form the filter media. In some embodiments, the bonding process does not significantly change the pore characteristics of the first fiber web. For instance, one or more pore properties (e.g., maximum pore size, full width at half maximum, mean flow pore size, ratio of maximum pore size to mean flow pore size) of the filter media may be within about 0% (no change) to 100% (100% change) of the value of the same pore property of the first fiber web prior to the bonding step, or in some embodiments within 0% to 50% (e.g., within 0% to 25%, within 0% to 10%) or 10% to 100% (e.g., within 10% to 50%, within 10% to 25%) of the value of the same pore property of the first fiber web prior to the bonding step. As an example, a first fiber web adjacent to a second fiber web, described herein, may have a maximum pore size of greater than or equal to about 0.1 micrometers and less than or equal to about 1 micrometer and a ratio of maximum pore size to mean pore size of less than or equal to about 2.5 prior to the bonding step. The filter media may have a maximum pore size and/or a ratio of maximum pore size to mean pore size that is within about 50% of the maximum pore size and/or a ratio of maximum pore size to mean pore size of the first fiber web prior to the bonding step.

As described herein, in some embodiments, the second fiber web and/or support layer may be calendered. In general, the second fiber web is calendered prior to contact with another fiber web (e.g., first fiber web). For example, first fiber web may be formed on a calendered second fiber web. In such cases, the first fiber web is uncalendered and the second fiber web is calendered. In some embodiments, the support layer (e.g., second fiber web and fourth fiber web) is calendered prior to contact with another fiber web (e.g., first fiber web). For instance, in embodiments in which the support layer comprises two or more fiber webs as described above with respect to FIG. 1C, the support layer may comprise two or more calendered fiber webs. For example, the support layer may comprise a meltblown fiber web and a spunbond fiber web that are calendered prior to formation of the first fiber web on the meltblown fiber web.

The calendering process may involve compressing one or more fiber webs (e.g., second fiber web, second and fourth fiber webs) using calender rolls under a particular pressure, temperature, and line speed. For instance, the pressure may be between 500 psi to 800 psi (e.g., between 550 psi to 750 psi, between 550 psi to 700 psi, between 550 psi to 650 psi, between 550 and 600 psi, between 600 psi and 750 psi, between 600 psi and 700 psi, between 650 psi and 750 psi, between 700 psi and 750 psi); the temperature may be between 40 degrees Celsius and 120 degrees Celsius (e.g., between 40 degrees Celsius and 85 degrees Celsius, between 50 degrees Celsius and 85 degrees Celsius, between 60 degrees Celsius and 85 degrees Celsius, between 65 degrees Celsius and 75 degrees Celsius, between 70 degrees Celsius and 85 degrees Celsius, between 35 degrees Celsius and 80 degrees Celsius, between 35 degrees Celsius and 70 degrees Celsius, between 35 degrees Celsius and 60 degrees Celsius, between 35 degrees Celsius and 50 degrees Celsius); and/or the line speed may be between 5 ft/min to 100 ft/min (e.g., between 5 ft/min to 80 ft/min, between 10 ft/min to 50 ft/min, between 15 ft/min to 100 ft/min, between 15 ft/min to 25 ft/min, or between 20 ft/min to 90 ft/min). Other ranges for pressure, temperature, and line speed are also possible.

In some embodiments, further processing may involve pleating the filter media. For instance, at least two fiber webs may be joined by a co-pleating process. In some cases, the filter media, or various fiber webs thereof, may be suitably pleated by forming score lines at appropriately spaced distances apart from one another, allowing the filter media to be folded. In some cases, one fiber web can be wrapped around a pleated fiber web. It should be appreciated that any suitable pleating technique may be used. In some embodiments, further processing may involve pleating the filter media with a blade pleater.

In some embodiments, a filter media can be post-processed such as subjected to a corrugation process to increase surface area within the web. In other embodiments, a filter media may be embossed.

In some embodiments, a fiber web, a layer, and/or a filter media described herein is not embossed.

The filter media may include any suitable number of fiber webs, e.g., at least 2, at least 3, at least 4, at least 5, at least 6, at least 7 fiber webs. In some embodiments, the filter media may include up to 20 fiber webs.

In some embodiments, a fiber web described herein may be a non-woven web. A non-woven web may include non-oriented fibers (e.g., a random arrangement of fibers within the web). Examples of non-woven webs include webs made by wet-laid or non-wet laid processes as described herein. Non-woven webs also include papers such as cellulose-based webs.

In some embodiments, the dirt holding capacity of the filter media may be greater than or equal to 60 mg/cm², greater than or equal to 65 mg/cm², greater than or equal to 70 mg/cm², greater than or equal to 75 mg/cm², greater than or equal to 80 mg/cm², greater than or equal to 85 mg/cm², greater than or equal to 90 mg/cm², or greater than or equal to 95 mg/cm². In some instances, the dirt holding capacity of the filter media may be less than or equal to 100 mg/cm², less than or equal to 95 mg/cm², less than or equal to 90 mg/cm², less than or equal to 85 mg/cm², less than or equal to 80 mg/cm², less than or equal to 75 mg/cm², less than or equal to 70 mg/cm², less than or equal to 65 mg/cm², less than or equal to 64 mg/cm², or less than or equal to 62 mg/cm². Combinations of the above-referenced ranges are also possible (e.g., greater than or equal to 60 mg/cm² and less than or equal to 100 mg/cm², greater than or equal to 64 mg/cm² and less than or equal to 75 mg/cm²). Other values are also possible. The dirt holding capacity may be determined by using a modified version of EN-13443-2 (2005) using iso-fine test dust as described above except that (similar to the efficiency test) the flow rate of challenge solution may differ between flatsheet and cartridge elements. In the case of flatsheet, in some cases, a flow rate of a challenge solution may be 1 L/min (face velocity of 10.5 cm/min) whereas a flow rate of a challenge solution for a cartridge element may be 15 L/min (face velocity of approximately 2.5 cm/min).

During use, the filter media mechanically trap contaminant particles on the filter media as fluid (e.g., water) flows through the filter media. The filter media need not be electrically charged to enhance trapping of contamination. Thus, in some embodiments, the filter media are not electrically charged. However, in some embodiments, the filter media may be electrically charged. Charging of such filter media might be performed by means of coating the media with ionic polymer and/or grafting ionic material (e.g., ionic polymer and/or ionic monomers) to the surface of the fibers of the filter media.

In some embodiments, sterilization processes described herein may include the use of an autoclave. In some embodiments, the filter media described throughout this disclosure can be sterilized using an autoclave. In some embodiments, the filter media may be capable of withstanding the temperatures, pressures, moisture, and/or durations associated with sterilization using an autoclave without exhibiting delamination, wrinkling, and/or other defects that were not present prior to the sterilization process.

A portion of a sterilization process described herein (e.g., a sterilization process that a filter media may be capable of withstanding) may be conducted at any of a variety of suitable temperatures. In some embodiments, a portion of the sterilization process is conducted at a temperature greater than or equal to 115 degrees Celsius, greater than or equal to 117 degrees Celsius, greater than or equal to 119 degrees Celsius, greater than or equal to 121 degrees Celsius, greater than or equal to 123 degrees Celsius, greater than or equal to 125 degrees Celsius, greater than or equal to 127 degrees Celsius, greater than or equal to 129 degrees Celsius, or greater than or equal to 130 degrees Celsius. In some embodiments, a portion of the sterilization process is conducted at a temperature less than or equal to 130 degrees Celsius, less than or equal to 129 degrees Celsius, less than or equal to 127 degrees Celsius, less than or equal to 125 degrees Celsius, less than or equal to 123 degrees Celsius, less than or equal to 121 degrees Celsius, less than or equal to 119 degrees Celsius, less than or equal to 117 degrees Celsius, or less than or equal to 115 degrees Celsius. Combinations of these ranges are possible (e.g., greater than or equal to 115 degrees Celsius and less than or equal to 130 degrees Celsius, and/or greater than or equal to 123 degrees Celsius and less than or equal to 130 degrees Celsius). Other ranges are also possible.

A portion of a sterilization process described herein (e.g., a sterilization process that a filter media may be capable of withstanding) may be conducted at any of a variety of suitable pressures (e.g., in combination with a temperature in one or more of the ranges provided in the preceding paragraph). In some embodiments, a portion of the sterilization process is conducted at a pressure greater than or equal to 1 bar, greater than or equal to 1.1 bar, greater than or equal to 1.2 bar, greater than or equal to 1.4 bar, greater than or equal to 1.6 bar, greater than or equal to 1.8 bar, greater than or equal to 2 bar, greater than or equal to 2.2 bar, greater than or equal to 2.4 bar, or greater than or equal to 2.5 bar. In some embodiments, a portion of the sterilization process is conducted at a pressure less than or equal to 2.5 bar, less than or equal to 2.4 bar, less than or equal to 2.2 bar, less than or equal to 2 bar, less than or equal to 1.8 bar, less than or equal to 1.6 bar, less than or equal to 1.4 bar, less than or equal to 1.2 bar, less than or equal to 1.1 bar, or less than or equal to 1 bar. Combinations of these ranges are possible (e.g., greater than or equal to 1 bar and less than or equal to 2.5 bar). Other ranges are also possible.

A portion of a sterilization process described herein (e.g., a sterilization process that a filter media may be capable of withstanding) may be conducted for any of a variety of suitable cycles (e.g., cycles that may comprise heating to a temperature in one or more of the ranges provided above and/or pressurizing to a pressure in one or more of the ranges provided above). In some embodiments, a portion of the sterilization process is conducted for less than or equal to 50 cycles, less than or equal to 40 cycles, less than or equal to 30 cycles, less than or equal to 20 cycles, less than or equal to 15 cycles, less than or equal to 10 cycles, less than or equal to 5 cycles, or less than or equal to 1 cycle. In some embodiments, a portion of the sterilization process is conducted for greater than or equal to 1 cycle, greater than or equal to 5 cycles, greater than or equal to 10 cycles, greater than or equal to 15 cycles, greater than or equal to 20 cycles, greater than or equal to 30 cycles, greater than or equal to 40 cycles, or greater than or equal to 50 cycles. Combinations of these ranges are possible (e.g., less than or equal to 50 cycles and greater than or equal to 1 cycle). Other ranges are possible.

Filter media as described herein may be suitable for filtering a variety of liquids. In some embodiments, the liquid comprise water. In some embodiments, the liquid comprises an aqueous solution and/or an aqueous suspension. That is, the filter media may be able to remove particulates, chemical compounds, microorganisms, and/or other matter from a water-based solution and/or suspension. In some embodiments, the filter media filters the aqueous solution such that the liquid is substantially free of solute.

The following examples are intended to illustrate certain embodiments of the present invention, but do not exemplify the full scope of the invention.

### Example 1

This example generally describes the fabrication of filter media and the characterization of their adhesion to plastic articles (e.g., filter housings).

### Filter Media Structure and Physical Properties

Tables 1-4 below summarize selected properties of three types of samples described in this Example: ST samples (lacking a fourth fiber web), AW samples (samples to which a fourth fiber web was bonded by an adhesive layer), and SO samples (samples to which a fourth fiber web was bonded via ultrasonic bonding).

TABLE 1
Layers Present in the ST, AW, and SO Samples

| | ST Samples | AW Samples | SO Samples |
|---|---|---|---|
| First Fiber | Polyamide 6 | Polyamide 6 | Polyamide 6 |
| Web | Nanofiber Web | Nanofiber | Nanofiber Web |
| | | Web | |
| Second Fiber | Polyamide 6 | Polyamide 6 | Polyamide 6 |
| Web | Meltblown Fiber | Meltblown | Meltblown Fiber |
| | Web | Fiber Web | Web |
| Third Fiber | Polyamide 6 | Polyamide 6 | Polyamide 6 |
| Web | Meltblown Fiber | Meltblown | Meltblown Fiber |
| | Web | Fiber Web | Web |
| Adhesive | No | Yes (see | No |
| Layer? | | Table 3 for | |
| | | more | |
| | | information) | |
| Fourth Fiber | N/A | 75 gsm | 75 gsm |
| Web | | Embossed | Embossed |
| | | polyester | polyester scrim |
| | | scrim | |

TABLE 2
Selected Physical Properties of the ST Samples

| | ST-1 | ST-2 | ST-3 | ST-4 | ST-5 |
|---|---|---|---|---|---|
| Mean Flow Pore Size (micrometers) | 0.29 | 0.42 | 0.48 | 0.57 | 0.63 |
| Air Permeability (L/(m² · s)) | 9.1 | 15.2 | 18.2 | 23.4 | 27.4 |
| Peak Peel Strength to Polypropylene (PP) Plastic | | | 0 | | |
| Article (g/mm) | | | | | |
| Peak Peel Strength to Polystyrene Plastic Article | | | 0-15 | | |
| (g/mm) | | | | | |
| Hydrostatic Pressure (millibar) | | 6.6 | 6.1 | 6.2 | 6.7 |

TABLE 3
Selected Physical Properties of the AW Samples

| | AW-1 | AW-2 | AW-3 | AW-4 | AW-5 |
|---|---|---|---|---|---|
| Adhesive Web Composition | Co-polyester | Polypropylene | Polypropylene | Polypropylene | Polypropylene |
| Nanofiber Web | ST-3 | ST-3 | ST-3 | ST-3 | ST-4 |
| Adhesive Web Basis Weight | 12 | 5 | 12 | 5 | 5 |
| (gsm) | | | | | |
| Melting Temperature of the | 100-110 | 150-160 | 150-160 | 150-160 | 150-160 |
| Adhesive Web (degrees | | | | | |
| Celsius) | | | | | |
| Air Permeability (L/(m² · s)) | 17.7 | 18.2 | 15.7 | 17.2 | 19.8 |
| Is there observable | Yes | No | No | No | No |
| delamination between the | | | | | |
| fourth fiber web and other | | | | | |
| layers of the filter media? | | | | | |
| Peak Peel Strength to | | | | 240 | |
| Polypropylene (PP) Plastic | | | | | |
| Article (g/mm) | | | | | |
| Peak Peel Strength to | | | | 40 | |
| Polystyrene Plastic Article | | | | | |
| (g/mm) | | | | | |
| Hydrostatic Pressure (mbar) | | | | 8.6 | 9.0 |

TABLE 4
Selected Physical Properties of the SO Samples

| | SO-1 | SO-2 | SO-3 |
|---|---|---|---|
| Nanofiber Web | ST-3 | ST-4 | ST-5 |
| Air Permeability | 19.4 | 20.9 | 25.5 |
| (L/(m² · s)) | | | |
| Mean Flow Pore Size | 0.46 | 0.54 | 0.53 |
| (micrometers) | | | |
| Peak Peel Strength to | >240 | | |
| Polypropylene (PP) | | | |
| Plastic Article | | | |
| (g/mm) | | | |
| Peak Peel Strength to | >40 | | |
| Polystyrene Plastic | | | |
| Article (g/mm) | | | |
| Hydrostatic Pressure | 9.3 | 8.1 | |

The ST samples shown in the above tables were fabricated by laminating three fiber webs comprising polyamide fibers. The three fibers webs were arranged such that a nanofiber web (e.g., an efficiency layer) was positioned between two meltblown fiber webs. The ST samples do not have an adhesive layer or a fourth fiber web.

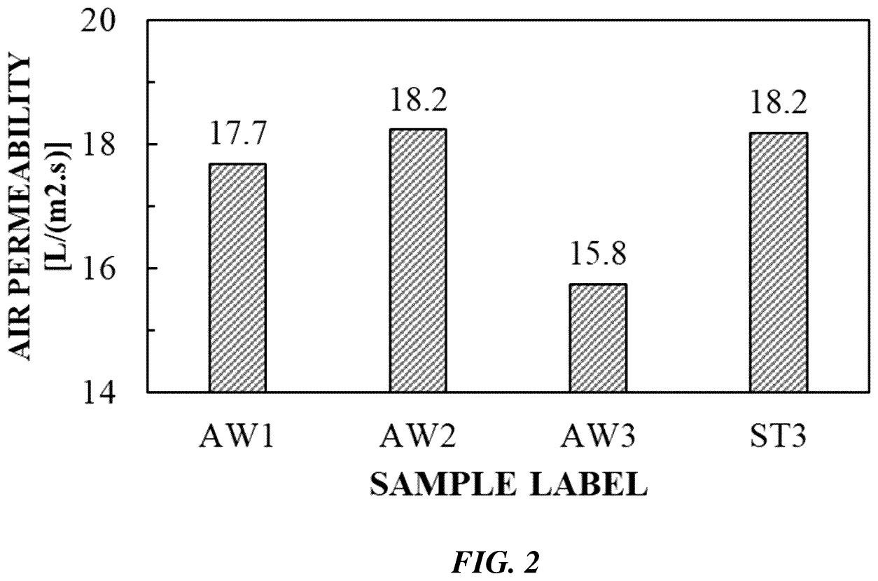

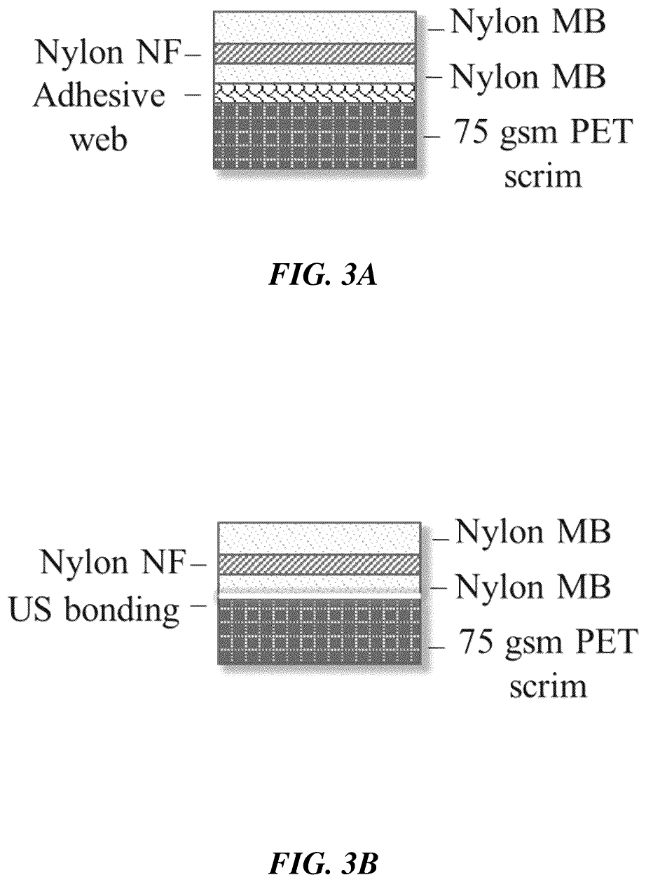

The AW samples shown in the above tables include the same fiber webs as selected ST samples, but further include a fourth fiber web bonded thereto using an adhesive web. This fourth fiber web was Scrim-3, whose properties are described in further detail below. These samples were made by heat laminating three fiber webs comprising polyamide fibers and a polyester scrim (e.g., a fourth fiber web) with the adhesive web positioned therebetween. The three fibers webs comprising polyamide fibers were arranged identically as the ST samples. That is, they were arranged such that a nanofiber web (e.g., an efficiency layer) was positioned between two meltblown fiber webs. The adhesive web was thermally activated to create the bond between the scrim and the meltblown fiber web. As shown in Table 2, several different adhesive webs were employed in the different AW samples. A copolyester web (AW-1) with melting temperature of 100-110 degrees Celsius and basis weight of 12 gsm, as well as two polypropylene (PP) adhesive webs with melting point of 150-160 degrees Celsius were explored. The basis weights of the polypropylene adhesive webs were 5 gsm (AW-2) and 12 gsm (AW-3). More details regarding the AW samples can be found in Table 3. The air permeability associated with the AW samples are shown in FIG. 2. A general diagram of the AW samples are shown in FIG. 3A.

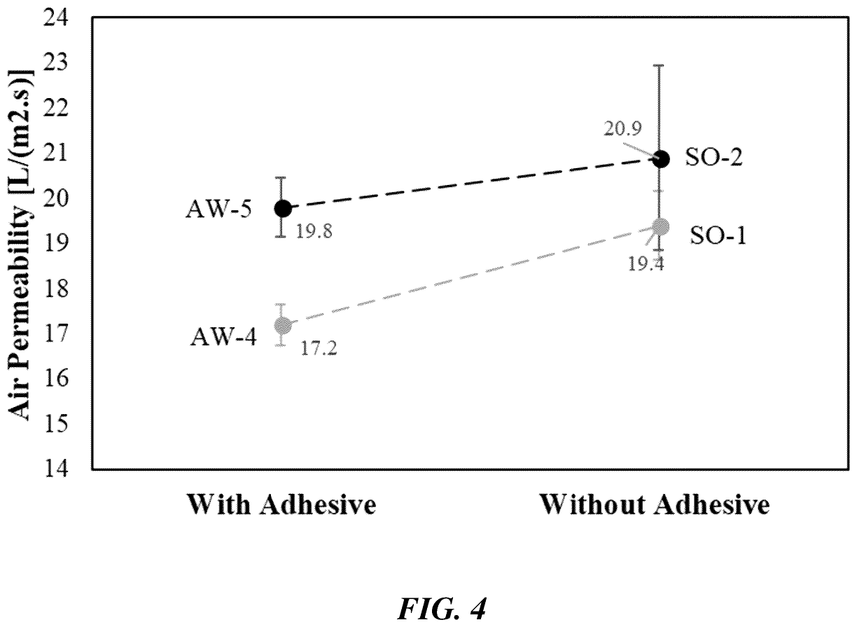

The SO samples shown in the above tables include the same fiber webs as selected ST samples, but further include a fourth fiber web bonded thereto via ultrasonic bonding. Unlike the AW samples, the SO samples did not have an adhesive web, but the structure of the fiber webs comprising polyamide fibers remained the same. The SO samples were made by adhering a meltblown fiber web comprising polyamide fibers (e.g., a second fiber web or a third fiber web) to a polyester scrim via ultrasonic bonding to form a primary layer. This primary layer was then used as a supporting layer to host a nanofiber web. Another meltblown fiber web was then positioned adjacent to the nanofiber web such that the nanofiber web is positioned between the two meltblown fibers webs. The layers in these samples were then adhered together via a heat lamination process. Details regarding the structure and properties of the SO samples can be found in Table 4, including their adhesion strength to polypropylene and polystyrene articles. A general diagram of the ST samples is shown in FIG. 3B. A comparison of the air permeability of selected SO samples and selected AW samples is depicted in FIG. 4. The air permeabilities of the AW and SO samples were not significantly impacted by the inclusion of the polyester scrim, as compared to the corresponding ST samples.

### Fourth Layer Bonding Strength to Polypropylene Plastic Articles

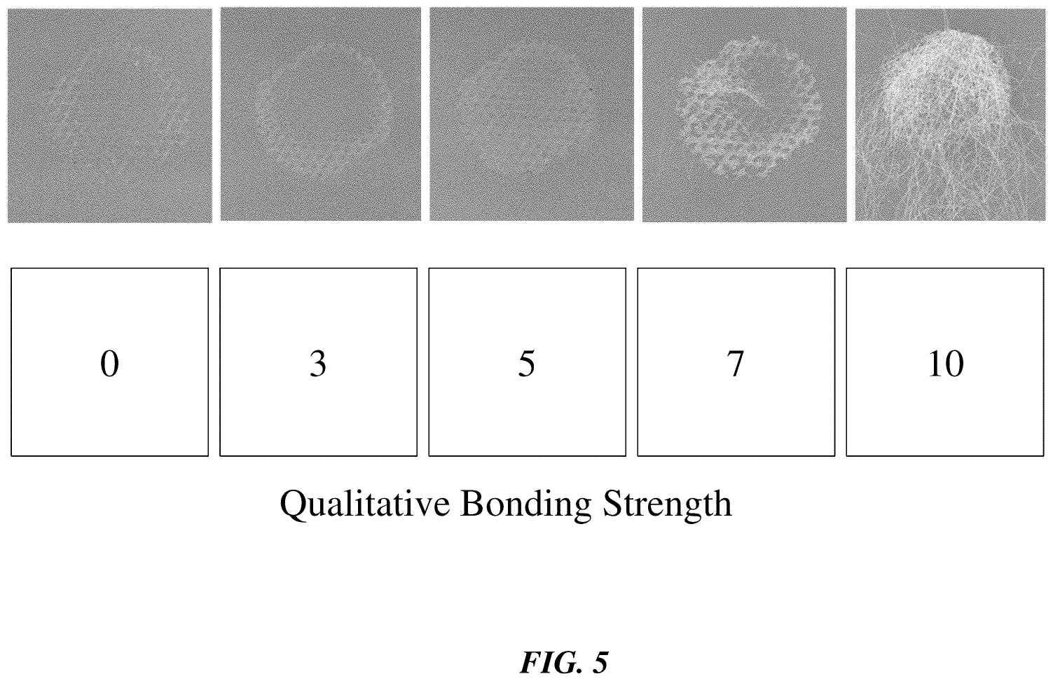

The qualitative bonding strength between a polypropylene plastic article and scrims of various types and basis weights were evaluated, as shown in Table 5. These scrims were ultrasonically bonded to the plastic article. The qualitative bond strength was measured on a scale of 0 to 10. A qualitative bonding strength of 0 indicated minimal bonding such that samples could be removed simply by the force of gravity. A qualitative bonding strength of 3 indicated mild bonding such that samples could be removed by the application of a gentle force. A qualitative bonding strength of 5 indicated moderate bonding such that an observable resistance was present during peeling but scrim residues (e.g., scrim fibers) were not observed on the plastic article after peeling. A qualitative bonding strength of 7 indicated a fair amount of bonding such that peeling off the sample resulted in partial cohesive failure of the scrim material thereby leaving scrim residues on the plastic article. A qualitative bonding strength of 10 indicated strong bonding such that peeling the samples from the filter housing resulted in total cohesive failure of the polyester scrim. Partial and/or total cohesive failure occurred when peeling resulted in the presence of scrim residues (e.g., scrim fibers) on the bonded area of the plastic article. FIG. 5 depicts scanned images (e.g., using a flatbed scanner) of the bonding area (10 mm in diameter) on the plastic article at various qualitative bonding strengths to further illustrate the qualitative bonding scale disclosed in this example.

TABLE 5
Various weights and types of polyester scrims tested.

| | Scrim Samples | | | | | |
|---|---|---|---|---|---|---|
| | Scrim-1 | Scrim-2 | Scrim-3 | Scrim-4 | Scrim-5 | Scrim-6 |
| Basis Weight | 25 | 40 | 75 | 110 | 13.5 | 95 |
| (gsm) | | | | | | |
| Scrim Type | Em- | Em- | Em- | Em- | Area | Area |
| | bossed | bossed | bossed | bossed | bonded | bonded |
| Qualitative | 10 | 10 | 10 | 10 | 0 | 7 |
| bond strength | | | | | | |
| (scale 0-10) | | | | | | |

As shown in Table 5, the qualitative bond strength of between each scrim sample and the polypropylene plastic article was dependent on the type of scrim used in each sample. Higher qualitative bond strengths were observed for scrim samples having embossed scrims, while those with area-bonded scrims had lower qualitative bond strengths.

### Filter Media Bonding Strength to Various Plastic Articles

The ST, AW, and SO samples (the latter two comprising Scrim-3) were ultrasonically bonded to polypropylene and polystyrene plastic articles (e.g., a filter housing), and the peak peel strengths between these samples and the plastic articles are shown in Tables 2-5. For the AW and SO samples, the bonding was performed between the scrim and the plastic article. For the ST samples, the bonding was performed between one of the meltblown fiber webs and the plastic article.

Additionally, and as shown in Table 6, the qualitative bond strength of both sides of the SO samples to various plastic articles after ultrasonic bonding therebetween was also evaluated. Generally, the qualitative bond strength between the plastic article and the scrim side of the SO samples was higher compared to that of the meltblown fiber web side. Accordingly, these results indicate that the fourth fiber web promotes stronger adhesion between the filter media and the plastic articles.

TABLE 6
Selected qualitative bonding strengths of the SO-2 sample to plastic articles.

| | Qualitative bond strength (scale 0-10) between the SO- | |
|---|---|---|
| | 2 samples and the plastic article | |
| Plastic article material | Scrim Side | Meltblown Fiber Web Side |
| Polystyrene | 5 | 0 |
| Polystyrene | 3 | 3 |
| Acrylonitrile Butadiene Styrene | 0 | 0 |
| (ABS) | | |
| Delrin Acetal | 3 | 0 |
| Low Density Polyethylene (LDPE) | 3 | 0 |
| High Density Polyethylene (HDPE) | 7 | 3 |
| Extruded Nylon | 0 | 0 |
| Polyester | 0 | 0 |
| Cast Nylon | 0 | 3 |
| Rexolite | 3 | 3 |
| Ultra-High Molecular Weight | 0 | 0 |
| Polyethylene (UHMWPE) | | |
| Noryl Polyphenylene Oxide (PPO) | 0 | 0 |
| Polypropylene (PP) | 10 | 3 |

Finally, further experiments were also conducted to evaluate the bonding strength between the meltblown fiber web side of the filter media and PP plastic articles after ultrasonic bonding therebetween. The results can be found in Table 7. The qualitative bond strength for the SO-2 sample, which includes a polyester scrim, between the polyamide meltblown fiber web and the plastic article was higher than for the ST-4 sample. Without wishing to be bound by any particular theory, it is believed that the polyester scrim melted through the polyamide meltblown layer during ultrasonic bonding and assisted with bonding to the plastic article, thereby forming a stronger bonding to the plastic article than the ST-4 sample. As further noted in Table 7, the bond strength between the meltblown fiber web side of SO-2 sample and the plastic article is lower than that between the polyester scrim and the plastic article (see Table 5).

TABLE 7
Selected bond strengths for SO-2 and ST-4 samples
bonded to a polypropylene plastic article.

| Side of Filter Media | | Qualitative bond | Peak Peel |
|---|---|---|---|
| Bonded to Plastic | | strength | Strength |
| Article | Sample | (scale 0-10) | (g/mm) |
| Meltblown Fiber Web | SO-2 | 7 | 35.9 |
| Meltblown Fiber Web | ST-4 | 5 | 5.3 |

Accordingly, the inclusion of the fourth fiber in the filter media promotes adhesion of the filter media to the plastic article (e.g., a filter housing) as the adhesion of the AW and SO samples to the plastic article is higher than that of the ST samples. This benefit was accompanied by a substantial retention of the air permeability of the filter media. In other words, the AW and SO samples exhibited air permeabilities that were not substantially lower than those of the ST samples. This can be observed by way of comparison between the air permeabilities associated with the ST-3, AW-4, and SO-1 samples, as these samples have identical nanofiber webs.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way.

Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A filter media, comprising:
a first fiber web comprising first fibers, wherein the first fibers have an average diameter of less than or equal to 0.5 micrometers, wherein the first fiber web has a thickness of less than or equal to 200 micrometers;
a second, hydrophilic fiber web directly adjacent to the first fiber web;
a third fiber web bonded to the first fiber web; and
a fourth fiber web bonded to the second fiber web or the third fiber web, wherein the fourth fiber web and the second or third fiber web are bonded mechanically and/or by an adhesive layer positioned therebetween, and wherein the fourth fiber web has a basis weight greater than or equal to 30 gsm.

2. A filter element, comprising:
a gravity filter housing; and
a filter media bonded to the filter housing, wherein the filter media comprises:
a first fiber web comprising first fibers, wherein the first fibers have an average diameter of less than or equal to 0.5 micrometers, wherein the first fiber web has a thickness of less than or equal to 200 micrometers;
a second, hydrophilic fiber web directly adjacent to the first fiber web;
a third fiber web directly adjacent to the first fiber web; and
a fourth fiber web bonded to the second fiber web or the third fiber web.

3. A method for fabricating a filter media, comprising:
bonding a fourth fiber web to a second, hydrophilic fiber web or a third fiber web mechanically and/or by an adhesive layer positioned therebetween, wherein:
the second fiber web is directly adjacent to a first fiber web having a thickness of less than or equal to 200 micrometers;
the third fiber web is bonded to the first fiber web;
the first fiber web comprises first fibers having an average diameter of less than or equal to 0.5 micrometers; and
the fourth fiber web has a basis weight greater than or equal to 30 gsm.

4. The filter media of claim 1, wherein the fourth fiber web is bonded directly to the third fiber web such that at least a portion of the third fiber web is in physical contact with at least a portion of the fourth fiber web.

5. The filter media of claim 1, wherein the filter media comprises the adhesive layer, and wherein the adhesive layer is positioned between the third fiber web and the fourth fiber web.

6. The filter media of claim 1, wherein the filter media comprises the adhesive layer, and wherein the adhesive layer comprises an adhesive web.

7.-8. (canceled)

9. The filter media of claim 1, wherein the fourth fiber web comprises polyester, polypropylene, and/or polyethylene.

10. (canceled)

11. The filter media of claim 1, wherein the fourth fiber web has a melting temperature within 45 degrees Celsius of the melting temperature of the third fiber web.

12. The filter media of claim 1, wherein the fourth fiber web has a melting temperature greater than or equal to 220 degrees Celsius.

13. (canceled)

14. The filter media of claim 1, wherein the fourth fiber web is calendered.

15. (canceled)

16. The filter media of claim 1, wherein the fourth fiber web comprises polyester, nylon, polysulfide, polycarbonate, and/or polypropylene.

17. The filter media of claim 1, wherein the fourth fiber web is a scrim.

18. The filter media of claim 1, wherein the fourth fiber web is embossed.

19. (canceled)

20. The filter media of claim 1, wherein the fourth fiber web is bonded to a pour-through filter housing.

21. The filter media of claim 20, wherein the pour-through filter housing comprises pleated, flat disk, panel, wrap-around, and/or spiral-wound filters.

22. The filter media of claim 1, wherein the filter media comprises the adhesive layer, and wherein the adhesive layer has a melting temperature greater than or equal to 130 degrees Celsius.

23.-25. (canceled)

26. The filter media of claim 1, wherein the filter media comprises the adhesive layer, and wherein the adhesive layer is hydrophobic.

27. The filter media of claim 1, wherein the filter media comprises the adhesive layer, and wherein the adhesive layer comprises a food-grade material.

28. The filter media of claim 1, wherein the filter media comprises the adhesive layer, and wherein the adhesive layer comprises a meltblown fiber web.

29.-46. (canceled)

47. The filter media of claim 1, wherein the peak peel strength between the third fiber web and the fourth fiber web is greater than or equal to 0.3 g/mm.
